(19) United States
(12) Patent Application Publication
(10) Pub. No.: US 2010/0188799 A1
(43) Pub. Date: Jul. 29, 2010

(54) CONTROLLED ESR LOW INDUCTANCE CAPACITOR

(75) Inventors: John L. Galvagni, Surfside Beach, SC (US); Marianne Berolini, Southport, NC (US); Andrew P. Ritter, Surfside Beach, SC (US)

Correspondence Address: DORITY & MANNING, P.A., POST OFFICE BOX 1449, GREENVILLE, SC, 29602-1449, US

(73) Assignee: AVX CORPORATION, Myrtle Beach, SC (US)

(21) Appl. No.: 12/694,402

(22) Filed: Jan. 27, 2010

Related U.S. Application Data
(60) Provisional application No. 61/147,792, filed on Jan. 28, 2009.

(51) Int. Cl. H01G 4/228; H01G 4/06; B05D 5/12

(52) U.S. Cl. 361/306.3; 361/321.2; 427/79

(57) ABSTRACT

Multilayer capacitors incorporate both low inductance (ESL) and controlled Equivalent Series Resistance (ESR) features into a cost-effective unitary device. Internal electrode patterns generally include one or more pairs of mother electrodes adapted for external connection (e.g., to a circuit, another electrical component, circuit board, or other mounting environment), and multiple pairs of daughter electrodes adapted only for internal connection to other electrodes (e.g., other daughter electrodes and/or selected mother electrodes) without direct connection to an external circuit. Mother and daughter electrodes are interdigitated with electrode tab features, where daughter electrodes have internal-connection tabs, and mother electrodes have both internal-connection tabs and circuit-connection tabs, all of which are connected to respective internal-connection or circuit-connection terminals. ESR is increased by the parallel connection between mother and daughter electrodes as well as other optional features such as but not limited to resistive terminations, resistive connectors, serpentine terminations and increased current path lengths.

### PRIORITY CLAIM

This application claims the benefit of previously filed U.S. Provisional Patent Application entitled “CONTROLLED ESR LOW INDUCTANCE CAPACITOR,” assigned U.S. Ser. No. 61/147,792, filed Jan. 28, 2009, and which is incorporated herein by reference for all purposes.

### FIELD OF THE INVENTION

The present subject matter generally concerns improved multilayer ceramic capacitors (MLCCs). More particularly, the present subject matter relates to capacitor configurations and related methodologies for making capacitors that incorporate both low inductance (ESL) and controlled Equivalent Series Resistance (ESR) features into a cost-effective unitary device.

### BACKGROUND OF THE INVENTION

The diversity of modern technical applications creates a need for efficient electronic components and integrated circuits for use therein. Capacitors are a fundamental component used for filtering, decoupling, bypassing and other aspects of such modern applications which may include wireless communications, computer or other processing systems, alarm systems, radar systems, circuit switching, matching networks, and many other applications. A dramatic increase in the speed and packing density of integrated circuits requires advancements in decoupling capacitor technology in particular.

Decoupling capacitors are often used to manage noise problems that occur in circuit applications. They provide stable, local charge sources required to switch and refresh the logic gates used in various digital circuits. When high-capacitance decoupling capacitors are subjected to the increased frequencies of many present applications, performance characteristics become increasingly more important. One such characteristic corresponds to lowered inductance (or ESL—Equivalent Series Inductance) within such capacitors.

As switching speeds increase and pulse rise times decrease in electronic circuit applications, the need to reduce inductance becomes a serious limitation for improved system performance. Even the decoupling capacitors, which act as a local energy source, can generate unacceptable voltage spikes: V=L (di/dt). Thus, in high speed circuits where di/dt can be quite large, the size of the potential voltage spikes can only be reduced by reducing the inductance value L.

Several design aspects have been implemented that reduce the self and mutual inductance of decoupling capacitors. Reducing the current path will lower self inductance. Since the current often has to travel the entire length of the capacitor, termination on the longer ends of the structure will reduce the current path. If the current in adjacent capacitor electrodes flows in opposite directions it will reduce the mutual inductance in a capacitor. Reduction in interconnect induction, such as by using multiple terminations and/or interdigitated electrode configurations correspond to other known techniques for lowering the inductance value in multilayer capacitors.

More particularly, the prior art includes several strategies for reducing equivalent series inductance, or ESL, of chip capacitors compared to standard multilayer chip capacitors. A first exemplary strategy involves reverse geometry termination, such as employed in low inductance chip capacitor (LICC) designs such as manufactured and sold by AVX Corporation. In LICCs, electrodes are terminated on the long side of a chip instead of the short side. Since the total inductance of a chip capacitor is determined in part by its length to width ratio, LICC reverse geometry termination results in a reduction in inductance by as much as a factor of six from conventional MLC chips.

Interdigitated capacitors (IDCs) incorporate a second known strategy for reducing capacitor inductance. IDCs incorporate electrodes having a main portion and multiple tab portions that connect to respective terminations formed on the capacitor periphery. Multiple such terminations can help reduce the parasitic inductance of a device. Some examples of multilayer capacitors that include features of interdigitated capacitor (IDC) technology can be found in U.S. Pat. Nos. 4,831,494 (Arnold et al), 5,880,925 (DuPré et al.) and 6,243,253 B1 (DuPré et al.).

A still further known technology utilized for reduction in capacitor inductance involves designing alternative current paths to minimize the mutual inductance factor of capacitor electrodes. A low inductance chip array (LICA) product, such as manufactured and sold by AVX Corporation, minimizes mutual inductance by configuring a ball grid array multilayer capacitor such that the charging current flowing out of a positive plate returns in the opposite direction along an adjacent negative plate. Utilization of LICA technology achieves low inductance values by low aspect ratio of the electrodes, an arrangement of electrode tabs so as to cancel inductance and vertical aspect of the electrodes to the mounting surface. Exemplary aspects of such a device are selectively shown in U.S. Pat. No. 4,831,494 (Arnold et al.).

Additional references that incorporate adjacent electrodes having reverse current paths used to minimize inductance include U.S. Pat. No. 6,956,730 (Togashi et al.) and U.S. Pat. No. 6,292,351 (Ahiko et al.) Both such references also utilize a vertical aspect of electrodes relative to a mounting surface. Additional references that disclose electrodes for use in a vertically-oriented position include U.S. Pat. Nos. 5,517,385 (Galvagni et al.), 4,831,494 (Arnold et al.) and 6,885,544 (Kim et al.)

A known reference that discloses features aimed to reduce inductance in an integrated circuit package that includes, in part, a capacitive device is U.S. Pat. No. 6,483,692 (Figueroa et al.). Such reference recognizes that inductance relates to circuit board “loop area” or the electrical distance (or span) that current must follow. It is desirable in Figeuroa et al. to minimize such loop area, thus reducing the inductance levels. Extended surface lands are also provided in Figueroa et al., providing a larger surface area that is said to result in more reliable connections characterized by reduced inductance and resistance levels.

U.S. Pat. No. 6,661,640 (Togashi) also discloses features for reducing ESL of a decoupling capacitor by maximizing the surface area of device terminations. U.S. Pat. No. 6,917,510 (Prymak) discloses a capacitor embodiment with terminal extensions formed to result in a narrow gap between the electrodes. The end electrodes of U.S. Pat. No. 6,822,847 (Devoe et al.) also cover all but a thin separation line at a central portion of the capacitor body.

Still further known references that include features for reducing component inductance correspond to U.S. Pat. Nos. 6,757,152 (Galvagni et al.) and 6,606,237 (Naito et al.), in which conductive vias are utilized to form generally low inductance connections to upper electrodes in a multilayer capacitor. In addition, U.S. Pat. No. 4,419,714 (Locke) discloses a low inductance ceramic capacitor and related method in which multiple sections of dielectric and companion plates are connected by tabs at a common face of the structure. U.S. Pat. No. 4,814,940 (Horstmann et al.) also discloses a low inductance capacitor with multiple internal capacitor plates having tabs that project diagonally to a corner of the capacitor body.

As ESL has decreased in some multilayer capacitors, a potential drawback of decreasing the ESR may also arise. Such phenomenon is especially prevalent when multilayer capacitors are made with a relatively large number of active electrode layers, for example, sometimes in a range of between 400-1000 layers or more. Since most or all of the multiple electrode layers are typically connected in parallel, the relatively large number of parallel electrodes and their associated parallel resistors combine to provide a very low resistance. In some instances, undesirable effects have been observed in the final circuits in which they are used, including mismatching of impedances, undesirable introduction of signal reflections, and also including a phenomenon known as “ringing.” Ringing generally refers to an undesirable level of oscillation in an electrical signal such as voltage or current, especially where some level of signal damping is alternatively preferred.

In light of the above problems and others encountered in the prior art, increasing the ESR in some multilayer capacitors, or at least incorporating features for providing a controlled amount of ESR in a capacitor, is desired. Known methods for controlling ESR are not simple, and some proposed arrangements are either non-reproducible, increase capacitor inductance, or are quite expensive.

One effort at providing controlled ESR in a low inductance MLCC is disclosed in U.S. Pat. No. 7,054,136 (Ritter et al.), in which controlled ESR is achieved either through inclusion of specific types of materials or through alteration of the shape of various component parts.

Another example, in which discrete capacitor components are coupled together in a cascade capacitor configuration, is provided in U.S. Pat. No. 6,757,152 (Galvagni et al.). In such capacitors, features for attachment and interconnection are provided that generally facilitate low ESL while maintaining a given capacitance value. Specifically, in FIG. 4C of Galvagni et al. '152, one embodiment comprises two surface mount tantalum or ceramic capacitors 64 arranged beside a single layer capacitor 66 and electrically connected to a BGA/IDC component 54. Inclusion of a tantalum device 64 preferably extends the range of potential capacitance values of selected embodiments of the subject technology, while small surface mount tantalum capacitors preferably offer high energy storage, high frequency of operation and desired ESR performance.

Another known prior art capacitor is disclosed in U.S. Pat. No. 7,310,217 (Takashima et al.), which is directed to a monolithic capacitor having respective first and second capacitor portions arranged in a given direction of lamination. The first capacitor portion contributes to decreasing ESL while the second capacitor portion contributes to increasing ESR.

Additional examples of multilayer capacitors designed to selectively address various aspects of ESL, ESR and/or other performance characteristics have been developed by TDK Corporation. Examples include U.S. Pat. Nos. 7,388,737 (Togashi et al.); 7,369,395 (Togashi); 7,298,604 (Togashi et al.); 7,283,348 (Togashi et al.); 7,145,429 (Togashi et al.); 7,099,138 (Togashi et al.); 7,088,569 (Togashi et al.); 6,970,342 (Togashi); and 6,765,781 (Togashi).

While various aspects and alternative features are known in the field of multilayer electronic components, no one design has emerged that generally addresses all of the issues as discussed herein. The disclosures of all the foregoing United States patents and published applications are for all purposes hereby fully incorporated into this application by reference thereto.

### BRIEF SUMMARY OF THE INVENTION

In view of the recognized features encountered in the prior art and addressed by the present subject matter, improved methodologies for producing multilayer electronic devices and associated aspects of electrical termination of such multilayer electronic devices, and resulting such devices, have been developed. Therefore, the present subject matter relates both to improved devices and apparatuses, and to corresponding related methodologies.

Controlled ESR low inductance capacitors generally include a capacitor structure which incorporates a low inductance section and a high ESR section that are connected in parallel. As such, a device is provided that has internal connectivity without sacrificing low inductance. This is an advantage over known prior art devices that require separate sections to be physically connected after termination, or else require some sacrifice in inductance levels. By incorporating a self-terminating scheme and subsequent deposition of thin-film conductive or resistive terminations by such techniques as electroless and/or electrolytic plating, unitary devices can be made. Additional advantages include but are not limited to the inclusion of uniform size, predictable values, customizable design options, and others.

Exemplary embodiments of the present subject matter may generally include at least two different types of electrode pairs. Mother electrodes will be adapted for external connection (e.g., to a circuit, another electrical component, circuit board, or other mounting environment). Daughter electrodes will be adapted only for internal connection to other electrodes (e.g., other daughter electrodes and/or selected mother electrodes) within an MLC without direct connection to an external circuit.

In some embodiments, mother electrodes and daughter electrodes will be provided in respective pairs of a first polarity and a second polarity electrode, thus often yielding four different electrode patterns (two mother electrode patterns and two daughter electrode patterns) for use in a each MLC. It may be preferable to include many more daughter electrodes than mother electrodes, leaving the mother electrodes for low inductance circuit connection to the MLC and daughter electrodes to contribute to overall device capacitance.

Improved overall device ESR values are realized by the form of parallel connection between mother and daughter electrodes as well as other optional features which may be used, such as but not limited to resistive terminations, resistive connectors, increased current path lengths, etc. It should be appreciated that device ESR values may be “improved” by controlling the ESR to achieve either higher or lower overall ESR depending on the circuit requirements.

In some present exemplary embodiments, a low inductance controlled equivalent series resistance (ESR) multilayer capacitor includes at least a first pair of mother electrodes and a plurality of pairs of daughter electrodes provided in a laminated stack with alternating dielectric layers. The mother electrodes are interdigitated with respective end tabs on opposite ends thereof for providing internal connection to other electrodes, and side tabs on opposite longer sides thereof for providing circuit connection to an external location. The daughter electrodes are not connected to an external circuit location, but include end tabs on opposite ends thereof for internal connection to other daughter electrodes and to the mother electrodes. Anchor tabs may or may not also be placed alongside portions of the mother and daughter electrodes (but not in direct contact with such electrodes) as dummy plates to provide additional nucleation and guide points for subsequently applied peripheral terminations. End terminations provide for internal connection among the various mother and daughter electrodes, while side terminations provide locations for connecting the MLC to a circuit or other mounting environment.

In other present exemplary embodiments, a low inductance controlled ESR multilayer capacitor includes interdigitated vertical electrodes, which are oriented in a substantially perpendicular direction relative to a mounting surface. Exemplary vertical electrodes may also include one or more respective pairs of mother and daughter electrode patterns. The mother electrodes may be provided anywhere in a laminated stack, such as in the middle and/or on ends of a stacked arrangement, and include circuit-connection tabs extending to a mounting surface and internal-connection tabs extending to the opposite surface thereof. Daughter electrodes also may have some tabs extending to the surface opposite the mounting surface, and are connected to other daughter electrodes and mother electrodes by internal-connection terminations. Circuit-connection tabs extending from the mother electrodes and circuit-connection terminals connected directly thereto may be provided in multiple stripes on the mounting surface of an MLC. In one example, four stripes are provided, two for each polarity mother electrode. In another example, only two termination stripes are employed, one for each polarity mother electrode. Still further numbers of circuit-connection terminals may be realized. Again, anchor tabs may optionally be employed in such exemplary electrode pattern configurations, especially when thin-film plated terminations are deposited.

In further exemplary embodiments, additional resistance features are provided by forming the internal-connection terminations with a resistive material, thus providing increased resistance in the current path traveled between each mother and daughter electrode in a stacked assembly. Alternatively, conductive terminals may be coupled together by resistive stripes printed on one or more peripheral surfaces of an MLC.

In still further exemplary embodiments, exposed electrode tabs and anchor tabs associated with the mother and daughter electrodes of the presently disclosed technology are configured such that they extend to varied locations relative to a columnar centerline, resulting in a staggered array of exposure locations. When thin-film plated terminations are selectively deposited on such staggered exposure locations, serpentine termination structures are formed that increase the resistive path length traveled by current flow through an MLC device.

Yet other exemplary embodiments accommodate the formation of peripheral internal-connection terminals in a wrap-around fashion, respectively extending across an entire end dimension and onto two adjacent surfaces thereof. Exemplary electrode configurations coupled with such wrap-around terminations may include a generally rectangular main portion with a single tab providing a narrow and highly resistive pathway from such terminations to the main electrode surface area.

In other examples, the typically rectangular main portion of each electrode pattern used in the subject embodiments may be altered to yield multiple substantially parallel portions in which current ultimately flows in opposing directions to improve current cancellation (thus lowering overall device inductance) while simultaneously increasing current path lengths (thus increasing amounts of controlled ESR).

In still further examples, mother and/or daughter electrodes of a given polarity are provided on front and back surfaces of a vertical electrode stack to facilitate formation of a device shield formed on multiple surfaces of the resultant MLC. Such an electrode shield offers additional advantages including heat dissipation and protection from electromagnetic interference (EMI) or emission.

One present exemplary embodiment relates to a unitary capacitor having low inductance and controlled Equivalent Series Resistance (ESR) features. Such a present capacitor preferably comprises a plurality of first conductive layers comprising at least one pair of mother electrodes adapted for connection externally to such unitary capacitor; a plurality of second conductive layers comprising at least one pair of daughter electrodes adapted for connection internally to such unitary capacitor; and a plurality of dielectric layers interleaved with such plurality of first and second conductive layers. With such an advantageous arrangement, such mother and daughter electrodes are in parallel connection and interdigitated with electrode tabs such that such daughter electrodes are only connected to other daughter electrodes and to selected mother electrodes without direct connection external to such unitary capacitor, while selected of such mother electrodes are connected externally to such unitary capacitor.

Another present exemplary embodiment relates to a multilayer ceramic capacitor incorporating both low inductance (ESL) and controlled Equivalent Series Resistance (ESR) features into a unitary device, having a low inductance section connected in parallel with a high ESR section. Such device preferably may include a first type of electrode pairs comprising mother electrodes adapted for external connection; and a second type of electrode pairs comprising daughter electrodes adapted only for internal connection to other electrodes within such capacitor without direct connection to an external circuit. Further included preferably are alternating dielectric layers among such electrode pairs; and outer lamination.

Yet another present exemplary embodiment relates to a low inductance controlled ESR multilayer capacitor, including interdigitated vertical electrodes, oriented in a substantially perpendicular direction relative to a mounting surface. Preferably, such vertical electrodes include at least one respective pair of mother and daughter electrode patterns, with circuit-connection tabs extending to a mounting surface and contacting selected of such mother electrode patterns, and with internal tabs extending to a surface opposite the mounting surface and connected to daughter electrode patterns and selected mother electrode patterns by internal-connection terminations.

It is to be understood that the present subject matter encompasses corresponding methodologies, one example of which relates to a method of providing a unitary capacitor having low inductance and controlled Equivalent Series Resistance (ESR) features. Such present exemplary method preferably comprises providing a plurality of first conductive layers comprising at least one pair of mother electrodes adapted for connection externally to the unitary capacitor; providing a plurality of second conductive layers comprising at least one pair of daughter electrodes adapted for connection internally to the unitary capacitor; forming a plurality of dielectric layers interleaved with the plurality of first and second conductive layers; and forming electrode tabs such that the mother and daughter electrodes are in parallel connection and interdigitated with the electrode tabs, with the daughter electrodes only connected to other daughter electrodes and to selected mother electrodes without direct connection external to the unitary capacitor, and with selected of the mother electrodes connected externally to the unitary capacitor.

Another present exemplary alternative methodology relates to a method of providing a multilayer ceramic capacitor incorporating both low inductance (ESL) and controlled Equivalent Series Resistance (ESR) features into a unitary device, having a low inductance section connected in parallel with a high ESR section. Such present exemplary embodiment may comprise providing a first type of electrode pairs comprising mother electrodes adapted for external connection; providing a second type of electrode pairs comprising daughter electrodes adapted only for internal connection to other electrodes within the capacitor without direct connection to an external circuit; forming alternating dielectric layers among the electrode pairs; and forming an outer lamination.

Yet another present exemplary embodiment relates to a method for providing a low inductance controlled ESR multilayer capacitor, including providing interdigitated vertical electrodes, oriented in a substantially perpendicular direction relative to a mounting surface, the vertical electrodes including at least one respective pair of mother and daughter electrode patterns, with circuit-connection tabs extending to a mounting surface and contacting selected of the mother electrode patterns, and with internal tabs extending to a surface opposite the mounting surface and connected to daughter electrode patterns and selected mother electrode patterns by internal-connection terminations.

Additional objects and advantages of the present subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments and uses of the present subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the Figures or stated in the detailed description of such Figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application.

### BRIEF DESCRIPTION OF THE DRAWINGS

A full and enabling disclosure of the present subject matter, including the best mode thereof, directed to one of ordinary skill in the art, is set forth in the specification, which makes reference to the appended Figures, in which:

FIGS. 1a-1c depict respective illustrations of a known configuration for providing a relatively low inductance part, using interdigitated electrodes to accomplish such low inductance, generally as described in U.S. Pat. Nos. 5,880,925 (DuPré et al.) and 6,243,253 B1 (DuPré et al.);

FIGS. 1d-1g depict respective illustrations of a technique for the application of anchor or dummy tabs to provide a substructure for deposition of thin-film plated terminations, such as electroless copper terminations, generally as described in U.S. Pat. No. 7,152,291 (Ritter et al.); and

FIGS. 2a-2g illustrate aspects of a first present exemplary embodiment of a multilayer capacitor incorporating both low inductance features and controlled ESR features, wherein exemplary electrode layers selectively include horizontal interdigitated configurations including a main portion and multiple tab portions as well as additional anchor or dummy tabs;

FIGS. 3a-3f illustrate aspects of a second present exemplary embodiment of a multilayer capacitor incorporating both low inductance features and controlled ESR features, wherein exemplary electrode layers selectively include horizontal interdigitated configurations including a main portion and multiple tab portions;

FIGS. 4a-4d depict respective illustrations of a technique for the formation of vertical electrodes for use in a low inductance capacitor, generally as described in U.S. Pat. No. 4,831,494 (Arnold et al.);

FIGS. 5a-5h illustrate aspects of a third present exemplary embodiment of a multilayer capacitor incorporating both low inductance features and controlled ESR features, wherein exemplary electrode layers selectively include vertical interdigitated configurations including a main portion and multiple tab portions;

FIGS. 6a-6h illustrate aspects of a fourth present exemplary embodiment of a multilayer capacitor incorporating both low inductance features and controlled ESR features, wherein exemplary electrode layers selectively include vertical electrodes with interdigitated configurations including a main portion and multiple tab portions;

FIGS. 7a-7i illustrate aspects of a fifth present exemplary embodiment of a multilayer capacitor incorporating both low inductance features and controlled ESR features, wherein exemplary electrode layers selectively include vertical electrodes with interdigitated features and wherein selected external terminations form resistive elements;

FIGS. 8a-8g illustrate aspects of a sixth exemplary embodiment of a multilayer capacitor incorporating both low inductance features and controlled ESR features, wherein exemplary electrode layers selectively include rotating corner tab locations, and wherein external terminations are selectively coupled together with resistive stripes;

FIGS. 9a-9h illustrate aspects of a seventh exemplary embodiment of a multilayer capacitor incorporating both low inductance features and controlled ESR features, wherein exemplary electrode layers selectively include vertical electrodes with interdigitated features and anchor tabs and wherein selected external terminations form resistive elements; and

FIGS. 10a-10c illustrate aspects of an eighth exemplary embodiment of a multilayer capacitor incorporating both low inductance features and controlled ESR features, wherein exemplary electrode layers selectively include anchor tab features with alternating locations such that resulting exposure location of electrode tabs and anchor tabs provides a conductive base to which thin-film plated terminations are formed in a generally serpentine pattern;

FIGS. 11a-11f illustrate aspects of a ninth exemplary embodiment of a multilayer capacitor incorporating both low inductance features and controlled ESR features, wherein exemplary electrode layers accommodate three-sided internal-connection terminals and relatively narrow pathways to the main portion of respective daughter electrodes;

FIGS. 12a-12d illustrate additional electrode features for possible inclusion in present exemplary embodiments of the disclosed subject matter, whereby electrode path length is increased to further increase ESR values, and improved current cancellation features are provided;

FIGS. 13a-13g illustrate aspects of a tenth exemplary embodiment of a multilayer capacitor for incorporating both low inductance features and controlled ESR features, also with EMI shielding and heat dissipation features; and

FIGS. 14a-14f illustrate aspects of an eleventh exemplary embodiment of a multilayer capacitor for incorporating both low inductance features and controlled ESR features, also with EMI shielding and heat dissipation features.

Repeat use of reference characters throughout the present specification and appended drawings is intended to represent same or analogous features, elements, or steps of the present subject matter.

### DETAILED DESCRIPTION OF THE PREFERRED EMBODIMENTS

As discussed in the Summary of the Invention section, the present subject matter is particularly concerned with improved device configurations and related methodologies for producing multilayer capacitors (MLCs) that incorporate features for providing both low inductance as well as a controlled level of ESR in a unitary device. Selected combinations of aspects of the disclosed technology correspond to a plurality of different embodiments of the present subject matter. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

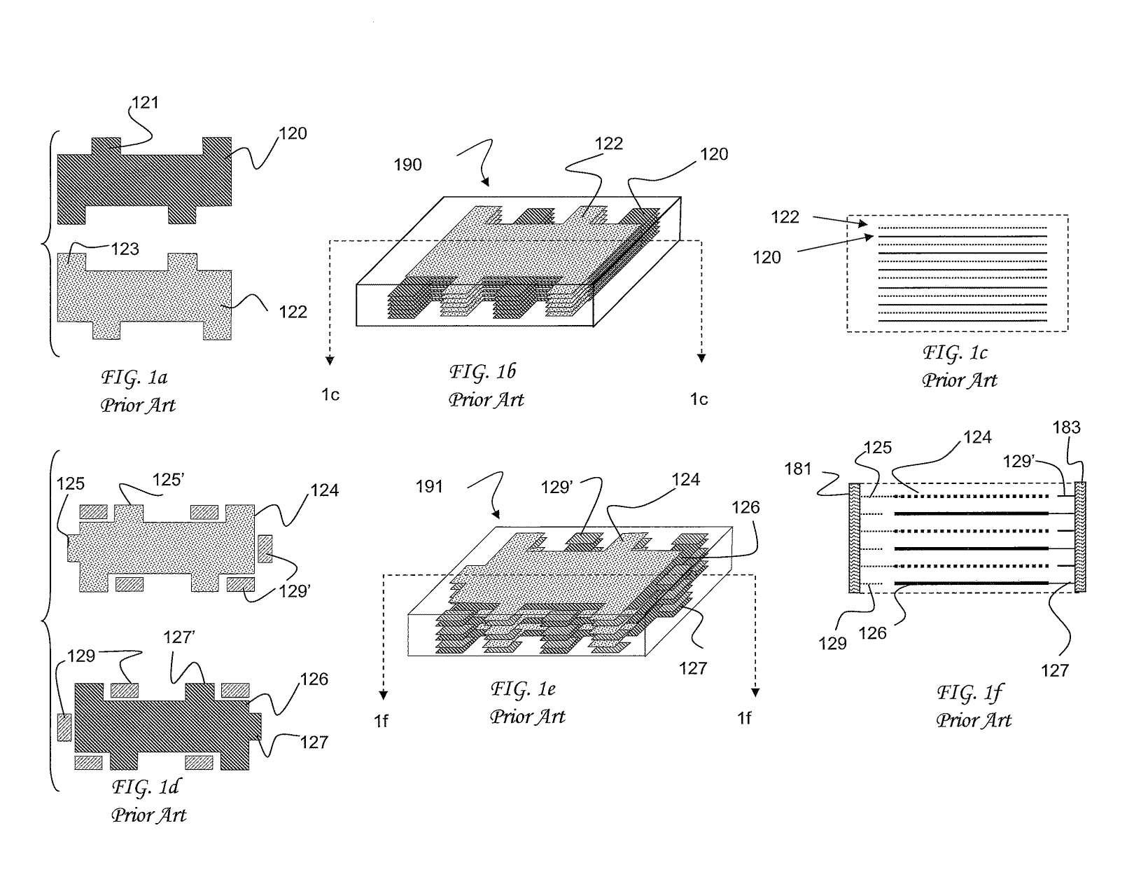

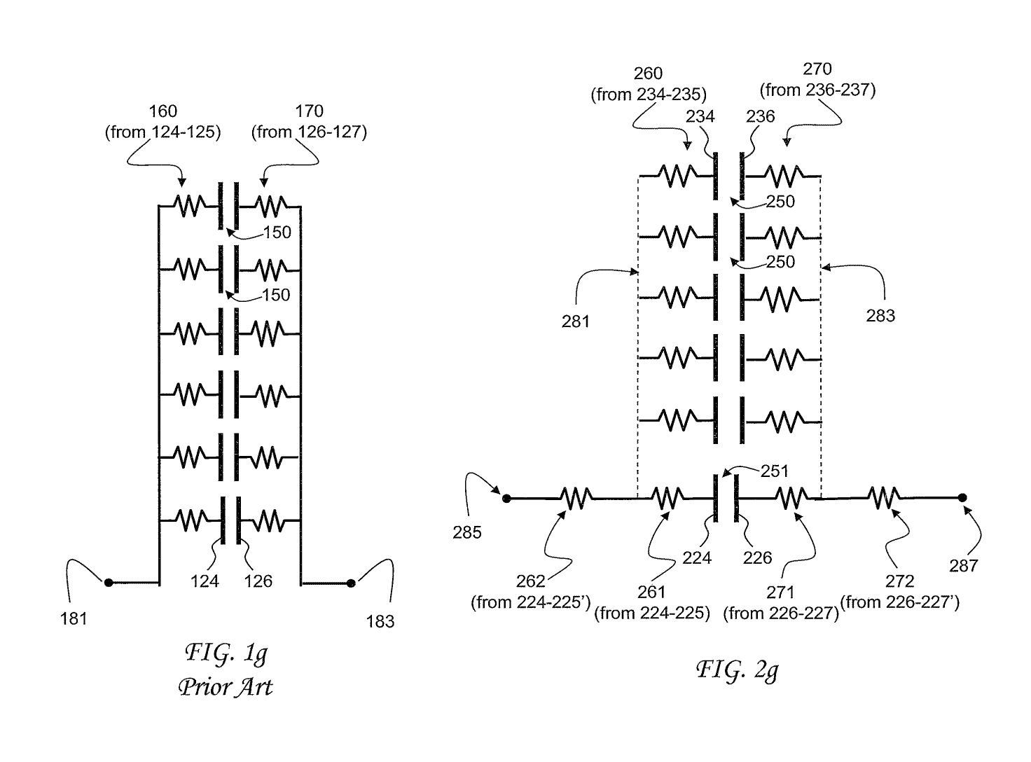

Reference will now be made in detail to the presently preferred embodiments of the subject multilayer device. Referring now to the drawings, FIGS. 1a-1c depict respective illustrations of a known configuration for providing a relatively low inductance part, using interdigitated electrodes to accomplish such low inductance, generally as described in U.S. Pat. Nos. 5,880,925 (DuPré et al.) and 6,243,253 B1 (DuPré et al.). Similarly, FIGS. 1d-1g depict respective illustrations of a technique for the application of anchor or dummy tabs to provide a substructure for deposition of thin-film plated terminations, such as electroless copper terminations, generally as described in U.S. Pat. No. 7,152,291 (Ritter et al.). Additional recognized aspects of such known configurations are described in U.S. Published Application No. 2008/0165468 (Berolini et al.), owned by Applicant and which is fully incorporated herein for all purposes by reference thereto.

Referring more particularly to FIG. 1a, a plan view of two versions of interdigitated electrodes are shown, namely first electrode layer 120 and second electrode layer 122. The first and second electrodes 120 and 122 are generally characterized by respective main portions and tab portions selectively extending therefrom. Such electrodes initially are printed on layers of dielectric material, such as sheets of green ceramic, and stacked in a multilayered arrangement, similar to the illustration as shown in exemplary FIG. 1b. FIG. 1b depicts a generally top and side perspective view of multiple pairs of the first and second electrode layers of FIG. 1a. Electrode layers 120 and 122 are interleaved with layers of dielectric material on which they are printed to form the nearly completed exemplary device 190, illustrated without the interleaved dielectric layers and without termination.

FIG. 1c illustrates a cross-section of exemplary device 190 as taken along the section line 1c-1c illustrated in present FIG. 1b. Different electrode polarities are represented by different line types. Interior solid lines in the cross-sectional view of FIG. 1c correspond to first electrodes 120 (of a first polarity) and interior dotted lines correspond to second electrodes 122 (of a second polarity, generally opposite that of the first polarity).

FIG. 1d provides a plan view of first and second electrode structures 124 and 126, which are similar in some respects but more advanced in other respects to the known configuration of FIGS. 1a-1c. In a fashion similar to the structure as described in U.S. Pat. No. 7,152,291 (Ritter et al.), dummy tabs 129 and 129′ respectively provide support and nucleation points for electroless copper termination. Electrodes 124 and 126 are similar in some respects to electrodes 120 and 122 of present FIG. 1a, including a main portion and respective side tabs 125′ and 127′. In addition, electrodes 124 and 126 also are provided with end tabs 125 and 127. The function of such tabs, as described in U.S. Pat. No. 5,880,925 (DuPre et al.) is to reduce inductance and resistance, and to provide for ease of testing during the manufacturing process.

In a manner similar in some respects to that as described above, pairs of the patterned electrode layers 124 and 126, along with corresponding anchor tabs 129, 129′, are alternately stacked with their printed dielectric layers vertically as shown in FIG. 1e, to provide a device 191 (dielectric layers and termination not shown). Tabs 129 and 129′ are also provided along respective device ends to provide anchor points for subsequent termination.

FIG. 1f illustrates a cross-sectional view of the subject matter of FIG. 1e, taken along section line 1f-1f thereof. Again, different polarity electrodes 124 and 126, as well as tabs 125, 127, 129 and 129′ are shown with different line types. Dotted interior lines are used to represent end tabs 125 of first electrode layers 124 as well as anchor tabs 129, all of which are directly connected to a peripheral termination 181. Anchor tabs 129′ as well as the opposing electrodes 126 and respective end tabs 127 are connected to another peripheral termination 183. Both sets of co-planar anchor tabs 129, 129′ are employed to assist with nucleation of subsequent thin-film plating, such as electroless copper plating, if used. It should be appreciated that if standard terminations, such as printed thick-film layers, are applied, anchor tabs 129 or 129′ may not be needed. The respective main portions of electrodes 124 and 126 that overlap each other to form respective capacitors that are connected in parallel are indicated in FIG. 1f by thicker line weight towards the central interior portion of the capacitor.

While the designs discussed above relative to FIGS. 1a-1f are useful for their intended purposes, it has been presently determined that there is a potential drawback of such designs in some instances. Such drawback can occur due to the circumstance that the relatively large number of parallel electrodes and their associated parallel resistors combine to provide a very low resistance. In some instances, undesirable effects have been observed in the final circuits in which they are used, including mismatching of impedances, and including a phenomenon known as “ringing”.

Referring now to FIG. 1g, a schematic representation of the structural components indicated in FIGS. 1a-1f is provided. Correlation between schematic elements in FIG. 1g is made to structural elements of device 191 shown in FIGS. 1d-1f, respectively, although it should be appreciated that FIG. 1g equally applies in certain respects to the similar structural elements of device 190 shown in FIGS. 1a-1c. In FIG. 1g, each capacitance 150 is representative of the parallel-plate capacitance formed between each pair of an opposing first electrode 124 and second electrode 126. Resistances 160 respectively depict the resistance provided by the main portion of each electrode 124 and corresponding end tab portion 125. Resistances 170 respectively depict the resistance provided by the main portion of each electrode 126 and corresponding end tab portion 127. A typical value for the resistance 160 or 170 formed from a given electrode tab structure and the electrode itself might be about one ohm.

In a typical capacitor, many layers (sometimes hundreds) are involved. For simplicity and for ease of illustration, the following considers an exemplary set of six capacitor-resistor sets in parallel, each set including a capacitor 150 provided in series between two resistors 160 and 170. Further for the present example, the total resistance of each capacitor (including a resistance 160 and a resistance 170 in series) will be regarded as one ohm, and with each capacitance value at one nano-farad. By analytical tools familiar to any one skilled in the art, the capacitances in the configuration of present FIG. 1g will add for an exemplary total capacitance of six nano-farads. The resistances combine by the well-known reciprocal rule, such that the net resistance is 0.166 ohms, or 166 milliohms. Such is the resistance that would be measured at terminals 181 and 183 of the exemplary configuration of present FIG. 1g. It can be appreciated then, that with capacitors which can have hundreds of layers, the resistance can be very low, such as down to only a few milliohms.

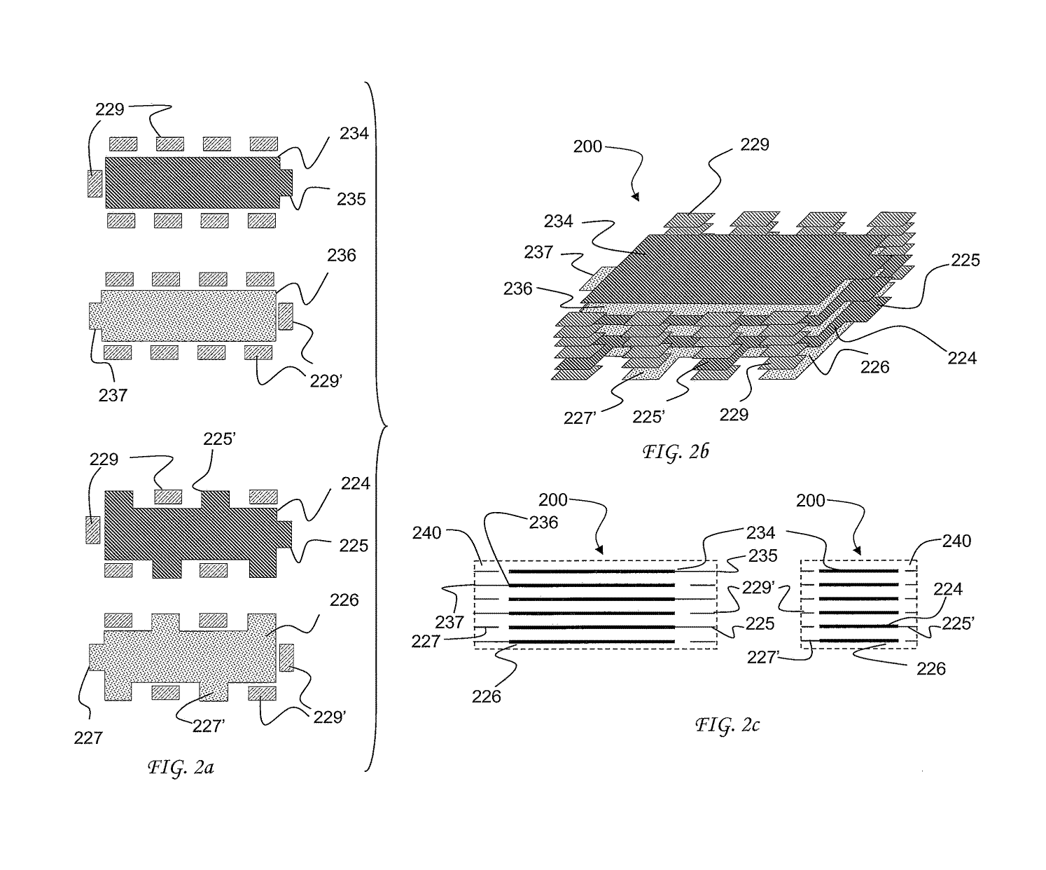

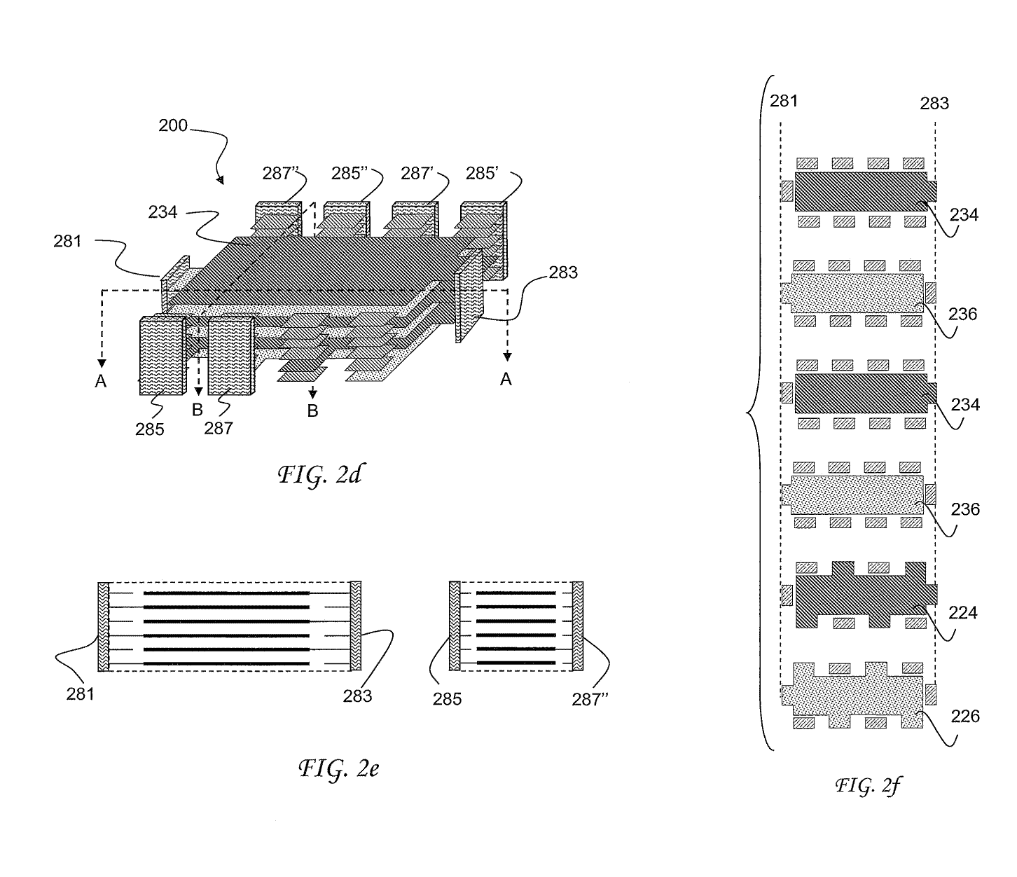

Efforts at controlling capacitor parameters related to ESR are disclosed in several of the references already described above in the Background of the Invention section. However, such designs do not include all the features and advantages of the present technology as will now be described with reference to FIGS. 2a-3f and 5a-12d, respectively. One of ordinary skill in the art will appreciate from such figures and the following relevant description, that unitary devices may be formed that provide controlled ESR while not sacrificing low inductance, thus selectively improving the performance characteristics for multilayer capacitors used for decoupling and other generally high-frequency applications.

As will be apparent from the following description, many of the improved capacitor embodiments in accordance with the present subject matter generally include at least two different types of electrode pairs, as opposed to the single pair type illustrated in and described with reference to FIGS. 1a-1f. Some of the electrodes will be adapted for external connection (e.g., to a circuit, another electrical component, circuit board, or other mounting environment). Such first type of electrodes will be referred to herein as “mother electrodes.” Others of the electrodes will be adapted only for internal connection to other electrodes without direct connection to an external circuit, and such electrodes will be referred to herein as “daughter electrodes.” In general, daughter electrodes, although not directly connected to an external location, can be connected to other daughter electrodes and/or to selected mother electrodes within an MLC. In some embodiments, mother electrodes and daughter electrodes will be provided in respective pairs of a first polarity and a second polarity electrode, thus often yielding four different electrode patterns (two mother electrode patterns and two daughter electrode patterns) for use in a each MLC.

Referring still to the use of exemplary terminology, the specification will sometimes make reference to two different types of peripheral terminals and two different types of electrode tabs. External terminals that will be used to connect an MLC to an external location (e.g., to a circuit, another electrical component, circuit board, or other mounting environment) will be referred to as “circuit-connection terminals/terminations.” External terminals that are used only to connect different electrodes to one another as opposed to connecting such electrodes to an external circuit location will be referred to as “internal-connection terminals/terminations.” Based on the definition of mother and daughter electrodes provided above, it will be inherent that circuit-connection terminals generally provide a direct electrical connection between mother electrodes and an external circuit location. Internal-connection terminals link mother and daughter electrodes together. When mother and daughter electrodes have integral tab portions extending from a main electrode portion, the tab portions (or tabs) being provided for forming an electrical connection pathway to the given electrode, such tab portions may generally be referred to herein as one of two different types—“circuit-connection tabs” or “internal-connection tabs.” If the tabs are used to form an electrical pathway from an electrode to a circuit-connection terminal, then the tabs are “circuit-connection tabs.” If the tabs are used to form an electrical pathway from an electrode to an internal-connection terminal, then the tabs are “internal-connection tabs.”

It should be further appreciated that use of directional terminology herein, such as “bottom” or “top” designations, is merely to help describe relative functional relationships among surfaces and elements herein. As such, these designations should not be unnecessarily limiting to the embodiments of the present subject matter.

Referring now to FIGS. 2a through 2f, a first exemplary embodiment of an improved present device and methodology with both low inductance and controlled ESR features is provided. Rather than using just two electrode configurations, the present exemplary embodiment of the subject matter of present FIGS. 2a through 2f uses four.

As shown in FIG. 2a, the first two electrodes 224 and 226 for use in the first exemplary embodiment of the disclosed technology are depicted in the two bottommost plan views. Electrodes 224 and 226 are similar in some respects to the shape of electrodes 124 and 126 of the prior art device illustrated in present FIG. 1d, but will function as mother electrodes since they will be connected to an external circuit location. A single pair of first and second (mother) electrode layers 224 and 226 (and corresponding anchor tabs 229, 229′) are provided at the beginning of a laminated stack of electrode layers.

Each first electrode 224 includes a substantially rectangular main portion with two circuit-connection tabs 225′ attached to and extending from a first longer side edge and two circuit-connection tabs 225′ attached to and extending from a second longer side edge of the main portion of electrode 224. An internal-connection tab 225 also is attached to and extends from an end edge of the electrode 224. Five dummy tabs 229, two each provided adjacent to each longer side edge and in between respective circuit-connection tabs 225′ of electrode 224 and one provided at the end edge opposite tab 225, are provided.

Each second electrode 226 includes a substantially rectangular main portion with two circuit-connection tabs 227′ attached to and extending from a first longer side edge and two circuit-connection tabs 227′ attached to and extending from a second longer side edge of the main portion of electrode 226. An internal-connection tab 227 also is attached to and extends from an end edge of the second electrode 226. Five dummy tabs 229′, two each provided adjacent to each longer side edge and in between respective side tabs 227′ of electrode 226 and one provided at the end edge opposite tab 227, are provided.

Referring still to FIG. 2a, third and fourth electrodes 234 and 236 generally include a substantially rectangular main electrode portion with respective internal-connection tabs 235 and 237 provided on alternate ones of the shorter (end) sides of the main electrode portion. Third and fourth electrodes 234 and 236 are daughter electrodes, and have only one connection to the outside world (through peripheral terminations), which is by way of connection to either internal-connection end tab 235 or internal-connection end tab 237. Exemplary dummy tabs 229 and 229′ associated with the third and fourth electrodes 234 and 236 now number nine and by definition, are not connected to the electrode bodies. Dummy tabs 229 associated with third electrode 234 in FIG. 2a are located in a spaced co-planar relationship to the main portion of electrode 234, with four dummy tabs 229 provided adjacent to a first (longer) side edge of the electrode 234, four additional dummy tabs 229 provided adjacent to a second (longer) side edge of the electrode 234, and one additional dummy tab 229 provided adjacent to a third (shorter) end edge of the electrode 234. Similarly, dummy tabs 229′ associated with the fourth electrode 236 in FIG. 2a are located in a spaced co-planar relationship to electrode 236, with four dummy tabs 229′ provided adjacent to a first (longer) side edge of the electrode 236, four additional dummy tabs 229′ provided adjacent to a second (longer) side edge of the electrode 236, and one additional dummy tab 229′ provided adjacent to a third (shorter) end edge of the electrode 236.

Referring now to FIG. 2b, the first, second, third and fourth electrode patterns described above in FIG. 2a are alternately stacked with interleaved dielectric layers to form a device 200, such as shown in present FIG. 2b, with cross-sectional views thereof per present FIG. 2c. For ease of illustration, the dielectric layers and terminations are not shown in FIG. 2b, although it should be appreciated that the thickness of the dielectric layers between electrode sheets may be selected to provide a predetermined capacitance value for each parallel-plate capacitance formed between electrode pairs. In one particular example, dielectric layers are characterized by a thickness of about 3-5 μm (4 μm in a particular exemplary embodiment) and electrode layers are characterized by a thickness of about 1-2 μm (1.5 μm in a particular exemplary embodiment). It should also be appreciated that sometimes multiple sheets of dielectric material may be applied between electrodes, thus resulting in a thickness of two or three or more times the 3-5 μm range, to optimize the FCT termination scheme.

When thin-film plated terminations are employed, the thickness of the dielectric layers may also be chosen such that exposed edges of electrode tabs (and anchor tabs) in each grouped column are close enough together (e.g., no more than about eight to ten microns in one exemplary embodiment) such that plated material deposits thereon and laterally bridges to other adjacent exposed tabs in a given group. Still further, it should be noted that the thickness of dielectric layers on the top and bottom of the electrode stacks may be slightly greater to form dielectric cover layers that provide additional mechanical protection and structural integrity for the resultant device. Dielectric material and the electrodes may respectively be applied in layers, or sheets, as a device is being formed. However, it should be appreciated that after firing, a finished device may be considered as a block of dielectric material in which electrodes are embedded.

Referring still to FIG. 2b, such figure illustrates one pair of first and second electrodes 224 and 226 (i.e., mother electrodes) provided at the bottom of the stack, followed by two pairs of third and fourth electrodes 234 and 236 (i.e., daughter electrodes). It should be appreciated that only two pairs of third and fourth electrodes are illustrated for ease and clarity of illustration, when in fact many more pairs, for example on the order of 100-1000 pairs, may be employed depending on the desired amount of capacitance for the final device 200. In addition, it should be appreciated that in exemplary devices where device symmetry is preferred such that mounting can occur to either top or bottom surfaces, an additional pair of first and second electrode layers 224 and 226 (i.e., mother electrodes) may be provided on the opposite end of the stack (i.e., the top of the stacked configuration in FIG. 2b). In still further alternative examples, it should be appreciated that the mother and/or daughter electrodes don't necessarily have to be provided in even numbers, for example, a stacked assembly could include groups of three mother electrodes including two first mother electrodes and one second mother electrode. Additional combinations of numbers of electrodes may be used, although it is generally preferred to have a fewer number of mother electrodes than daughter electrodes.

FIG. 2c provides two cross-sectional views of first exemplary capacitor embodiment 200 namely, a longitudinal cross-section on the left and a transverse cross section on the right. From the longitudinal cross-section of FIG. 2c, it is apparent that each of the first and second electrodes 224 and 226 (i.e., mother electrodes) as well as third and fourth electrodes 234 and 236 (i.e., daughter electrodes) extends to and is exposed along one of two end surfaces by an internal-connection end tab 235, 237, 225 or 227. From the transverse cross-sectional view of FIG. 2c, it is apparent that only the first and second electrodes 224 and 226 (i.e., mother electrodes) include directly connected tabs (225′ and 227′) that extend to and are exposed along the two side surfaces of the device 200. Areas 240 in the respective cross-sectional views generally correspond to the dielectric material provided between the various electrode layers and anchor tabs.

It should be appreciated that different materials known to those of ordinary skill in the art may be selected for forming the electrodes and dielectric material of the subject capacitors. For example, electrodes 224, 226, 234 and 236 as well as surrounding anchor tabs 229, 229′ may be formed of a variety of different conductive materials, such as but not limited to platinum, silver, nickel, copper, a palladium-silver alloy, combinations of these and/or other conductive materials, or other suitable conductive substances. Dielectric material 240 may comprise a ceramic, semiconductive, or insulating material, such as but not limited to barium titanate, zinc oxide, alumina with low-fire glass, or other suitable ceramic or glass-bonded materials. Alternatively, dielectric material 240 may be an organic compound such as an epoxy (with or without ceramic mixed in, with or without fiberglass), popular as circuit board materials, or other plastics common as dielectrics. In these cases the conductor is usually a copper foil which is chemically etched to provide the patterns. In still further embodiments, dielectric material 240 may comprise a material having a relatively high dielectric constant (K), such as barium and strontium titanate combinations, known generally as NPO (COG), X7R, X7S, Z5U, or Y5V.

Additional aspects of the first exemplary capacitor embodiment 200 can be appreciated from FIGS. 2d through 2f, respectively, which provide various illustrations of such first embodiment 200 after the application of peripheral terminations. In some embodiments, exemplary terminations are formed by a process of precisely self-depositing thin-film plating over adjacent groups of exposed conductive portions (such as grouped columns of exposed electrode edges, electrode tab edges and/or anchor tab edges). Thin-film plating layers may be applied by different processes, such as electroless or electrolytic plating, and may correspond to different types of conductive or resistive materials, such as but not limited to copper, nickel, tin or tin-lead, gold and other metals. Additional details for forming plated terminations is provided, for example, in U.S. Pat. No. 7,154,371 (Ritter et al.) which is incorporated herein for all purposes by virtue of present reference thereto.

FIG. 2d provides a generally top and side perspective view of the same electrode configuration from FIG. 2b with the addition of terminations (two of which are left off for clarity). Side terminations 285, 285′, 285″ and a fourth termination which is not shown electrically connect to the side tabs 225′ of first electrode layer 224. Selected alternating anchor tabs 229 surrounding each third electrode layer 234 and anchor tabs 229′ surrounding each second and fourth electrode layer are also directly connected to the side terminations 285, 285′ and 285″, not to provide electrical connection to the second, third and fourth electrodes 226, 234, 236, respectively, but to offer additional nucleation and guide points for the deposition of thin-film plated terminations, such as electroless copper terminations. Side terminations 287, 287′, 287″ and a fourth termination which is not shown electrically connect to the side tabs 227′ of second electrode layer 226. Selected alternating anchor tabs 229′ surrounding each fourth electrode layer 236 and anchor tabs 229 surrounding each first and third electrode layer are also directly connected to the side terminations 287, 287′ and 287″, not to provide electrical connection to the first, third and fourth electrodes 224, 234, 236, respectively, but to offer additional nucleation and guide points for the deposition of thin-film plated terminations, such as electroless copper terminations. Selected ones or all of the side terminals 285, 287 are adapted for providing electrical connection to an external circuit location, and so are referred to as circuit-connection terminals. Corresponding electrode tabs that are directly connected to the circuit-connection terminals 285, 287 (including tabs 225′ and 227′) as well as selected ones of the anchor tabs 229, 229′ that are directly connected to circuit-connection terminals 285, 287 are thus circuit-connection tabs.

Referring still to FIG. 2d, end terminations 281 and 283 are generally configured not for electrical connection to an external location, but to internally connect the multiple mother and daughter electrodes together. Providing such internal-connection terminals on the ends of the device may, in some embodiments, provide for ease of testing during the manufacturing process. Internal-connection terminal 281 is directly connected to each second (mother) electrode 226 by way of an internal-connection tab 227 and to each fourth (daughter) electrode 236 by way of internal-connection tab 237. Internal-connection terminal 281 may also be connected to anchor tabs 229 (if provided) at an end of each first (mother) electrode 224 and an end of each third (daughter) electrode 234. Internal-connection terminal 283 is directly connected to each first (mother) electrode 224 by way of an internal-connection tab 225 and to each third (daughter) electrode 234 by way of internal-connection tab 235. Internal-connection terminal 283 may also be connected to anchor tabs 229′ (if provided) at an end of each second (mother) electrode 226 and each fourth (daughter) electrode 236.

Referring now to FIG. 2f, such figure provides an exploded view of the stacked electrodes in such embodiment, with alignment relative to the location for applying internal-connection end terminations 281 and 283. The direction of lamination as represented in such figure starts at the bottom of the figure with the pair of electrodes 224 and 226, followed by subsequently stacked pairs of third and fourth electrodes 234 and 236.

FIG. 2e depicts the same longitudinal and transverse cross-sectional views as FIG. 2c, with the addition of terminations. The longitudinal cross-section on the left in FIG. 2e corresponds to a cross-section of FIG. 2d taken along section line A-A thereof showing internal-connection end terminations 281 and 283. The transverse cross-section on the right in FIG. 2e corresponds to a cross-section of FIG. 2d take along section line B-B thereof showing one set of circuit-connection terminations, namely side terminations 285 and 287″.

A notable present aspect of the first exemplary embodiment 200 of FIGS. 2a-2f is that the interdigitated electrode tabs 225′, 227′ (i.e., circuit-connection tabs) electrically connect the side terminations (circuit-connection terminals) only to the bottom two electrode surfaces (the pair of first and second mother electrodes 224 and 226). Since the inductance is primarily determined by the closest planes to the circuit board, such device 200 is thus a low inductance capacitor. External circuit connection is only made directly to the lower two layers, first and second electrodes 224 and 226). The rest of the electrode stack, consisting of electrode designs 234 and 236, are connected together in parallel (via the end terminations 281 and 283) but are only connected in series to the ends of electrodes 224 and 226, respectively. Electrical connection is only made internally to the third and fourth electrodes 234 and 236. By providing a large number of pairs of third and fourth (daughter) electrodes 234 and 236, an MLC with relatively high capacitance can be achieved, while still maintaining overall low inductance by forming a circuit board connection to only the first and second electrodes 224 and 226. Still further, increased or controlled amounts of ESR are provided, as will now be discussed relative to the FIG. 2g.

The approximated equivalent circuit of present FIG. 2g represents various present advantages of the first exemplary embodiment 200, including desirable ESR and ESL performance characteristics. For the sake of comparison to the equivalent circuit of FIG. 1g, the same number of electrodes is used (i.e., a total of twelve electrodes). In an exemplary device 200, this corresponds to one pair of first and second electrodes 224, 226 and five pairs of third and fourth electrodes 234, 236.

For example, assuming the same exemplary values for resistance and capacitance as in the previous example of FIG. 1g, each pair of third and fourth (daughter) electrode plates 234 and 236 forms a capacitance 250 in series with a resistance 260 associated with electrode 234 and its end tab 235 and a resistance 270 associated with electrode 236 and its end tab 237. Each of these series combinations of resistance 260, capacitance 250 and resistance 270 is connected in parallel by the internal-connection end terminations 281 and 283. Such parallel combination electrically combines to yield net parameters including a capacitance of 5.0 nano-farads, and a resistance of 0.2 ohms. In increasing the amount of resistance, it is advantageous that the current flow through such upper electrodes 234 and 236 runs in the longest dimension of each electrode sheet from end of the device at end terminal 281 to the other lengthwise end of the device at end terminal 283 before flowing to the next adjacent electrode in the stack.

Referring still to FIG. 2g, additional schematic elements are formed from the pair of first and second (mother) electrodes 224 and 226. More particularly, such opposing plates 224 and 226 form a capacitance 251 rated at about 1.0 nano-farads, which is combined in series with a resistance 261 (formed by the resistance of plate 224 in the lengthwise direction (from end to end) in addition to the resistance of end tab 225) and a resistance 271 (formed by the resistance of plate 226 in the lengthwise direction (from end to end) in addition to the resistance of end tab 227). Assuming again that the total resistance for the capacitor 251 (including both resistances 261 and 271) is about 1.0 ohms, then a 1.0 ohm resistance and 1.0 nano-farad capacitance is combined in parallel with the above capacitance of 5.0 nano-farads and resistance of 0.2 ohms to yield a capacitance of about 6.0 nano-farads and a resistance of about 0.166 ohms. This resistance of about 0.166 ohms is then added in series with respective resistances 262 and 272. Resistance 262 generally corresponds to the resistance of electrode 224 in the widthwise direction (from side to side) in addition to the resistance of side tabs 225′. Resistance 272 generally corresponds to the resistance of electrode 226 in the widthwise direction (from side to side) in addition to the resistance of side tabs 227′. If the width of the device 200 is about half the length of such device, then resistors 262 and 272 can be expected to be about 0.5 ohms. Combining the 0.5 ohms from resistors 262 and 272 with the 0.166 ohms equivalent resistance between terminals 281 and 283, an overall resistance for the device of about 0.666 ohms is achieved with an overall capacitance of about 6.0 nano-farads. This value compares with 166 milliohms of the device represented in FIG. 1g, so the benefits of such presently constructed devices may by comparison be appreciated.

Those of ordinary skill in the art will appreciate two important points from the present disclosure. First, as the number of 234-236 daughter electrode pairs gets very much larger, the differences between the net resistances of such construction vis-à-vis the prior art constructions of FIGS. 1a-1f get larger. The second point is that the presently disclosed device can be made symmetrical for mounting purposes by putting a similar pair of mother electrodes 224 and 226 at the upper end of the stack, with only a resulting relatively small sacrifice in resistance increase, especially with many layers.

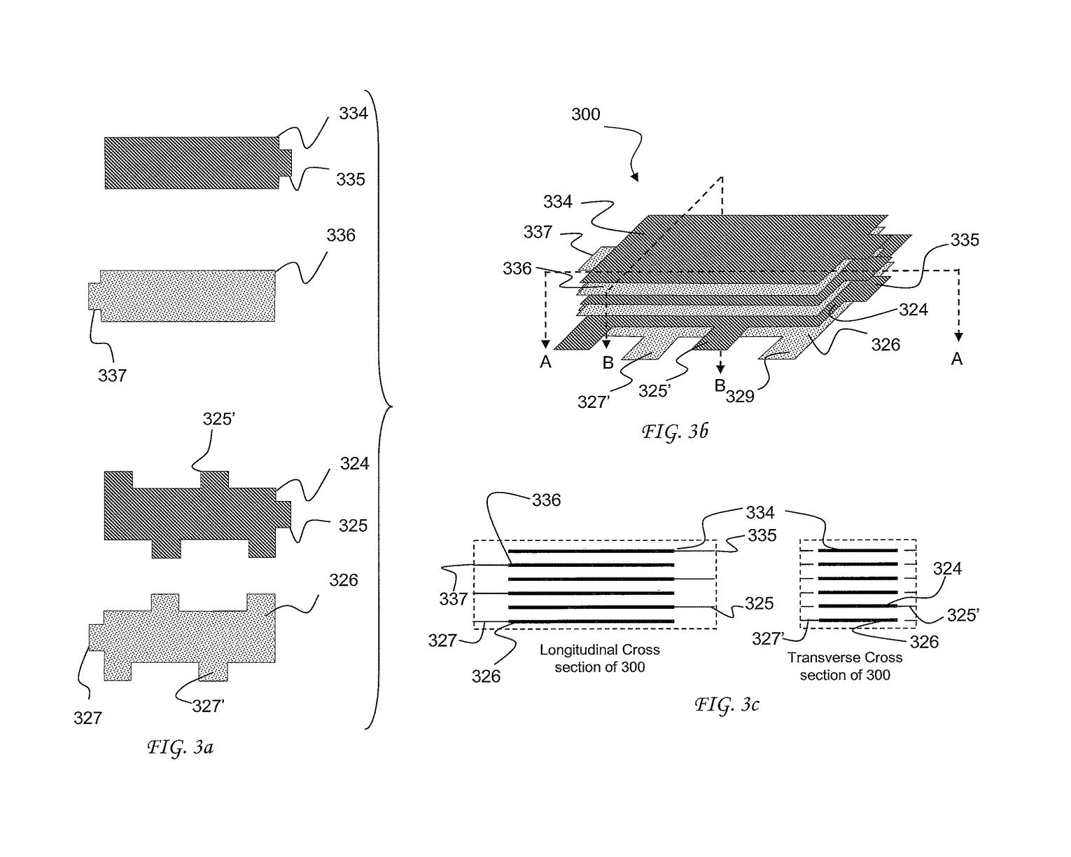

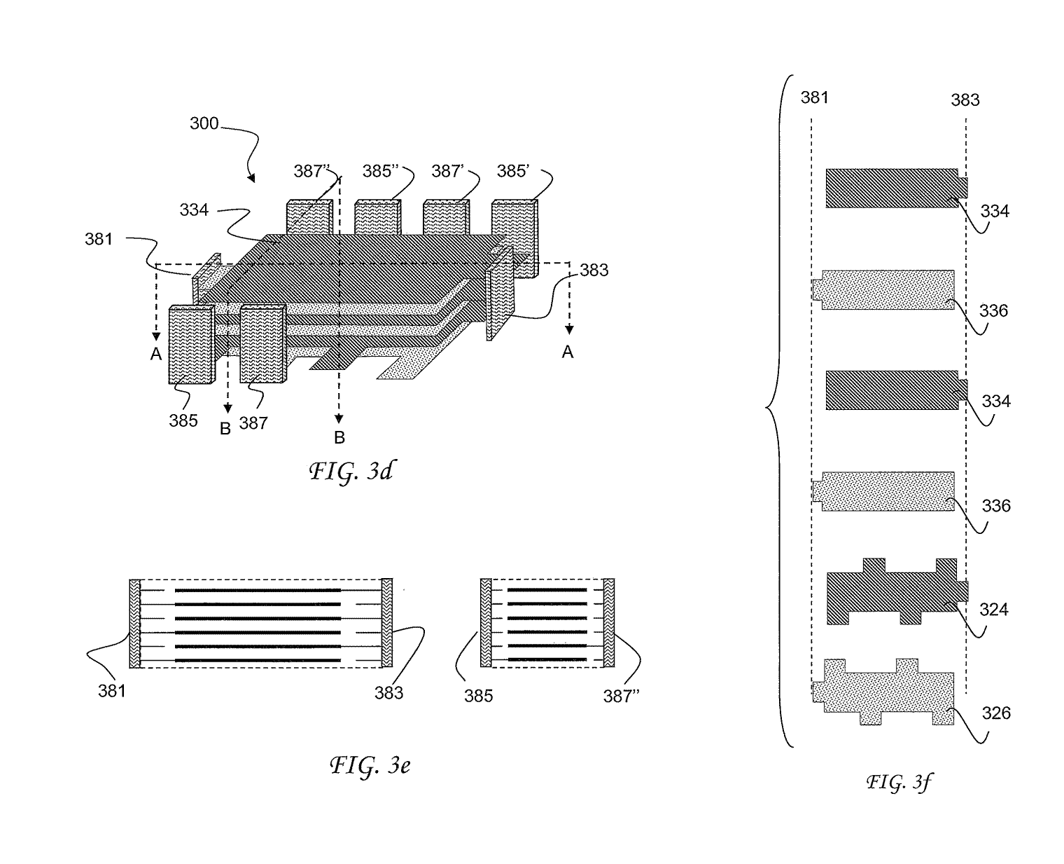

Referring now to FIGS. 3a-3f, a second exemplary embodiment (generally, device 300) of the present capacitor technology will now be discussed. FIGS. 3a-3f are similar in many respects to the prior FIGS. 2a-2f, except that anchor tabs 229, 229′ are not employed.

As such, with reference to FIG. 3a, a first mother electrode 324 includes a generally rectangular main portion with two circuit-connection tabs 325′ provided on a first side of the main portion, two circuit-connection tabs 325′ provided on a second side of the main portion, and a single internal-connection tab 325 provided on one end of the main portion. A second mother electrode 326 is provided in a pair with first mother electrode 324. Second electrode 326 also includes a substantially rectangular main portion with two circuit-connection tabs 327′ provided on a first side of the main portion, two circuit-connection tabs 327′ provided on a second side of the main portion, and a single internal-connection tab 327 provided on an end of the main portion opposite internal-connection end tab 325 (from electrode 324). Each third electrode 334 is a daughter electrode consisting of a substantially rectangular portion with an internal-connection end tab 335 attached to and extending from a first end. Each fourth electrode is a daughter electrode 336 including a substantially rectangular portion with an internal-connection end tab 337 attached to and extending from a second end (where the second end is opposite that of the first end from which tab 335 extends from the first electrode 334).

As shown in FIG. 3b, one pair of first and second (mother) electrodes 324 and 326 are alternately stacked with dielectric layers (not shown for ease and clarity of illustration) on top of which are one or more pairs (typically many) of third and fourth (daughter) electrodes 334 and 336, also with corresponding interleaved dielectric layers. A longitudinal cross-section view of the device 300 of FIG. 3b taken along section line A-A is provided in the left portion of FIG. 3c. A transverse cross-sectional view of the device 300 of FIG. 3b taken along section line B-B is provided in the right portion of FIG. 3c.

Additional aspects of the second exemplary capacitor embodiment 300 can be appreciated from FIGS. 3d through 3f, respectively, which provide various illustrations of such second embodiment 300 after the application of peripheral terminations.

FIG. 3d provides a generally top and side perspective view of the same electrode configuration from FIG. 3b with the addition of terminations (two of which are left off for clarity). Circuit-connection terminations 385, 385′, 385″ and a fourth termination which is not shown electrically connect to the circuit-connection tabs 325′ of first (mother) electrode layer 324. Circuit-connection terminations 387, 387′, 387″ and a fourth termination which is not shown electrically connect to the circuit-connection tabs 327′ of second (mother) electrode layer 326. Internal-connection termination 381 forms a direct electrical connection to the internal-connection tab 327 of each second (mother) electrode 326 and to the internal-connection tab 337 of each fourth (daughter) electrode. Internal-connection termination 383 forms a direct electrical connection to the internal-connection tab 325 of each first (mother) electrode 324 and to the internal-connection tab 335 of each third (daughter) electrode 334.

FIG. 3e depicts the same longitudinal and transverse cross-sectional views as FIG. 3c, with the addition of terminations. The longitudinal cross-section on the left in FIG. 3e corresponds to a cross-section of FIG. 3d taken along section line A-A thereof showing internal-connection end terminations 381 and 383. The transverse cross-section on the right in FIG. 3e corresponds to a cross-section of FIG. 3d take along section line B-B thereof showing one set of circuit-connection terminations, namely side terminations 385 and 387″.

Referring now to FIG. 3f, such figure provides an exploded view of the stacked electrodes in such embodiment (with alignment relative to the location for applying internal-connection end terminations 381 and 383). The direction of lamination as represented in such figure starts at the bottom of the figure with the pair of mother electrodes 324 and 326, followed by subsequently stacked pairs of daughter electrodes 334 and 336.

The first and second exemplary devices 200 and 300 described above are generally configured such that the device is connected to a circuit board or other mounting substrate only through the side terminations (e.g., 285, 285′, 285″, 287, 287′, 287″, etc. for the first embodiment 200, and 385, 385′, 385″, 387, 387′, 387″, etc. for the second embodiment 300). Traces can be provided on the circuit board or mounting surface to attach to such side terminations. When mounted, each of the first, second, third and fourth internal electrodes is configured in a substantially parallel direction relative to the mounting surface, thus yielding so-called “horizontal electrodes.” If lower ESR is desired, a circuit connection can be made to either or both of these end terminals 381 or 383.

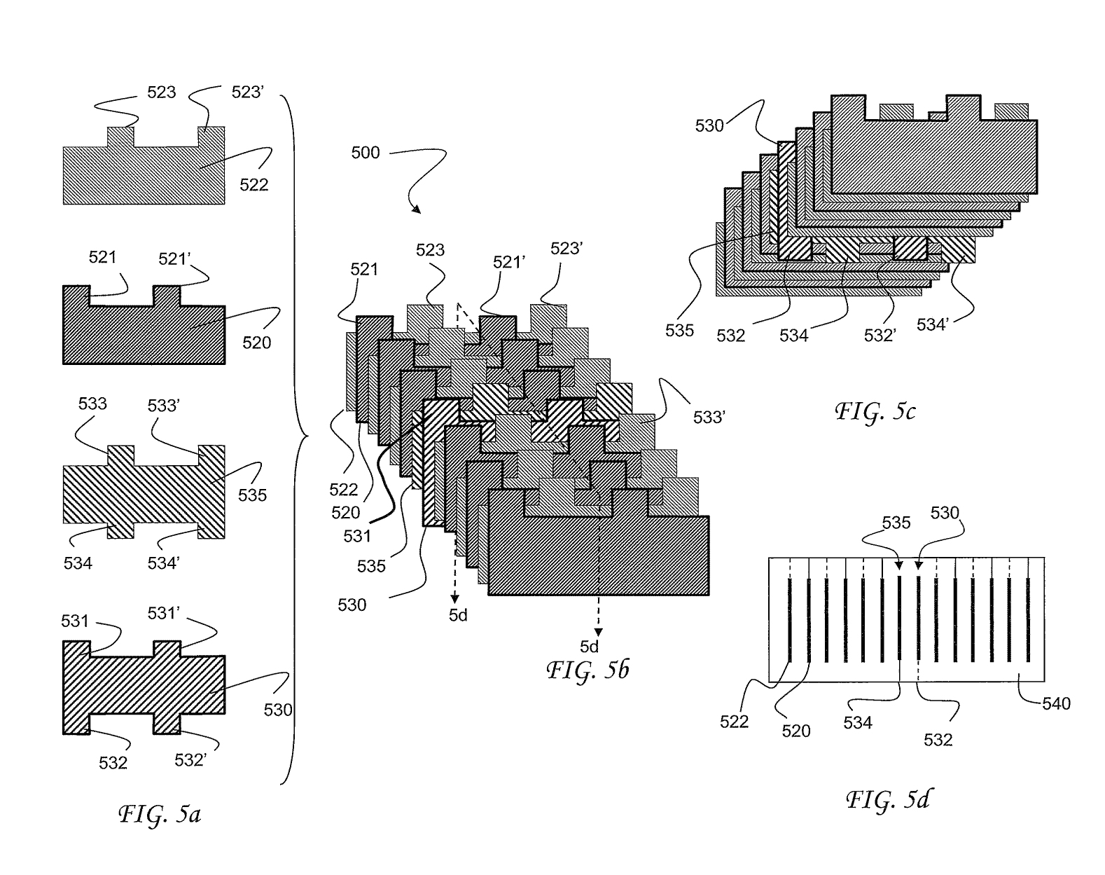

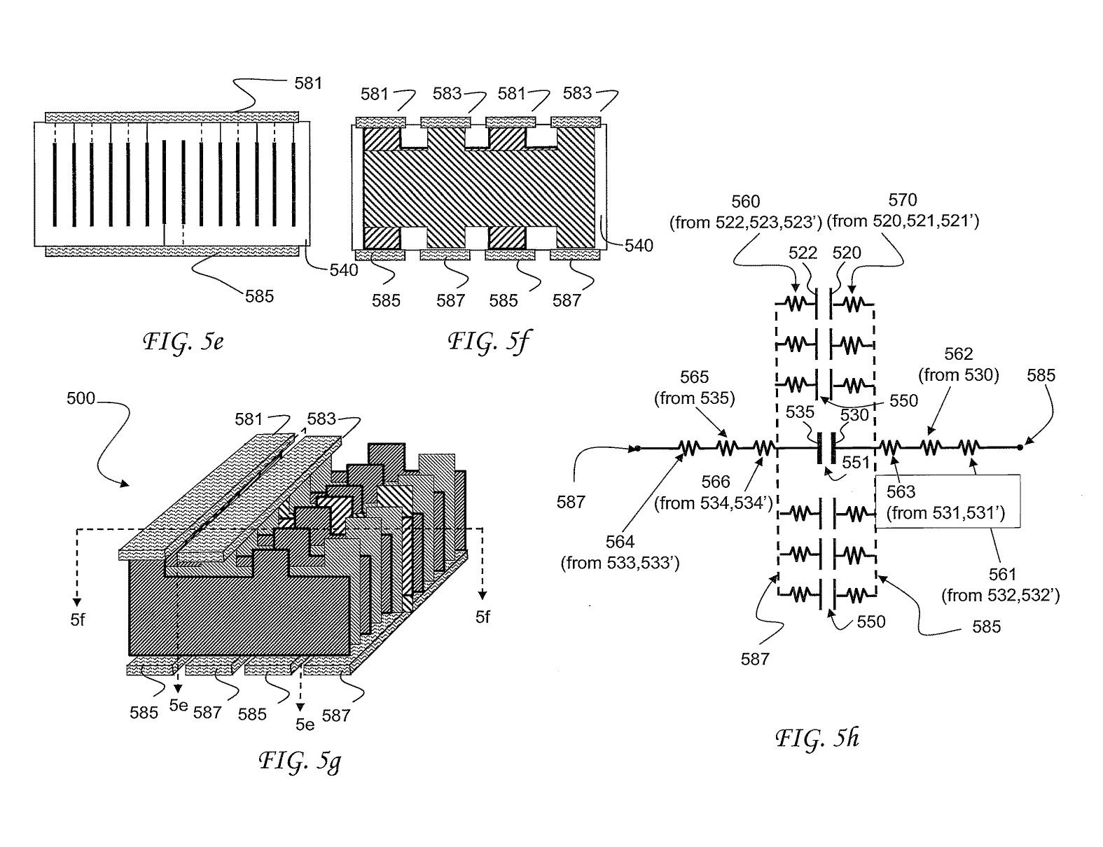

Reference will now made to a third exemplary embodiment of the present technology, in which the electrodes are oriented in a different direction such that they are substantially perpendicular to a mounting surface when attached thereto, thus yielding so-called “vertical electrodes.” Various aspects of such third exemplary embodiment are illustrated in and described with reference to FIGS. 5a-5h.

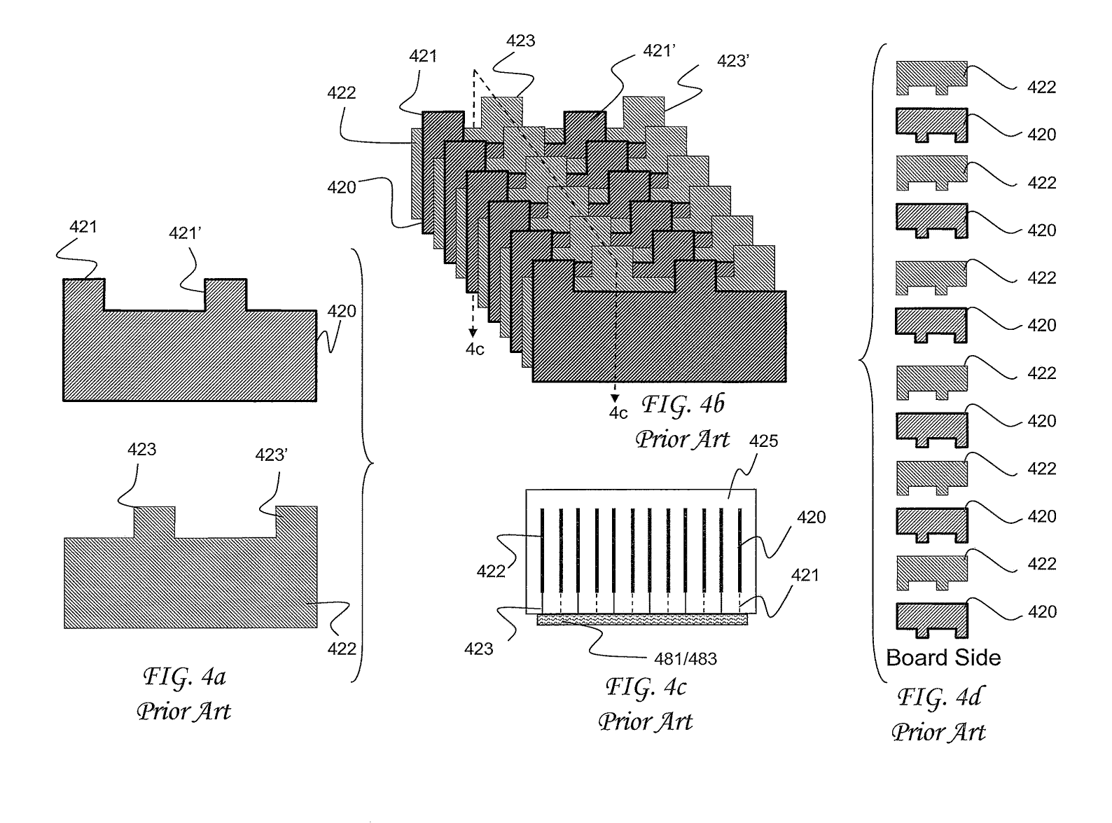

Before discussing such figures, FIGS. 4a-4d are directed to known aspects of a vertical electrode configuration, aspects of which are generally described in U.S. Pat. No. 4,831,494 (Arnold et al.). In accordance with such prior art configuration, sets of first and second electrodes 420 and 422 are provided to form multiple parallel plate capacitors. Respective plan views of such first and second electrodes 420 and 422 are illustrated in FIG. 4a. As shown, a first electrode 420 includes a substantially rectangular main portion with first and second tabs 421 and 421′ extending from a longer side edge of the electrode. Second electrode 422 includes a substantially rectangular main portion with first and second tabs 423 and 423′ extending from the same longer side edge of the electrode as tabs 421 and 421′. Tabs 423 and 423′ of second electrode 422 are offset from tabs 421 and 421′ of first electrode 421 such that when pairs of such electrodes are alternately interleaved with dielectric layers in a stacked configuration, such tabs align in different respective columns, as shown in FIGS. 4b and 4d.

FIG. 4b shows a generally side and top perspective view of a stacked configuration of alternating first and second electrodes 420 and 422, provided in multiple pairs. FIG. 4d shows an exploded view of the same electrodes, provided in a direction of lamination from bottom to top of the figure. Only six pairs of electrodes are illustrated in FIGS. 4b and 4d, although it should be appreciated that many more electrodes are often employed to achieve relative higher device capacitance levels.

FIG. 4c shows a cross-sectional view of the device in FIG. 4b taken along section line 4c-4c, but turned upside-down. The portions of first and second electrodes 420 and 422 that overlap to form parallel-plate capacitances are respectively illustrated with lines having a thicker weight. Electrode tabs 421 (attached to first electrodes 420), corresponding to a first polarity, are depicted with dashed lines, while electrode tabs 423 (attached to second electrodes 422) and corresponding to a second opposing polarity are depicted with solid lines. When first and second electrodes are alternately stacked between layers of dielectric material 425, the tabs 421, 421′, 423 and 423′ extend to and are initially exposed along a mounting surface. The exposed portions of such tabs are directly connected to external terminals 481, 483 of opposite polarity. Those terminals 481 and 483 are then attached directly to a mounting surface, yielding a generally low inductance capacitor.

Referring now to FIGS. 5a through 5h, a third exemplary embodiment 500 of the present technology provides not only low inductance features, but also a way to add controlled ESR into a unitary MLC device. More particularly, and similar to the embodiments 200 and 300 described before, such exemplary device 500 utilizes not only two different electrode configurations, but four two mother electrode and two daughter electrode configurations. First and second electrodes 520 and 522 are similar in many respects to the electrodes 420 and 422 of FIGS. 4a-4c.

Referring more particularly to FIG. 5a, first electrode 520 includes a substantially rectangular main portion and two tabs 521, 521′ that extend from a longer side of the electrode 520. Second electrode 522 includes a substantially rectangular main portion and two tabs 523, 523′ that extend from the same longer side of the electrode 522 (as do tabs 521, 521′ extend from electrode 520). First electrode 520 and second electrode 522 are used as daughter electrodes, and so tabs 521, 521′, 523 and 523′ will be internal-connection tabs. Third and fourth electrodes 530 and 535 are also employed, but as mother electrodes. Third electrode 530 includes internal-connection tabs 531 and 531′ that extend from the first side of a main rectangular portion in generally the same alignment as internal-connection tabs 521 and 521′ of first electrode 520. Additional tabs 532 and 532′ extend from a second side of the main electrode portion in a location generally opposite that of tabs 531 and 531′, and are used as circuit-connection tabs. Fourth electrode 535 includes internal-connection tabs 533 and 533′ that extend from the first side of a main rectangular portion in generally the same alignment as internal-connection tabs 523 and 523′ of second electrode 523. Additional tabs 534 and 534′ extend from a second side of the main electrode portion in a location generally opposite that of tabs 533 and 533′, and are used as circuit-connection tabs.

FIGS. 5b-5d, respectively, show how select pairs of first and second (daughter) electrodes 520, 522 and third and fourth (mother) electrodes 530, 535 can be combined to form a low inductance, controlled ESR multilayer capacitor. For example, FIG. 5b provides a top, side perspective view of a single pair of third and fourth (mother) electrodes 530 and 535, with three pairs of first and second (daughter) electrodes 520, 522 provided on either side thereof. FIG. 5c provides a generally bottom, side perspective view of the same arrangement of electrodes. From FIG. 5b, it is apparent that when first, second, third and fourth electrodes are stacked as shown, internal-connection tabs 521 and 531 align in a first given column of tabs, internal-connection tabs 523 and 533 align in a second column of tabs, internal-connection tabs 521′ and 531′ align in a third column of tabs, and internal-connection tabs 523′ and 533′ align in a fourth column of tabs. From FIG. 5c, it is apparent that the only tabs presented on the bottom side (what will ultimately become the mounting side) are circuit-connection tabs 532 and 532′ associated with mother electrode 530 of a first polarity and circuit-connection tabs 534 and 534′ associated with mother electrode 535 of a second polarity. FIG. 5d provides a cross-sectional view of a capacitor incorporating the electrode stack of FIG. 5b, as taken along section line 5d-5d thereof. FIG. 5d depicts an outline of the dielectric body 540 formed when dielectric layers are stacked among the various electrode layers.

When the stacked arrangement of alternating electrodes and dielectric layers discussed above is formed in a given direction of lamination, such device would be formed by first arranging three pairs of first and second (daughter) electrodes 520, 522, followed by one pair of third and fourth (mother) electrodes 530, 535, followed by an additional three pairs of first and second (daughter) electrodes 520, 522. Again, it should be appreciated that many more pairs of first and second (daughter) electrodes 520 and 522 would normally be provided, depending on the desired level of capacitance in the finished device. In addition, it should be appreciated that the location of the single pair of third and fourth (mother) electrodes 530, 535 does not necessarily have to be in the middle of the laminated stack. In other examples, such single pair (or other grouping of first and second electrodes) can be provided on a given end of the stack or at some other intermediate location, while still achieving similar benefits of controlled ESR and low inductance. In addition, it should be appreciated in this and other embodiments that it may be possible to utilize anywhere from one (1) to five (5) mother electrodes, not just a single pair of two (2) electrodes.

Additional aspects of the third exemplary capacitor embodiment 500 can be appreciated from FIGS. 5e through 5g, respectively, which provide various illustrations of such third embodiment 500 after the application of peripheral terminations.

FIG. 5e shows the same cross-sectional view of FIG. 5d, with a view of selected terminations 581 and 585. FIG. 5f shows a cross-sectional view of the same device, rotated ninety degrees in the planar direction relative to the view of FIG. 5e. FIG. 5g shows a generally top and side perspective view, such as provided in FIG. 5b, with the addition of terminations (two of which are left off for ease of illustration). With reference to FIG. 5g, FIG. 5e is a cross-sectional view taken along section line 5e-5e in FIG. 5g, and FIG. 5f is a cross-sectional view taken along section line 5f-5f.

As apparent from FIGS. 5f and 5g, two first polarity terminations 581 and two second polarity terminations 583 are provided on a first surface of the capacitor, and are ultimately used to provide internal connection among mother and daughter electrodes. First polarity internal-connection terminations 581 are directly connected to the internal-connection tabs 521 and 521′ of each daughter electrode 520 as well as internal-connection tabs 531 and 531′ of mother electrode 530. Second polarity internal-connection terminations 583 are directly connected to the internal-connection tabs 523 and 523′ of each daughter electrode 522 as well as to internal-connection tabs 533 and 533′ of each mother electrode 535.

On an opposite surface, two first polarity circuit-connection terminations 585 and two second polarity circuit-connection terminations 587 are provided. The additional first polarity terminations 585 are respectively connected to one each of circuit-connection tabs 532 and 532′ of mother electrode 530, while the additional second polarity terminations 587 are respectively connected to one each of circuit-connection tabs 534 and 534′ of mother electrode 535. The surface on which circuit-connection terminations 585 and 587 are provided is preferably configured for mounting, such that direct connection is only made to the single pair of third and fourth (mother) electrodes 530 and 535. This pair is then connected in parallel to the other pairs of first and second (daughter) electrodes 520 and 522 via the internal-connection terminations 581 and 583 provided on the surface opposite the mounting surface.

Referring now to FIG. 5h, an equivalent circuit schematic representation of the physical configuration of device 500 of FIG. 5g is presented. Such schematic depicts the mother electrodes 530 and 535 in the middle forming a first parallel-plate capacitance 551. Each pair of daughter electrodes 520, 522 forms a parallel-plate capacitance 550 provided in parallel with other capacitors 550 and the mother electrode capacitance 551. The parallel connections are made by internal-connection terminals 585 and 587, represented schematically with dashed lines in FIG. 5h. Respective resistances are associated with each pair of daughter electrodes 520 and 522, namely a first resistance 560 formed by each electrode plate 522 (and including internal-connection tabs 523, 523′) and a second resistance 570 formed by each electrode plate 520 (and including internal-connection tabs 521, 521′). Each capacitance 550 is electrically represented in series with the first daughter electrode resistance 560 and second daughter electrode resistance 570. Looking into the circuit schematic from circuit-connection terminal 585, three resistances attributable to first mother electrode 530 are provided—namely, a resistance 561 from external-connection tabs 532 and 532′, a resistance 562 from the main portion of mother electrode 530, and a resistance 563 from the internal-connection tabs 531 and 531′. From circuit-connection terminal 587, current flow will pass through three resistances attributable to mother electrode 535—namely, a resistance 564 from external-connection tabs 533 and 533′, a resistance 565 from the main portion of mother electrode 535, and a third resistance 566 from the internal-connection tabs 534 and 534′. Again, by ensuring that the resistances 561-566, respectively, are not provided in parallel with the total resistance value formed from daughter electrodes 520, 522, but in series, increased ESR is available.

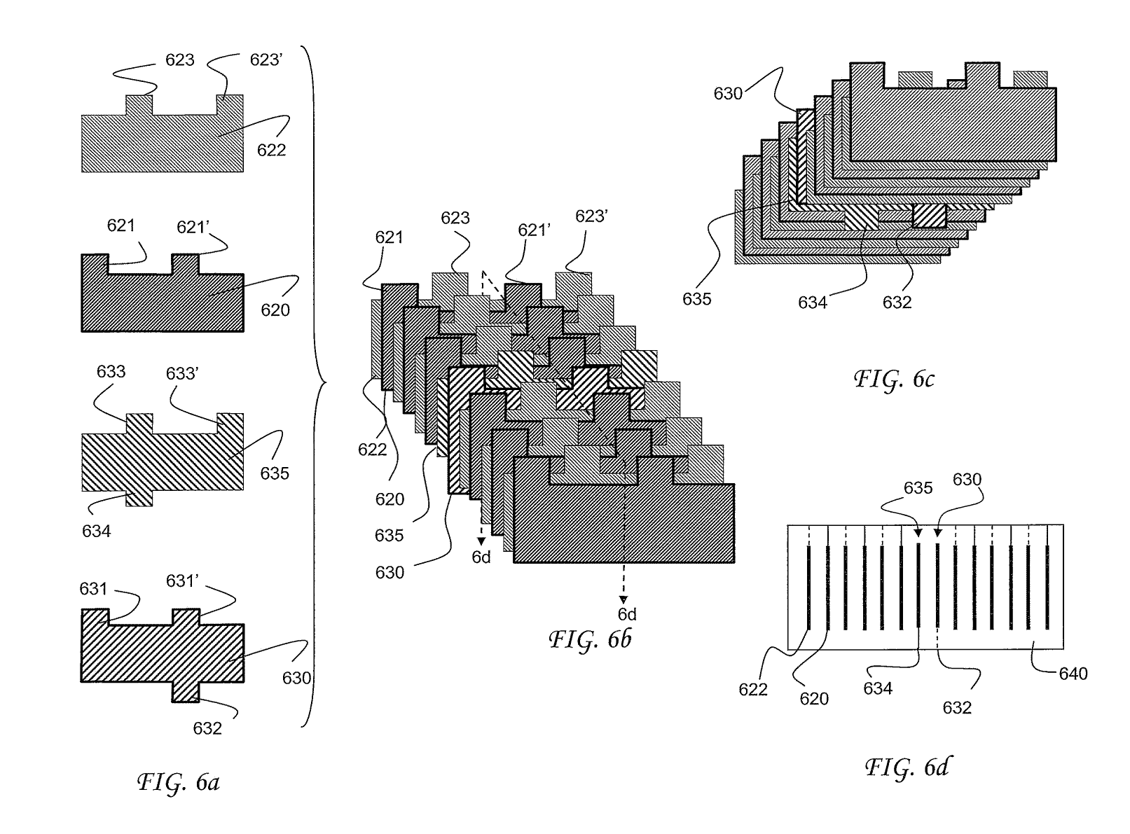

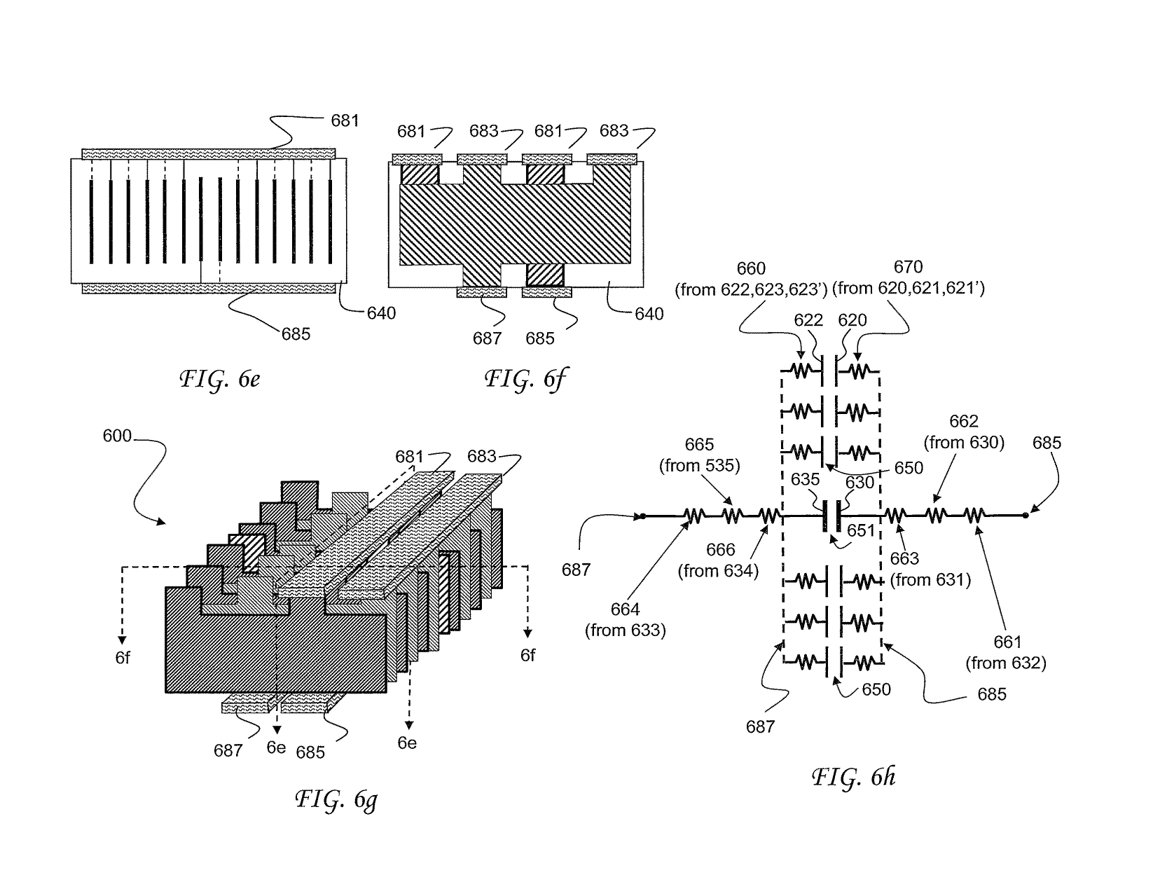

Yet another exemplary embodiment of the disclosed capacitor technology is provided in FIGS. 6a-6h, respectively. Such embodiment is similar in some respects to the embodiment illustrated in FIGS. 5a-5h, except that only two terminations (one first polarity, one second polarity) are provided on the mounting surface of the capacitor.

Referring more particularly to FIG. 6a, first electrode 620 includes a substantially rectangular main portion and two tabs 621, 621′ that extend from a longer side of the electrode 620. Second electrode 622 includes a substantially rectangular main portion and two tabs 623, 623′ that extend from the same longer side of the electrode 622 (as do tabs 621, 621′ extend from electrode 620). The first and second electrodes 620 and 622 are utilized as daughter electrodes, while third and fourth electrodes 630 and 635 are provided for use as mother electrodes. Third electrode 630 includes tabs 631 and 631′ that extend from the first side of a main rectangular portion in generally the same alignment as tabs 621 and 621′ of first electrode 620. An additional tab 632 extends from a second side of the main electrode portion in a location generally opposite that of tab 631′. Fourth electrode 635 includes tabs 633 and 633′ that extend from the first side of a main rectangular portion in generally the same alignment as tabs 623 and 623′ of second electrode 622. An additional tab 634 extends from a second side of the main electrode portion in a location generally opposite that of tab 633.

FIGS. 6b-6d, respectively, show how select pairs of first and second electrodes 620, 622 and third and fourth electrodes 630, 635 can be combined to form a low inductance, controlled ESR multilayer capacitor. For example, FIG. 6b provides a top, side perspective view of a single pair of third and fourth electrodes 630 and 635, with three pairs of first and second electrodes 620, 622 provided on either side thereof. FIG. 6c provides a generally bottom, side perspective view of the same arrangement of electrodes. From FIG. 6b, it is apparent that when first, second, third and fourth electrodes are stacked as shown, tabs 621 and 631 align in a first given column of tabs, tabs 623 and 633 align in a second column of tabs, tabs 621′ and 631′ align in a third column of tabs, and tabs 623′ and 633′ align in a fourth column of tabs. From FIG. 6c, it is apparent that the only tabs presented on the bottom side (what will ultimately become the mounting side) are tab 632 associated with electrode 630 of a first polarity and tab 634 associated with electrode 635 of a second polarity. FIG. 6d provides a cross-sectional view of a capacitor incorporating the electrode stack of FIG. 6b, as taken along section line 6d-6d thereof. FIG. 6d depicts an outline of the dielectric body 640 formed when dielectric layers are stacked among the various electrode layers.

When the stacked arrangement of alternating electrodes and dielectric layers discussed above is formed in a given direction of lamination, such device would be formed by first arranging three pairs of first and second electrodes 620, 622, followed by one pair of third and fourth electrodes 630, 635, followed by an additional three pairs of first and second electrodes 620, 622. Again, it should be appreciated that many more pairs of first and second electrodes 620 and 622 would normally be provided, depending on the desired level of capacitance in the finished device. In addition, it should be appreciated that the location of the single pair of first and second electrodes 620, 622 does not necessarily have to be in the middle of the laminated stack. In other examples, such single pair (or other grouping of first and second electrodes) can be provided on a given end of the stack or at some other intermediate location, while still achieving similar benefits of controlled ESR and low inductance.

Additional aspects of the fourth exemplary capacitor embodiment 600 can be appreciated from FIGS. 6d through 6f, respectively, which provide various illustrations of such fourth embodiment 600 after the application of peripheral terminations.

FIG. 6e shows the same cross-sectional view of FIG. 6d, with a view of selected terminations 681 and 685. FIG. 6f shows a cross-sectional view of the same device, rotated ninety degrees in the planar direction relative to the view of FIG. 6e. FIG. 6g shows a generally top and side perspective view, such as provided in FIG. 6b, with the addition of terminations (two of which are left off for ease of illustration). With reference to FIG. 6g, FIG. 6e is a cross-sectional view taken along section line 6e-6e in FIG. 6g, and FIG. 6f is a cross-sectional view taken along section line 6f-6f.

As apparent from FIGS. 6f and 6g, two first polarity terminations 681 and two second polarity terminations 683 are provided on a first surface of the capacitor. First polarity terminations 681 are directly connected to the tabs 621 and 621′ of each electrode 620 as well as tabs 631 and 631′ of electrode 630. Second polarity terminations 683 are directly connected to the tabs 623 and 623′ of each electrode 622 as well as to tabs 633 and 633′ of each electrode 635.

On an opposite surface, one additional first polarity termination 685 and one additional second polarity termination 687 are provided. The additional first polarity terminations 685 is connected to tab 632 of electrode 630, while the additional second polarity termination 687 is connected to tab 634 of electrode 635. The surface on which terminations 685 and 687 are provided is preferably configured for mounting, such that direct connection is only made to the single pair of third and fourth electrodes 630 and 635. This pair is then connected in parallel to the other pairs of first and second electrodes 620 and 622 via the terminations 681 and 683 provided on the surface opposite the mounting surface. As illustrated, termination stripes 685 and 687 corresponding to the exposed location of single tabs 632 and 634 are generally towards the middle of the mounting surface, although the location of such tabs and terminations may be towards outer edges of the mounting surface or at any other desired location thereon.

Referring now to FIG. 6h, an equivalent circuit schematic representation of device 600 of FIG. 6g is presented. Such schematic depicts the mother electrodes 630 and 635 in the middle forming a first parallel-plate capacitance 651. Each pair of daughter electrodes 620, 622 forms a parallel-plate capacitance 650 provided in parallel with other capacitors 650 and the mother electrode capacitance 651. The parallel connections are made by internal-connection terminals 685 and 687, represented schematically with dashed lines in FIG. 6h. Respective resistances are associated with each pair of daughter electrodes 620 and 622, namely a first resistance 660 formed by each electrode plate 622 (and including internal-connection tabs 623, 623′) and a second resistance 670 formed by each electrode plate 620 (and including internal-connection tabs 621, 621′). Each capacitance 650 is electrically represented in series with the first daughter electrode resistance 660 and second daughter electrode resistance 670. Looking into the circuit schematic from circuit-connection terminal 685, three resistances attributable to first mother electrode 630 are provided—namely, a resistance 661 from external-connection tab 632, a resistance 662 from the main portion of mother electrode 630, and a resistance 663 from the internal-connection tabs 631 and 631′. From circuit-connection terminal 687, current flow will pass through three resistances attributable to mother electrode 635 namely, a resistance 664 from external-connection tab 634, a resistance 665 from the main portion of mother electrode 635, and a third resistance 666 from the internal-connection tabs 633 and 633′. Again, by ensuring that the resistances 661-666, respectively are not provided in parallel with the total resistance value formed from daughter electrodes 620, 622, but in series, increased ESR is available.

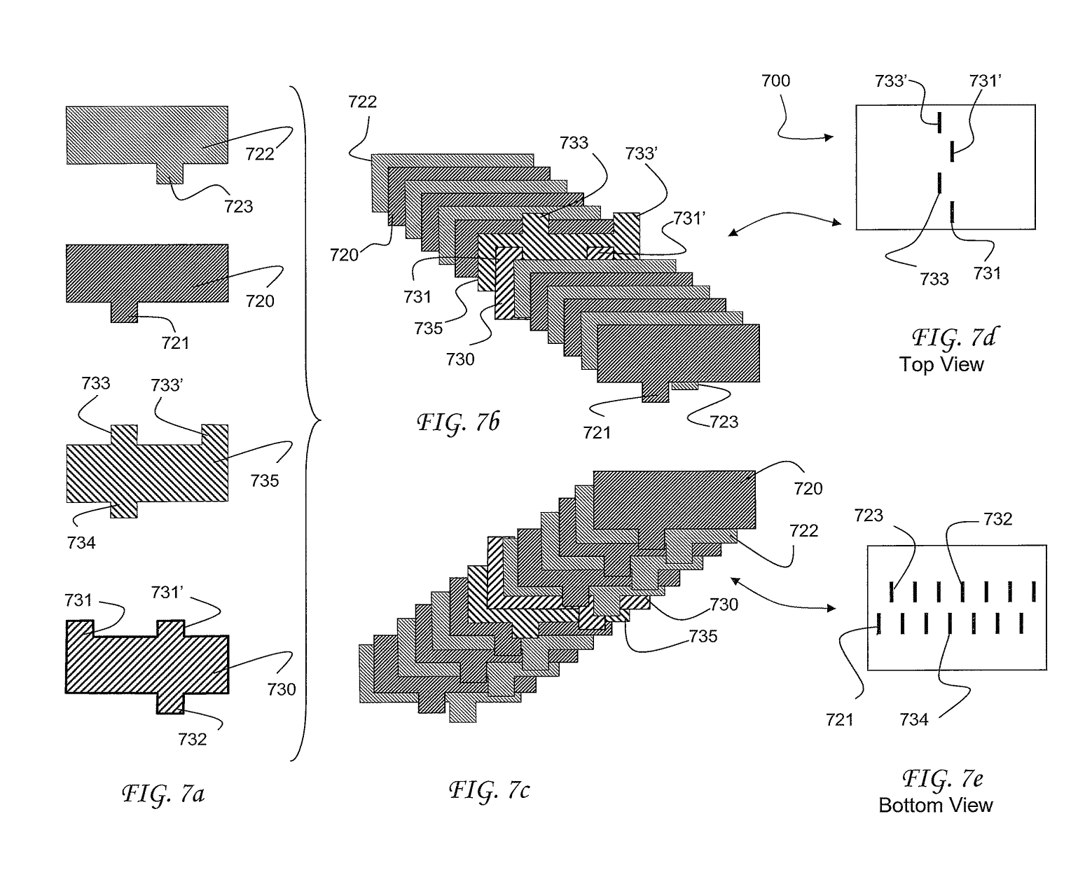

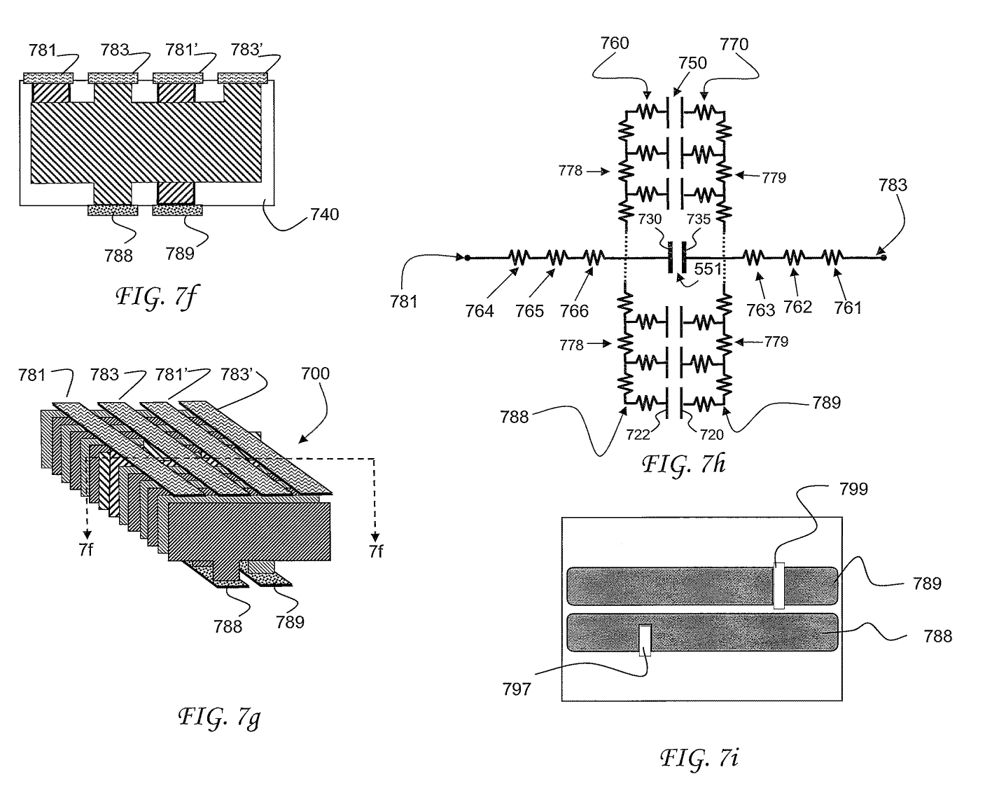

A still further exemplary embodiment of the disclosed capacitor technology having vertical electrodes is provided in FIGS. 7a-7i, respectively. Referring more particularly to FIG. 7a, first daughter electrode 720 includes a substantially rectangular main portion and one internal-connection tab 721 that extends from a longer side of the electrode 720. Second daughter electrode 722 includes a substantially rectangular main portion and an internal-connection tab 723 that extends from the same longer side of the electrode 722 as does tab 721 extend from electrode 720. Third and fourth electrodes 730 and 735 are also employed, although as mother electrodes. Third electrode 730 is a mother electrode including an internal-connection tab 732 that extends from the first side of a main rectangular portion in generally the same alignment as tab 723 of daughter electrode 722. Additional tabs 731 and 731′ are circuit-connection tabs that extend from a second side of the main electrode portion, with tab 731′ in a location generally opposite that of tab 732, and tab 731 extending from a far side of the main electrode portion. Fourth electrode 735 is a mother electrode including internal-connection tab 734 that extends from the first side of a main rectangular portion in generally the same alignment as tab 721 of daughter electrode 720. Additional tabs 733, 733′ are circuit-connection tabs that extend from a second side of the main electrode portion, with circuit-connection tab 733 provided in a location generally opposite that of internal-connection tab 734, and circuit-connection tab 733′ extending from a far side of the main electrode portion.

FIGS. 7b-7d, respectively, show how select pairs of first and second (daughter) electrodes 720, 722 and third and fourth (mother) electrodes 730, 735 can be combined to form a low inductance, controlled ESR multilayer capacitor. For example, FIG. 7b provides a top, side perspective view of a single pair of mother electrodes 730 and 735, with three pairs of daughter electrodes 720, 722 provided on either side thereof. FIG. 7c provides a generally bottom, side perspective view of the same arrangement of electrodes. From FIG. 7b, it is apparent that when first, second, third and fourth electrodes are stacked as shown, tabs 731, 733, 731′ and 733 alternately extend from mother electrodes 730 and 735 in four different spaced, yet adjacent, locations on what will ultimately become the mounting side of the MLC device. See also, the top plan view provided in FIG. 7d. From FIG. 7c, it is apparent that the only tabs presented on the opposing non-mounting side are internal-connection tabs 732 and 723, aligned in a first column as shown in the bottom plan view of FIG. 7e, and internal-connection tabs 721 and 734 aligned in a second column.

When the stacked arrangement of alternating electrodes and dielectric layers discussed above is formed in a given direction of lamination, such device would be formed by first arranging three pairs of daughter electrodes 720, 722, followed by one pair of mother electrodes 730, 735, followed by an additional three pairs of daughter electrodes 720, 722. Again, it should be appreciated that many more pairs of first and second electrodes 720 and 722 would normally be provided, depending on the desired level of capacitance in the finished device. In addition, it should be appreciated that the location of the single pair of mother electrodes 730, 735 does not necessarily have to be in the middle of the laminated stack. In other examples, such single pair (or other grouping of one or more mother electrodes) can be provided on a given end of the stack or at some other intermediate location, while still achieving similar benefits of controlled ESR and low inductance.

Additional aspects of the fifth exemplary capacitor embodiment 700 can be appreciated from FIGS. 7f through 7i, respectively, which provide various illustrations of such fifth embodiment 700 after the application of peripheral terminations.

FIG. 7g shows a generally top and side perspective view of capacitor embodiment 700, similar to that depicted in FIG. 7b, illustrated without dielectric material but with the addition of peripheral terminations. FIG. 7f shows a cross-sectional view of the same device 700 taken along section line 7f-7f in FIG. 7g and including an outline of dielectric body 740.

As apparent from FIGS. 7f and 7g, two internal-connection terminations 788, 789 are provided on a non-mounting surface of the device. A first polarity internal-connection termination 788 is directly connected to the internal-connection tabs 721 of each daughter electrode 720 and internal-connection tab 734 on each mother electrode 735. A second polarity internal-connection termination 789 is directly connected to the internal-connection tabs 723 of each daughter electrode 722 and internal-connection tab 732 on each mother electrode 730. On an opposite surface configured for mounting the device 700, four circuit-connection terminals 781, 783, 781′ and 783′ are provided in four substantially parallel strips. Circuit-connection terminal 781 is connected to circuit-connection tab 731 of mother electrode 730. Circuit-connection terminal 783 is connected to circuit-connection tab 733 of mother electrode 735. Circuit-connection terminal 781′ is connected to circuit-connection tab 731′ of mother electrode 732. Circuit-connection terminal 783′ is connected to circuit-connection tab 733′ of mother electrode 735. It should be appreciated that since the circuit-connection terminals only provide a direct connection to the mother electrodes, the length of such terminals need not necessarily extend for the entire length of device 700 as shown in FIG. 7g. In other alternative embodiments, circuit-connection terminals may correspond to lands for BGA mounting or other shorter termination stripes, located wherever the mother electrodes are provided in the laminated stack, while still providing sufficient external connection to a circuit or other mounting environment.

In one embodiment of the present subject matter, device 700 is selectively formed with resistive terminations. For example, although prior terminals have been discussed as being generally conductive terminals, resistive versions may alternatively be used in device 700 or in any of the other devices described in this application. Resistive terminals may be formed in a variety of fashions, such as but not limited to electroplating a phosphorous material containing nickel, plating or evaporating chrome and nickel then diffusing them together, photoresisting a thin film material like tantalum-nickel (TaN) or sputtering such a material through a mask, directly plating a thick film resistor material, or any combination of these or other suitable techniques for application of one or more resistive materials or layers of material. In one particular embodiment of the present technology, the internal-connection terminals 788 and 789 of device 700 are formed as respective stripes of resistive material. The extra resistance provided by such resistive terminal elements is apparent from the circuit diagram of FIG. 7h.

Referring now to FIG. 7h, an equivalent circuit schematic representation of device 700 of FIG. 7g is presented, with internal-connection terminals 788, 789 being formed of resistive material. Such schematic depicts the mother electrodes 730 and 735 in the middle forming a first parallel-plate capacitance 751. Each pair of daughter electrodes 720, 722 forms a parallel-plate capacitance 750 provided in parallel with other capacitors 750 and the mother electrode capacitance 751. The parallel connections are made by internal-connection terminals 788 and 789. Since such terminals are made of resistive material, they add additional resistances (respectively formed by the portion of each resistive terminal through which current travels from electrode to adjacent electrode) represented by resistors 778 and 779. Respective resistances are also associated with each pair of daughter electrodes 720 and 722, namely a first resistance 760 formed by each electrode plate 722 (and including internal-connection tab 723) and a second resistance 770 formed by each electrode plate 720 (and including internal-connection tab 721). Each capacitance 750 is electrically represented in series with the first daughter electrode resistance 760 and second daughter electrode resistance 770. Looking into the circuit schematic from circuit-connection terminals 783, 783′, three resistances attributable to mother electrode 735 are provided—namely, a resistance 761 from external-connection tabs 733 and 733′, a resistance 762 from the main portion of mother electrode 735, and a resistance 763 from the internal-connection tab 734. From circuit-connection terminals 781, 781′, current flow will pass through three resistances attributable to mother electrode 730—namely, a resistance 764 from external-connection tabs 731 and 731′, a resistance 765 from the main portion of mother electrode 730, and a third resistance 766 from the internal-connection tab 732. Again, by ensuring that the resistances 761-766, respectively are not provided in parallel with the total resistance value formed from daughter electrodes 720, 722, but in series, increased ESR is available. In addition, the additional series resistance provided by portions of the resistive internal-connection terminals 788 and 789 further increases overall device ESR.

Referring now to FIG. 7i, an additional feature that may be implemented in some embodiments of the present subject matter is illustrated. It may be desirable in some instances to alter the internal-connection terminals 788 and/or 789 in one or two possible ways. In one example, a portion 797 of the resistive material forming terminal 788 is removed. In this manner, the ESR of the device would increase by virtue of making the path more tortuous. It should be appreciated that more than one portion of terminal material as illustrated may be removed, or removal can occur in different terminal locations. In another example, the termination is completely severed, such as depicted by removed portion 799. Complete interruption of terminal 789 can cause some of the daughter electrodes to be disconnected from a circuit, which would lower overall device capacitance, but increase overall resistance. Such exemplary terminal variations may be selectively employed to produce trimming of the capacitance and/or resistance, or abrading or ablating of a terminal stripe, to create more customized aspects of resistance and/or capacitance tuning. It should be appreciated that these customizing steps may be undertaken during manufacture of the MLC, or later such as after mounting in a user's final circuit or in a test fixture at the manufacturer.

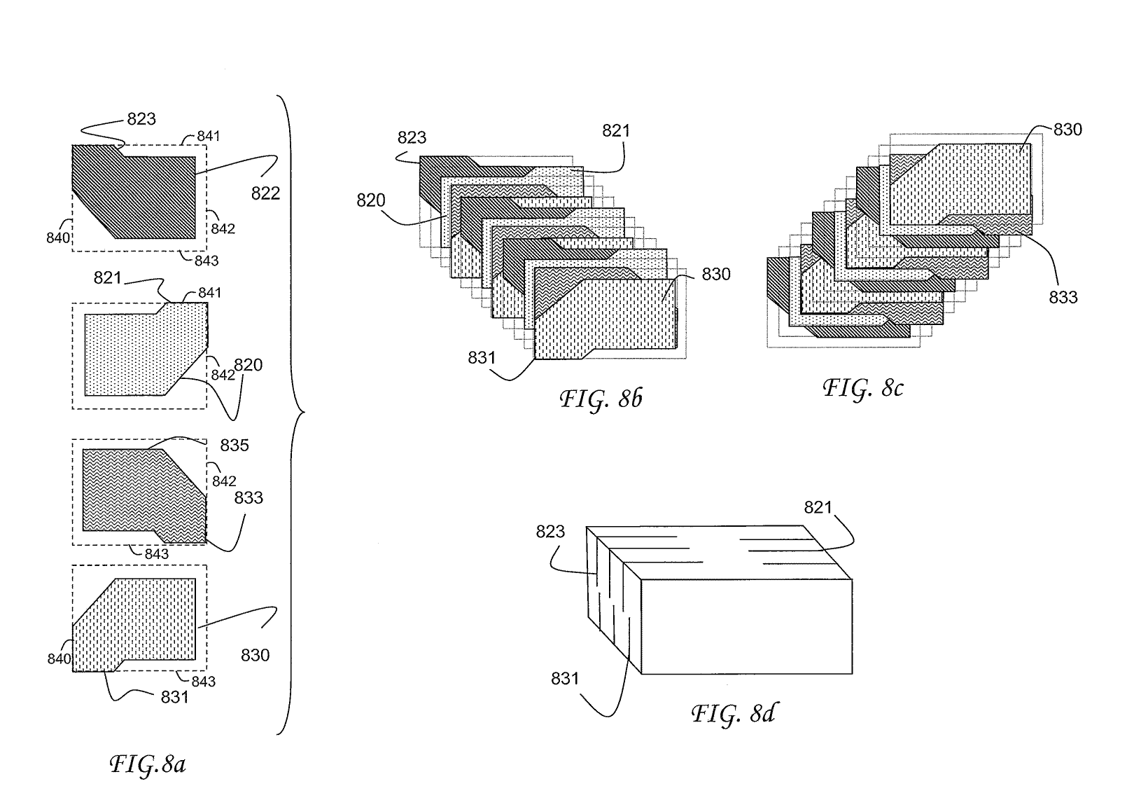

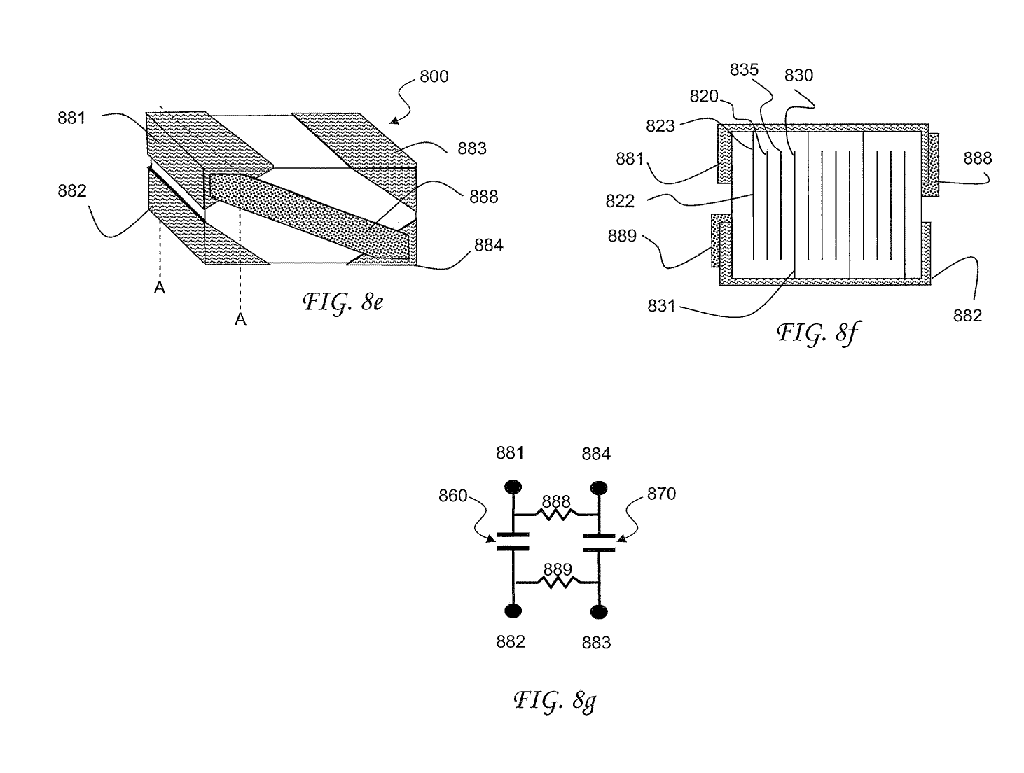

FIGS. 8a-8g, respectively, are directed to aspects of a sixth exemplary MLC embodiment 800. With more particular reference to FIG. 8a, four respective electrode configurations are shown, similar to those disclosed in U.S. Pat. No. 4,814,940 (Horstmann et al.). The rectangular dotted line surrounding each configuration is intended to represent the outline of a ceramic or dielectric layer onto which each electrode pattern is printed or otherwise applied during the manufacturing process. A first electrode pattern 822 consists of a generally rectangular main portion with a corner tab 823 extending therefrom. When provided in a laminated stack of dielectric and electrode layers, corner tab 823 extends to and is initially exposed along two adjacent surfaces of the stack, namely on first and second surfaces 840 and 841, including the portion of the edge of the device where such two surfaces meet. A second electrode pattern 820 consists of a generally rectangular main portion with a corner tab 821 extending therefrom. When provided in a laminated stack of dielectric and electrode layers, corner tab 821 extends to and is initially exposed along two adjacent surfaces of the stack, namely on second and third surfaces 841 and 842, including the portion of the edge of the device where such two surfaces meet. A third electrode pattern 835 consists of a generally rectangular main portion with a corner tab 833 extending therefrom. When provided in a laminated stack of dielectric and electrode layers, corner tab 833 extends to and is initially exposed along two adjacent surfaces of the stack, namely on third and fourth surfaces 842 and 843, including the portion of the edge of the device where such two surfaces meet. A fourth electrode pattern 830 consists of a generally rectangular main portion with a corner tab 831 extending therefrom. When provided in a laminated stack of dielectric and electrode layers, corner tab 831 extends to and is initially exposed along two adjacent surfaces of the stack, namely on first and fourth surfaces 840 and 843, including the portion of the edge of the device where such two surfaces meet.

FIG. 8b shows an exploded view of a partial laminated stack of the plurality of respective electrode configurations illustrated in FIG. 8a from a top perspective. FIG. 8c shows an exploded view of the same partial laminated stack, but from the opposite side, a generally bottom perspective. When all such layers are stacked together to form a laminated assembly, the resulting MLC with exposed electrode edges (before termination) is shown in FIG. 8d. When successive electrode and dielectric layers are provided in such fashion as shown, alternating the first, second, third and fourth electrode layers 822, 820, 835 and 830, the respective corner tabs extending from the electrode layers form a clockwise series of contacts around the four edges. It is apparent from these and subsequent figures that the alignment of the corner tabs is such that there is no overlap of exposure from one corner tab to the next. This will facilitate the formation of four separate and distinct terminations for the MLC device, as shown in FIGS. 8e and 8f. Only three sets of the four different electrode configurations 822, 820, 835 and 830 are shown in FIGS. 8b-8d, respectively, although it should be appreciated that this is merely for ease of illustration. In reality, many more iterations of the different electrode patterns may be utilized.

Additional aspects of the sixth exemplary embodiment of the present subject matter can be realized from the views provided in FIGS. 8e-8g, respectively. FIG. 8e provides a generally top, side perspective view of a laminated assembly of dielectric layers and electrode sheets, similar to that depicted in FIG. 8d, now illustrating the addition of external terminations as well as a resistive connector(s). Using similar techniques as already described for applying peripheral terminations, four corner terminations 881, 882, 883 and 884 may be applied at each corner of the MLC device where the respective columns of corner tabs 823, 821, 833 and 831 are initially exposed. Such corner tabs, may thus provide an electrical connection to each electrode sheet as well as a mechanical nucleation for the applied terminations. Although not illustrated in FIGS. 8a-8f, additional corner anchor tabs may be employed in some embodiments to provide additional nucleation points for applied terminations.

In addition to the four terminations 881, 882, 883, 884, a portion of resistive material 888 is provided as a stripe connecting terminations 881 and 884. On the opposite side of the device a similar portion of resistive material 889 extends between and electrically connects terminations 882 and 883. Although only resistive stripe 888 is visible in FIG. 8e, respective portions of both stripes 888 and 889 can be seen in the cross-sectional view of FIG. 8f, taken along line A-A in FIG. 8e. The alternating four patterns of electrodes generally combine to form a low inductance structure, and the addition of resistive strips 888 and 889 provide controlled ESR, where the amount of resistive contribution can be altered by the choice of the resistor value. Such contribution may be altered, for example, by choices of resistive material, thickness or width of the resistive stripes, etc.

Referring now to FIG. 8g, an equivalent circuit schematic representation of device 800 of FIGS. 8e and 8f is presented. It should be appreciated that the actual circuit may be modeled by additional circuit elements other than those shown in FIG. 8g, although certain relevant aspects thereof are highlighted for present purposes of describing the capacitive functionality of device 800 with additional ESR. A first capacitor 860 is formed between adjacent pairs of the connected sets of first electrodes 822 (attached to terminal 881) and fourth electrodes 830 (attached to terminal 882). A second capacitor 870 is formed between the adjacent pairs of the connected sets of second electrodes 820 (attached to terminal 883) and third electrodes 835 (attached to terminal 884). Resistive strips 888 and 889 form the resistors in FIG. 8g, linking selected respective terminals together. From such circuit schematic, it is apparent that when a circuit is connected to two terminals on one device surface, for example terminals 882 and 884, half of the electrodes are seen through a resistance, thus providing increased ESR for the circuit. In some embodiments, the ratio of direct electrodes to high resistance electrodes can be varied for increased flexibility in circuit customization.

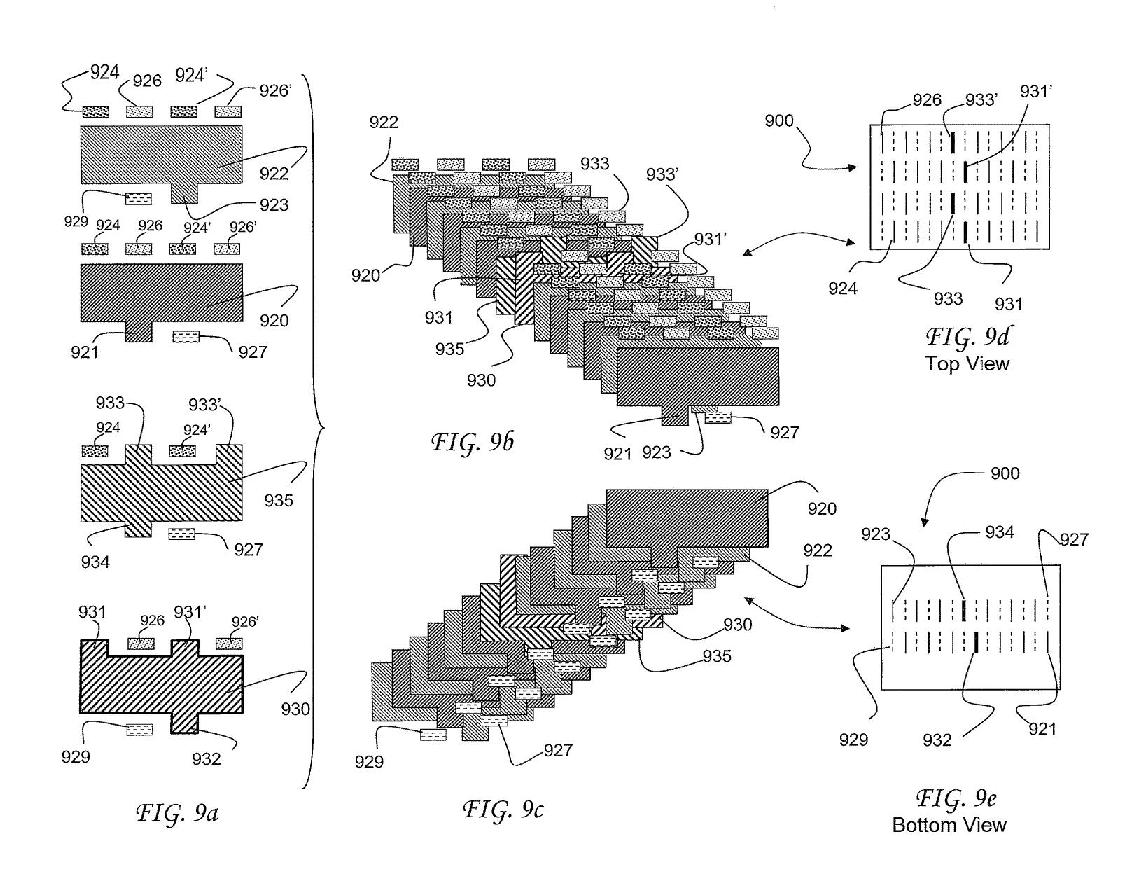

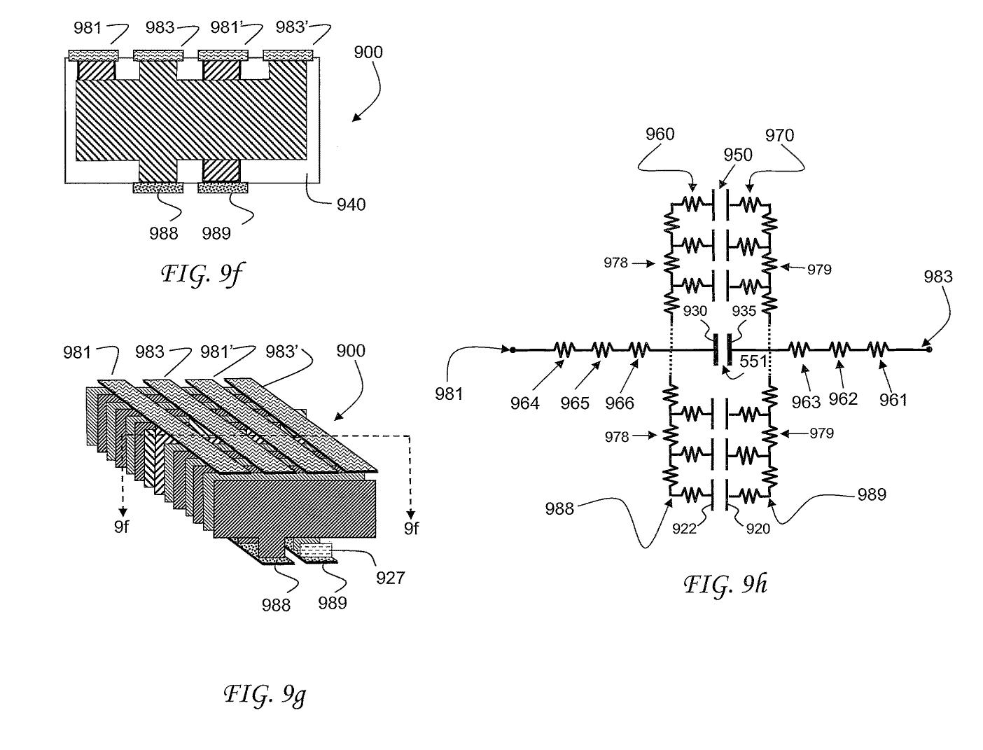

A still further exemplary embodiment of the disclosed capacitor technology having vertical electrodes is provided in FIGS. 9a-9g, respectively. The exemplary device 900 described with reference to such figures is similar to that of FIGS. 7a-7g, with the addition of additional anchor/dummy tabs to provide additional nucleation and guide points for the application of peripheral terminations, including conductive terminations and/or connective resistive stripes. Such anchor/dummy tabs are especially useful when terminations are selectively deposited using thin-film plating techniques as previously described, since the thin-film plating is adapted to bridge laterally among adjacent exposed edges of the internal conductive elements (i.e., internal electrodes, electrode tabs and the additional anchor/dummy tabs in device 900.)

Referring more particularly to FIG. 9a, first daughter electrode 920 includes a substantially rectangular main portion and one internal-connection tab 921 that extends from a longer side of the electrode 920. Anchor/dummy tabs 924, 926, 924′ and 926′ are not directly connected to electrode 920, but are provided in a spaced arrangement along the longer side opposite that from which internal-connection tab 921 extends. Such anchor/dummy tabs, although not providing direct electrical connection to an electrode, will still be directly connected to one of the circuit-connection terminals and so may be referred to as additional circuit-connection tabs. An anchor/dummy tab 927 is also provided at a spaced distance from the same longer side of electrode 920 that internal-connection electrode tab 921 extends from. This anchor tab 927, although not providing direct electrical connection to an electrode, will still be directly connected to one of the internal-connection terminals and so may be referred to as additional internal-connection tab. Second daughter electrode 922 includes a substantially rectangular main portion and an internal-connection tab 923 that extends from the same longer side of the electrode 922 as does tab 921 extend from electrode 920. Electrode configuration 922 is also flanked on a longer side by anchor/dummy tabs 924, 926, 924′ and 926′, identical to those provided adjacent to electrode 920. An anchor/dummy tab 929 is also provided at a spaced distance from the same longer side of electrode 922 that internal-connection tab 923 extends from.

Third and fourth electrodes 930 and 935 are also employed, although as mother electrodes. Third electrode 930 is a mother electrode including an internal-connection tab 932 that extends from the first side of a main rectangular portion in generally the same alignment as tab 923 of daughter electrode 922. Additional tabs 931 and 931′ are circuit-connection tabs that extend from a second side of the main electrode portion, with tab 931′ in a location generally opposite that of tab 932, and tab 931 extending from a far side of the main electrode portion. Anchor/dummy tab 929, similar to that described with reference to daughter electrode 922, is also provided in a spaced relationship adjacent to the main portion of electrode 930. Fourth electrode 935 is a mother electrode including internal-connection tab 934 that extends from the first side of a main rectangular portion in generally the same alignment as tab 921 of daughter electrode 920. Additional tabs 933, 933′ are circuit-connection tabs that extend from a second side of the main electrode portion, with circuit-connection tab 933 provided in a location generally opposite that of internal-connection tab 934, and circuit-connection tab 933′ extending from a far side of the main electrode portion. Anchor/dummy tab 927, similar to that described with reference to daughter electrode 920, is also provided in a spaced relationship adjacent to the main portion of electrode 935.

FIGS. 9b-9d, respectively, show how select pairs of first and second (daughter) electrodes 920, 922 and third and fourth (mother) electrodes 930, 935, including all surrounding anchor/dummy tabs can be combined to form a low inductance, controlled ESR multilayer capacitor. For example, FIG. 9b provides a top, side perspective view of a single pair of mother electrodes 930 and 935, with three pairs of daughter electrodes 920, 922 provided on either side thereof. FIG. 9c provides a generally bottom, side perspective view of the same arrangement of electrodes. From FIG. 9b, it is apparent that when first, second, third and fourth electrodes are stacked as shown, four different spaced, yet adjacent columns of electrode tabs and anchor tabs are formed. A first column of tabs corresponds to circuit-connection anchor tabs 924 and circuit-connection electrode tab(s) 931. A second column of tabs corresponds to circuit-connection anchor tabs 926 and circuit-connection electrode tab(s) 933. A third column of tabs corresponds to circuit-connection anchor tabs 924′ and circuit-connection electrode tab(s) 931′. A fourth column of tabs corresponds to circuit-connection anchor tabs 926′ and circuit-connection electrode tab(s) 933′. Edges of the circuit-connection tabs in each of the four columns will be configured to extend to and ultimately be exposed along on what will become the mounting side of the MLC device after terminations are applied. See also, the top plan view provided in FIG. 9d.

From FIGS. 9c and 9e, the arrangement of internal-connection electrode tabs and anchor/dummy tabs within a stack of mother and daughter electrodes of device 900 is shown. A first column of internal-connection tabs is formed from the internal-connection anchor tabs 929 flanking each daughter electrode 922 and mother electrode 932 as well as the internal-connection electrode tab 934 extending from mother electrode 935. A second column of internal-connection tabs is formed from the internal-connection anchor tabs 927 flanking each daughter electrode 920 and mother electrode 935 as well as the internal-connection electrode tab 932 extending from mother electrode 930.

When the stacked arrangement of alternating electrodes and dielectric layers discussed above is formed in a given direction of lamination, such device would be formed by first arranging three pairs of daughter electrodes 920, 922 and associated anchor tabs, followed by one pair of mother electrodes 930, 935, and associated anchor tabs followed by an additional three pairs of daughter electrodes 920, 922 and associated anchor tabs. Again, it should be appreciated that many more pairs of first and second electrodes 920 and 922 would normally be provided, depending on the desired level of capacitance in the finished device. In addition, it should be appreciated that the location of the single pair of mother electrodes 930, 935 does not necessarily have to be in the middle of the laminated stack. In other examples, such single pair (or other grouping of one or more mother electrodes) can be provided on a given end of the stack or at some other intermediate location, while still achieving similar benefits of controlled ESR and low inductance.

Additional aspects of the seventh exemplary capacitor embodiment 900 can be appreciated from FIGS. 9f and 9g, which provide various illustrations of such seventh embodiment 900 after the application of peripheral terminations.

FIG. 9g shows a generally top and side perspective view of capacitor embodiment 900, similar to that depicted in FIG. 9b, illustrated without dielectric material but with the addition of peripheral terminations. FIG. 9f shows a cross-sectional view of the same device 900 taken along section line 9f-9f in FIG. 9g and including an outline of dielectric body 940.

As apparent from FIGS. 9f and 9g, two internal-connection terminations 988, 989 are provided on a non-mounting surface of the device. A first polarity internal-connection termination 988 is directly connected to the internal-connection electrode tabs 921 of each daughter electrode 920, internal-connection electrode tab 934 on each mother electrode 935, and internal-connection anchor tabs 929 flanking each daughter electrode 922 and mother electrode 930. A second polarity internal-connection termination 989 is directly connected to the internal-connection electrode tabs 923 of each daughter electrode 922, the internal-connection electrode tab 932 extending from mother electrode 930, and the internal-connection anchor tabs 927 flanking each daughter electrode 920 and mother electrode 935.

On an opposite surface configured for mounting the device 900, four circuit-connection terminals 981, 983, 981′ and 983′ are provided in four substantially parallel strips. Circuit-connection terminal 981 is connected to circuit-connection electrode tab 931 of mother electrode 930 and circuit-connection anchor tabs 924 provided adjacent to each daughter electrode 920 and 922 as well as mother electrode 935. Circuit-connection terminal 983 is connected to circuit-connection electrode tab 933 of mother electrode 935 and circuit-connection anchor tabs 926 provided adjacent to each daughter electrode 920 and 922 as well as mother electrode 930. Circuit-connection terminal 981′ is connected to circuit-connection electrode tab 931′ of mother electrode 932 and circuit-connection anchor tabs 924′ provided adjacent to each daughter electrode 920 and 922 as well as mother electrode 935. Circuit-connection terminal 983′ is connected to circuit-connection electrode tab 933′ of mother electrode 935 and circuit-connection anchor tabs 926′ provided adjacent to each daughter electrode 920 and 922 as well as mother electrode 930.

In one embodiment of the present subject matter, device 900 is selectively formed with resistive terminations as previously described. In a particular example, the internal-connection terminals 988 and 989 of device 900 are formed as respective stripes of resistive material. The extra resistance provided by such resistive terminal elements is apparent from the circuit diagram of FIG. 9h, which shows an equivalent schematic representation of aspects of device 900. Such schematic depicts the mother electrodes 930 and 935 in the middle forming a first parallel-plate capacitance 951. Each pair of daughter electrodes 920, 922 forms a parallel-plate capacitance 950 provided in parallel with other capacitors 950 and the mother electrode capacitance 951. The parallel connections are made by internal-connection terminals 988 and 989. Since such terminals are made of resistive material, they add additional resistances (respectively formed by the portion of each resistive terminal through which current travels from electrode to adjacent electrode) represented by resistors 978 and 979. Respective resistances are also associated with each pair of daughter electrodes 920 and 922, namely a first resistance 960 formed by each electrode plate 922 (and including internal-connection tab 923) and a second resistance 970 formed by each electrode plate 920 (and including internal-connection tab 921). Each capacitance 950 is electrically represented in series with the first daughter electrode resistance 960 and second daughter electrode resistance 970. Looking into the circuit schematic from circuit-connection terminals 983, 983′, three resistances attributable to mother electrode 935 are provided—namely, a resistance 961 from external-connection tabs 933 and 933′, a resistance 962 from the main portion of mother electrode 935, and a resistance 963 from the internal-connection tab 934. From circuit-connection terminals 981, 981′, current flow will pass through three resistances attributable to mother electrode 930—namely, a resistance 964 from external-connection tabs 931 and 931′, a resistance 965 from the main portion of mother electrode 930, and a third resistance 966 from the internal-connection tab 932. Again, by ensuring that the resistances 961-966, respectively are not provided in parallel with the total resistance value formed from daughter electrodes 920, 922, but in series, increased ESR is available. In addition, the additional series resistance provided by portions of the resistive internal-connection terminals 988 and 989 further increases overall device ESR.

As apparent from several of the embodiments discussed above, the positioning of internal conductive elements and precisely controlled location of exposed edges of such conductive elements (i.e. electrodes, electrode tabs, anchor tabs, etc.) lends itself to the formation of precisely spaced external terminations, especially when self-determining thin-film plating materials are deposited, for example, with electroless and/or electrolytic plating techniques. In some embodiments, it may be desired to form adjacent circuit-connection terminals with a relatively narrow controlled gap between such terminals, such as on the order of about 100-300 mils, for example.

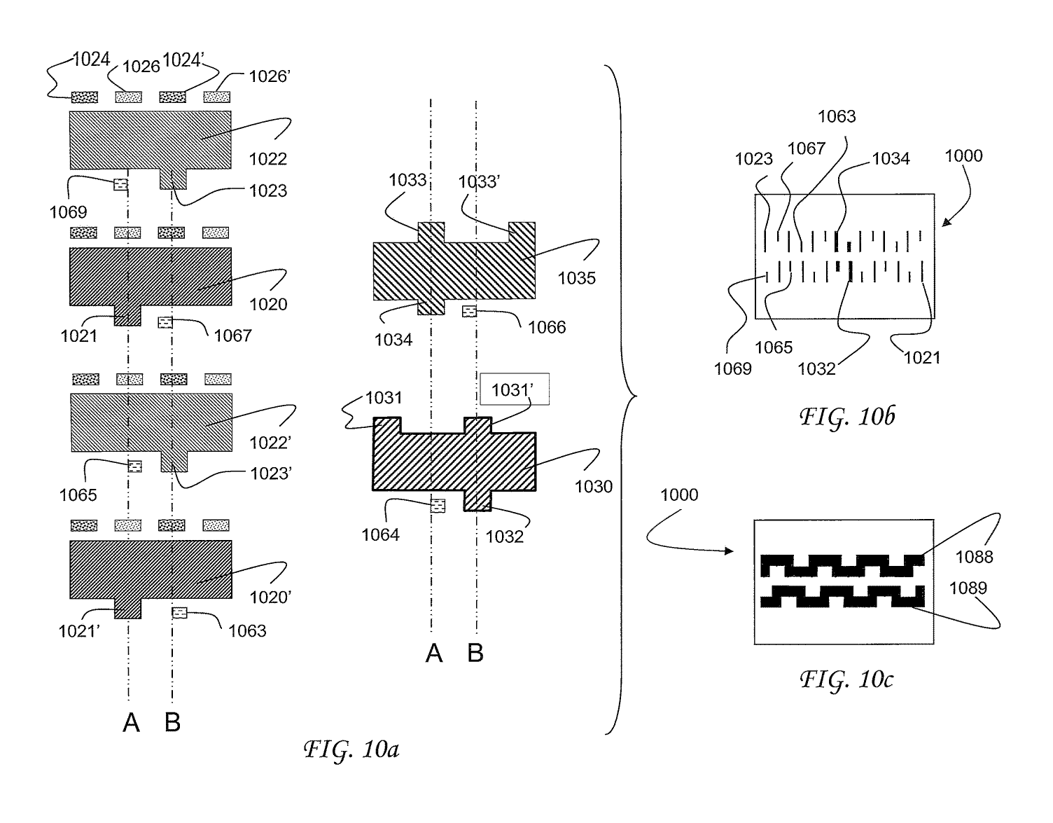

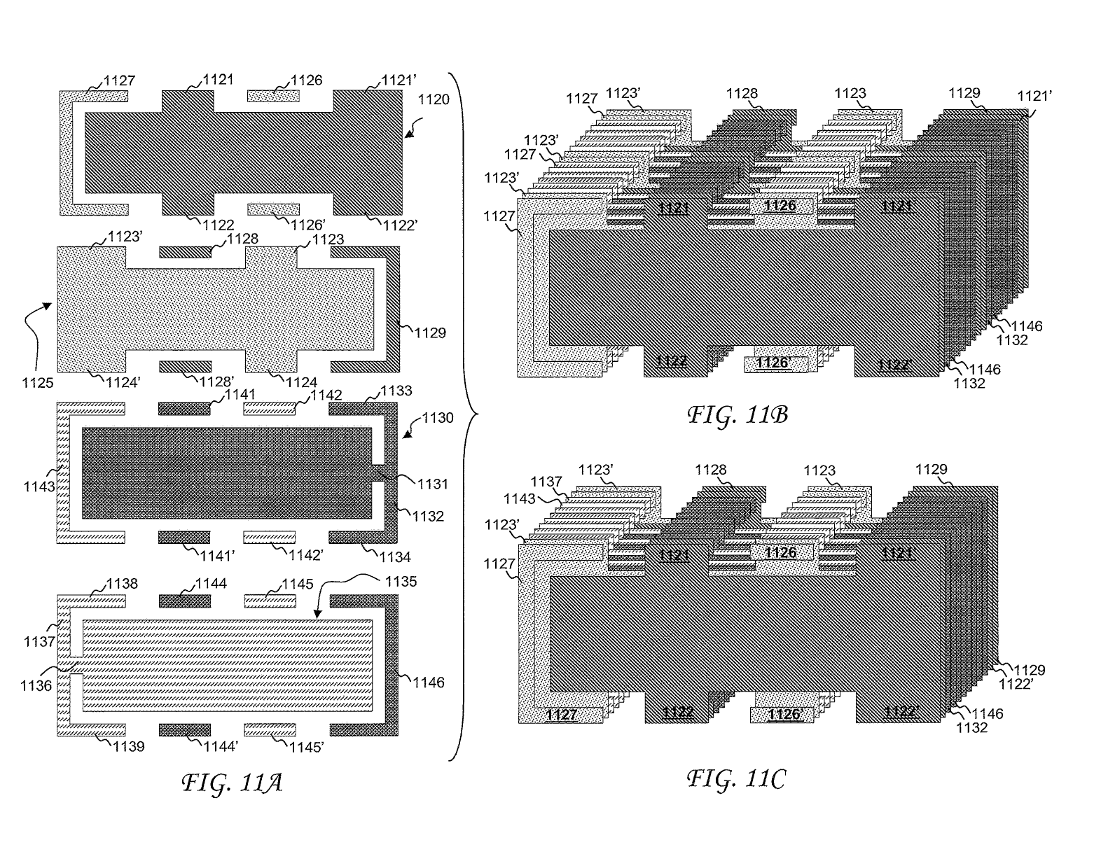

In still further embodiments, it may be desirable to take advantage of some of the precision benefits of thin-film plating techniques to form external terminations with unique shapes such as depicted in FIG. 10c. By forming external terminations 1088 and 1089 in a serpentine pattern as shown in FIG. 10c, a more resistive structure is formed on the surface of an MLC device by forcing current through a longer and narrower path between connected electrodes. Additional details of such exemplary embodiment are presented with more particular reference to FIGS. 10a and 10b.

FIG. 10a shows six different electrode configurations, including four exemplary daughter electrodes 1022, 1022′, 1020 and 1020′ as well as exemplary mother electrode patterns 1030 and 1035. Daughter patterns 1020 and 1020′ are similar to daughter electrode pattern 920 shown in FIG. 9a, except that the single internal-connection anchor tab (previously 927) is cut to a portion of the width (e.g., half-width) and placed in two different locations relative to center line B in FIG. 10a. More particularly, anchor tab 1067 provided adjacent to the main portion of electrode pattern 1020 is provided immediately to the left of centerline B, while anchor tab 1063 provided adjacent to the main portion of electrode pattern 1020′ is provided immediately to the right of centerline B. Daughter patterns 1022 and 1022′ are similar to daughter electrode 922 of FIG. 9a, except that the single internal-connection anchor tab (previously 929) is cut to a portion of the width (e.g., half-width) and placed in two different locations relative to center line A in FIG. 10a. More particularly, anchor tab 1069 provided adjacent to the main portion of electrode pattern 1022 is provided immediately to the left of centerline A, while anchor tab 1065 provided adjacent to the main portion of electrode pattern 1022′ is provided immediately to the right of centerline A. Mother electrode 1030 of FIG. 10a is similar to mother electrode 930 of FIG. 9a, with its internal-connection anchor tab 1064 cut to a portion of the width (e.g., half-width) and provided on one side of centerline A (either left or right depending on where in the stack the mother electrodes are placed). Mother electrode 1035 of FIG. 10a is similar to mother electrode 1030 of FIG. 9a, with its internal-connection anchor tab 1066 cut to a portion of the width (e.g., half-width) and provided on one side of centerline B (either left or right, depending on where in the stack the mother electrodes are placed).

An exemplary stack of the mother and daughter electrodes depicted in FIG. 10a may correspond to any number of pairs of daughter electrodes, interleaved with one or more mother electrodes provided at one or more selected locations therebetween. For example, FIG. 10b shows a plan view of a device 1000 formed by alternating dielectric layers with a laminated stack of electrode patterns as follows: 1022, 1020, 1022′, 1020′, 1022, 1020, 1035, 1030, 1020, 1022, 1020′, 1022′, 1020, 1022. By alternating the location of anchor tabs relative to respective center lines A and B (shown in FIG. 10a), the exposure location of such anchor tab edges 1069, 1067, 1065, 1063, 1066 and 1064 will combine with the exposure location of electrode tab edges 1023, 1021, 1023′, 1021′ 1034 and 1032 to form a staggered array in two substantially adjacent columns of tab exposure. This array of tab exposure provides a self-determining base for selective depositing of generally serpentine-shaped peripheral terminations 1088 and 1089 as shown in FIG. 10c. In one example, the previously described thin-film plating process described in U.S. Pat. No. 6,972,942 (Ritter et al.) could be used to form terminations 1088 and 1089. It should be appreciated that various termination designs other than the illustrated serpentine pattern can be formed on a surface of an MLC device, to selectively add or tune resistance or inductance as needed in a resulting circuit.

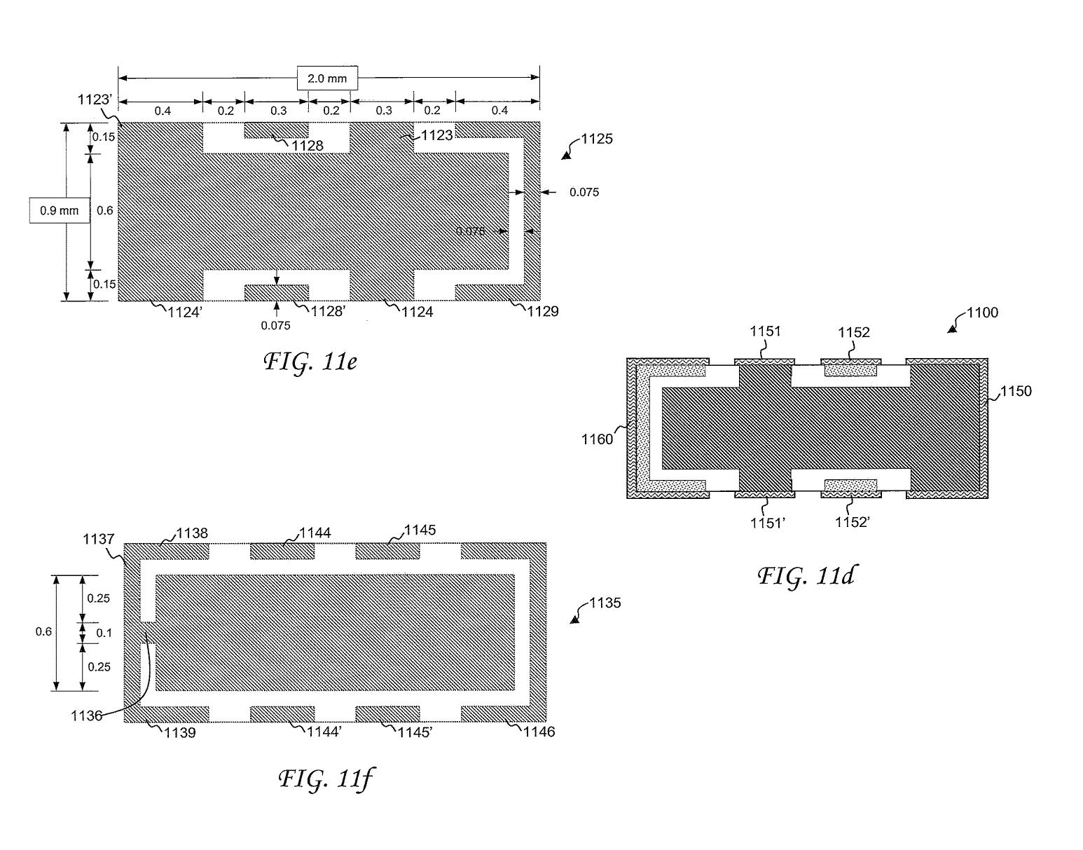

Aspects of a ninth exemplary embodiment of the disclosed technology 1100 are presented in FIGS. 11a-11f, respectively. Such embodiment shows another variation of exemplary electrode configurations for use in a low inductance, controlled ESR multilayer capacitor. FIG. 11a provides generally plan views of four different electrode patterns, including mother electrodes 1120 and 1125 as well as daughter electrodes 1130 and 1135.

First mother electrode 1120 includes a substantially rectangular main portion with four tabs extending therefrom. First and second circuit-connection tabs 1121 and 1122 extend from generally opposing locations along opposite longer sides of the main portion of mother electrode 1120. Internal connection tabs 1121′ and 1122′ extend from generally opposing locations along longer sides of the main portion of mother electrode 1120 and are provided adjacent to an end surface thereof. When provided in a laminated stack, each electrode 1120 offers a continuous portion of the main electrode 1120 including tabs 1121′ and 1122′ for exposure along an entire end dimension and onto portions of the opposing side dimensions, thus facilitating wrap-around external terminations. The main portion of mother electrode 1120 is also flanked by three different anchor tabs, including first and second circuit-connection anchor tabs 1126 and 1126′ and a C-shaped internal-connection anchor tab 1127. Circuit-connection anchor tabs 1126 and 1126′ are provided on generally opposing sides of the main portion, although not directly connected to the electrode 1120. C-shaped anchor tab 1127 extends to a similar continuous portion of an end dimension and adjacent sides as do tabs 1123′ and 1124′ of second mother electrode 1125.

Second mother electrode 1125 also includes a substantially rectangular main portion with four tabs extending therefrom. First and second circuit-connection tabs 1123 and 1124 extend from generally opposing locations along opposite longer sides of the main portion of mother electrode 1125. Internal connection tabs 1123′ and 1124′ extend from generally opposing locations along longer sides of the main portion of mother electrode 1125 and are provided adjacent to an end surface thereof. When provided in a laminated stack, each electrode 1125 offers a continuous portion of the main electrode 1125 including tabs 1123′ and 1124′ for exposure along an entire end dimension and onto portions of the opposing side dimensions, thus facilitating wrap-around external terminations. The end dimension to which mother electrode 1125 and tab portions 1123′ and 1124′ extend is generally opposite the end dimension to which mother electrode 1120 and tab portions 1121′ and 1122′ extend. The main portion of mother electrode 1125 is also flanked by three different anchor tabs, including first and second circuit-connection anchor tabs 1128 and 1128′ and a C-shaped internal-connection anchor tab 1129. Circuit-connection anchor tabs 1128 and 1128′ are provided on generally opposing sides of the main portion, although not directly connected to the electrode 1125. C-shaped anchor tab 1129 extends to a similar continuous portion of an end dimension and adjacent sides as do tabs 1121′ and 1122′ of first mother electrode 1120.

Referring still to FIG. 11a, a first daughter electrode 1130 also includes a substantially rectangular main portion. A single internal-connection end tab 1131 extends from the middle of an end of the main rectangular portion and is connected to a C-shaped structure that includes an end portion 1132 and side-arm extensions 1133, 1134 that generally extend in a substantially parallel fashion to the main rectangular portion of daughter electrode 1130. The exposure location of end portion 1132 and side arms 1133, 1134 is similar to that of C-shaped anchor tab 1129 flanking mother electrode 1125. The main portion of daughter electrode 1130 is also flanked by circuit-connection anchor tabs 1141, 1141′, 1142 and 1142′ as well as C-shaped internal-connection anchor tab 1143. Anchor tabs 1141 and 1141′ generally oppose one another, in similar locations as anchor tabs 1128 and 1128′ of mother electrode 1125. Anchor tabs 1142 and 1142′ generally oppose one another, in similar locations as anchor tabs 1126 and 1126′ of mother electrode 1120. C-shaped internal-connection anchor tab 1143 surrounding an end of daughter electrode 1130 provides a similar exposure location to the C-shaped electrode 1127 provided adjacent an end of mother electrode 1120.

Second daughter electrode 1135 also includes a substantially rectangular main portion. A single internal-connection end tab 1136 extends from the middle of an end of the main rectangular portion and is connected to a C-shaped structure that includes an end portion 1137 and side-arm extensions 1138, 1139 that generally extend in a substantially parallel fashion to the main rectangular portion of daughter electrode 1135. The exposure location of end portion 1137 and side arms 1138, 1139 is similar to that of C-shaped anchor tab 1127 flanking mother electrode 1120. The main portion of daughter electrode 1135 is also flanked by circuit-connection anchor tabs 1144, 1144′, 1145 and 1145′ as well as C-shaped internal-connection anchor tab 1146. Anchor tabs 1144 and 1144′ generally oppose one another, in similar locations as anchor tabs 1128 and 1128′ of mother electrode 1125. Anchor tabs 1145 and 1145′ generally oppose one another, in similar locations as anchor tabs 1126 and 1126′ of mother electrode 1120. C-shaped internal-connection anchor tab 1146 surrounding an end of daughter electrode 1135 provides a similar exposure location to the C-shaped electrode 1129 provided adjacent an end of mother electrode 1125.

A significant feature of the exemplary electrode patterns shown in FIG. 11a stems from the rather narrow connector tabs 1131 and 1136 associated with the daughter electrodes 1130 and 1135. By forcing current from each C-shaped end electrode portion through such narrow respective pathways to the main daughter electrode portions, the current path and its tortuosity is increased, thus increasing overall device ESR and helping to achieve the low inductance controlled ESR devices of the present subject matter.

Referring now to FIGS. 11b and 11c, the mother and daughter electrode patterns shown in FIG. 11a can be provided in a variety of stacked configurations, such as those previously illustrated or discussed or those shown in FIGS. 11b and 11c. For example, FIG. 11b shows a generally top, side perspective view of a laminated stack of electrode patterns, starting with a first pair of mother electrodes 1120, 1125, three pairs of daughter electrodes 1130, 1135, a second pair of mother electrodes 1120, 1125, three more pairs of daughter electrodes 1130, 1135 and finally a third pair of mother electrodes 1120, 1125. Each of such referenced mother and daughter electrodes includes its associated anchor tabs. As such, one pair of mother electrodes is provided at each end of the stack, and one in the middle thus yielding a symmetrical device. Many more pairs of daughter electrodes may be provided in between the mother electrodes, as respective groups of three pairs are shown merely for ease and clarity of illustration. In an alternative example, as shown in FIG. 11c, no mother electrodes are provided in the middle of the stacked arrangement, but only on the ends thereof. It should be appreciated that any number of daughter electrodes may be provided in between the mother pairs, and in some embodiments, mother electrodes may be provided in groups other than pairs, such as, for example, groups of one to five mother electrodes.

Although not shown in FIG. 11b or 11c, the various electrode patterns are alternately stacked in a direction of lamination with ceramic sheets or dielectric layers that provide a spaced relationship between adjacent electrodes to form multiple parallel-plate capacitors. In one example, a laminated stack of such dielectric layers and electrodes is fired to produce a body of dielectric material in which electrodes and corresponding anchor tabs are embedded. Such internal conductive elements extend to and are exposed along selected surfaces of a fired device body, at which point external terminations may be applied. In one example, terminations are applied using thin-film plating techniques as previously discussed.

FIG. 11d shows a cross-sectional view of a finished MLC 1100 with the application of external terminations. Opposing wrap-around terminations 1150 and 1160 straddle three adjacent surfaces of a device, including a device end and two adjacent surfaces. Internal-connection termination 1150 connects all mother electrodes 1120 and daughter electrodes 1130 to a first polarity location, and is also directly connected to C-shaped anchor tabs 1129 and 1146. Internal-connection termination 1160 connects all mother electrodes 1125 and daughter electrodes 1135 together at a second polarity location, and is also directly connected to C-shaped anchor tabs 1127 and 1143. Circuit-connection terminations 1151 and 1151′ are provided at generally opposite locations, while circuit-connection terminations 1152 and 1152′ are provided at generally opposite locations. Termination 1151 is connected to each circuit-connection electrode tab 1121 associated with a mother electrode 1120 and to anchor tabs 1128 (of each mother electrode 1125), 1141 (of each daughter electrode 1130) and 1144 (of each daughter electrode 1135). Termination 1151′ is connected to each circuit-connection electrode tab 1122 associated with a mother electrode 1120 and to anchor tabs 1128′ (of each mother electrode 1125), 1141′ (of each daughter electrode 1130) and 1144′ (of each daughter electrode 1135). Termination 1152 is connected to each circuit-connection electrode tab 1123 associated with a mother electrode 1125 and to anchor tabs 1126 (of each mother electrode 1120), 1142 (of each daughter electrode 1130) and 1145 (of each daughter electrode 1135). Termination 1152′ is connected to each circuit-connection electrode tab 1124 associated with a mother electrode 1125 and to anchor tabs 1126′ (of each mother electrode 1120), 1142′ (of each daughter electrode 1130) and 1145′ (of each daughter electrode 1135).

Referring now to FIGS. 11e and 11f, exemplary dimensions for one example of the electrode patterns provided in FIGS. 11a are provided. These dimensions are provided only as one example of possible relative element sizes and should not be unnecessarily limiting to the present subject matter. FIG. 11e depicts exemplary dimensions for a mother electrode pattern 1125, although can equally apply to mother electrode pattern 1120. Each pattern is generally characterized by an overall size (resulting in a device size) that is about 0.9 mm by 2.0 mm. The substantially rectangular main portion of electrode pattern 1125 is about 0.6 mm by 1.85 mm. Internal-connection anchor tabs are about 0.4 mm by 0.15 mm. Spaced about 0.2 mm from the nearest end of each tab 1123′ and 1124′, internal-connection anchor tabs 1128 and 1128′ have dimensions of about 0.3 mm by 0.075 mm. Spaced about 0.2 mm from the nearest end of each anchor tab 1128, 1128′, circuit-connection electrode tabs 1123 and 1124 have dimensions of about 0.3 mm by 0.15 mm. The main end portion of C-shaped anchor tab 1129 extends along the entire 0.9 mm dimension with a width of about 0.075 mm. Side arm portions thereof extend about 0.4 mm and are also about 0.075 mm in width.

Referring more particularly to FIG. 11f, similar dimensions described with reference to FIG. 11e apply to the daughter electrode 1135 (as well as to opposing daughter electrode 1130). The substantially rectangular main portion of each daughter electrode 1135 measures about 0.6 mm by 1.7 mm. Each connective tab portion 1136 has a width of only about 0.1 mm, thus providing a relatively narrow current path to the main electrode portion.

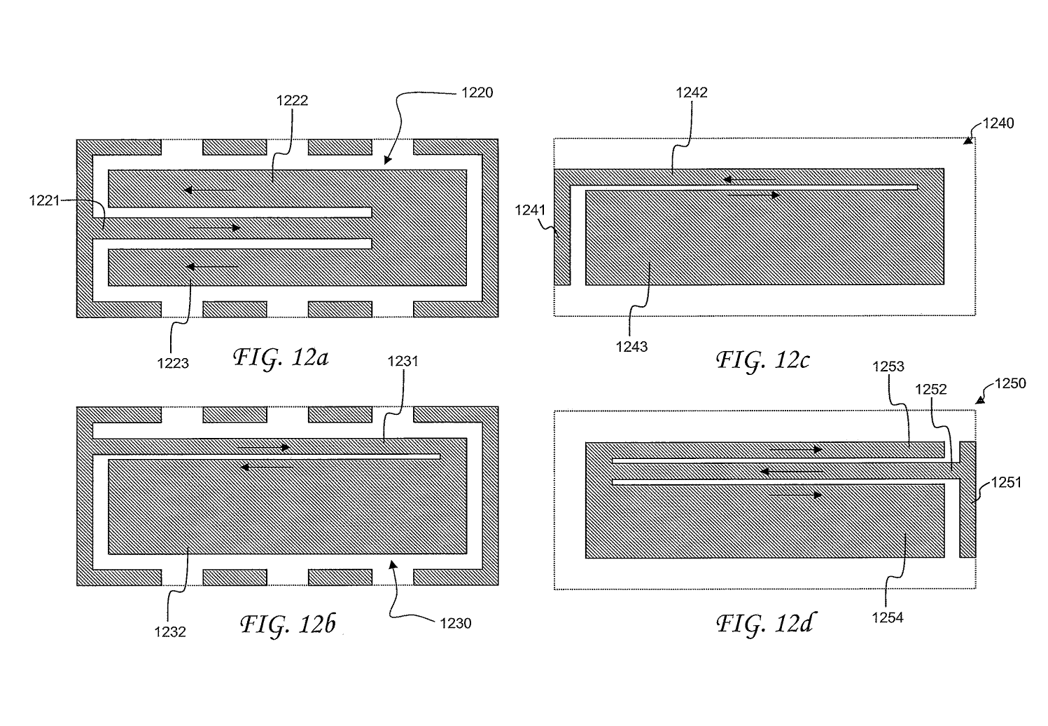

Referring now to FIGS. 12a-12d, respectively, additional features are illustrated for increasing overall device performance, including lowered ESL through improved current cancellation as well as increased ESR by increased current path lengths. The direction of current flow will be indicated in FIGS. 12a-12d by respective directional arrows, thus depicting aspects of both increased path length and improved current cancellation. Such features may be implemented as shown or incorporated into one or more of the prior horizontal or vertical electrode patterns discussed herein or variations thereof as will be appreciated by one of ordinary skill in the art.

FIG. 12a shows an exemplary electrode pattern 1220, which is similar in many respects to the daughter electrode pattern 1135 shown in FIG. 11a, except that the substantially rectangular main portion is replaced by three substantially parallel extensions, namely a center extension 1221 and adjacent side-arm extensions 1222 and 1223. Current entering electrode 1220 is forced from a C-shaped terminal through a narrow tab portion in a first direction down the center extension 1221 and back in the opposite direction through side-arm extensions 1222 and 1223.

FIG. 12b shows another variation, similar to daughter electrode 1135 of FIG. 11a. Discussion of similar features of daughter electrode 1135 equally applies to the embodiments illustrated in FIGS. 12a and 12b. In FIG. 12b, electrode pattern 1230 replaces the substantially rectangular main portion of daughter electrode 1135 with first and second parallel portions 1231 and 1232, respectively. The first portion 1231 consists of a relatively narrow pathway into a substantially larger main portion, in which current will flow in an opposite direction as indicated.

FIGS. 12c and 12d depict additional exemplary electrode patterns for a main electrode portion (e.g., for daughter electrodes). In FIG. 12c a main electrode portion includes an end portion 1241 for connection to an external termination. Current entering electrode pattern 1240 would travel down a first relatively narrow pathway portion 1242 into a substantially larger main portion 1243, in which the current will flow in a substantially opposite direction as indicated. Both electrode portions 1242 and 1243 are provided in a generally parallel relationship to one another.

In FIG. 12d, an exemplary electrode pattern 1250 includes a wide end tab portion 1251 for connection to an external termination and first, second and third internal portions provided generally parallel to one another and generally connected at the ends thereof opposing the end portion 1251. Current entering electrode 1250 passes first through a first central internal portion 1252 and then in the opposite direction through side portions 1253 and 1254. In FIG. 12d, side portion 1254 has a relatively wider dimension than the narrower side portion 1253, although it should be appreciated that the widths thereof may be altered in different fashions. Still further, although the electrode patterns of FIGS. 12c and 12d are illustrated without surrounding anchor tab features, it should be appreciated that such additional termination points may be added as described in previous exemplary embodiments.

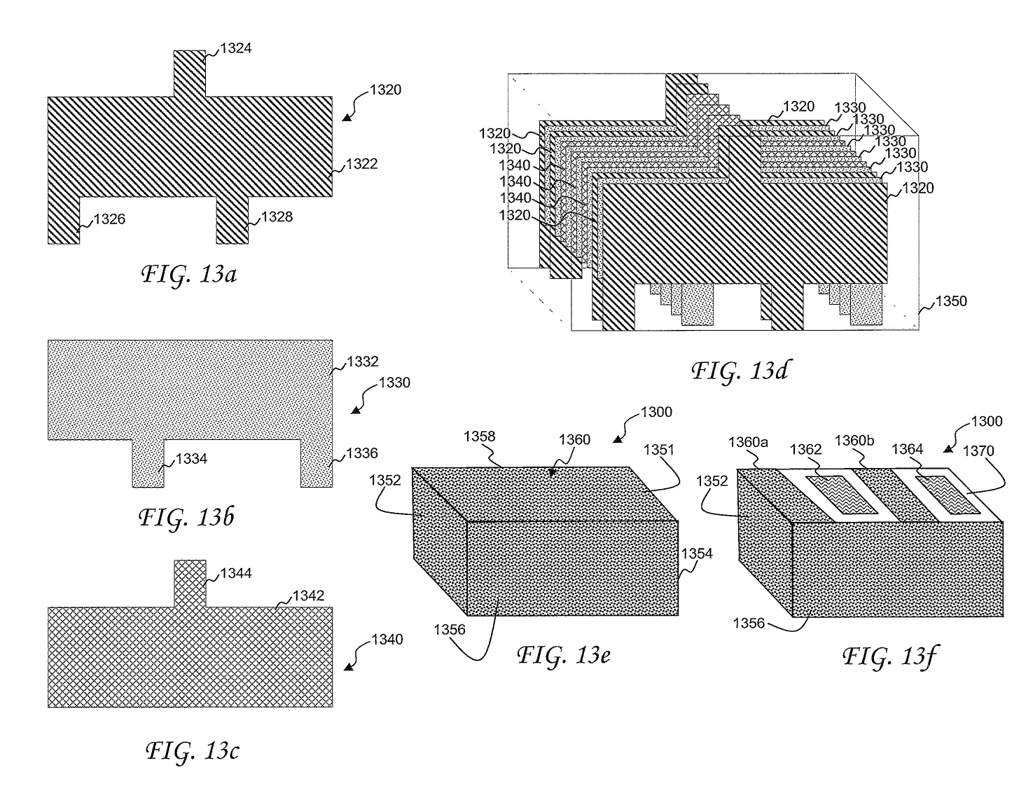

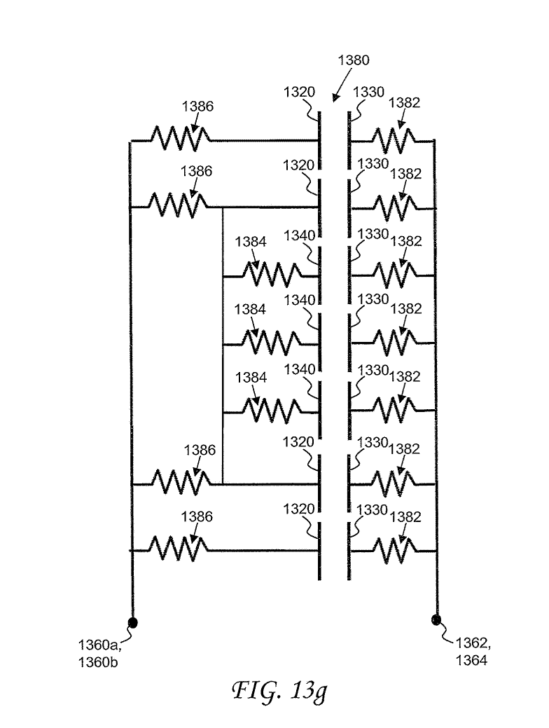

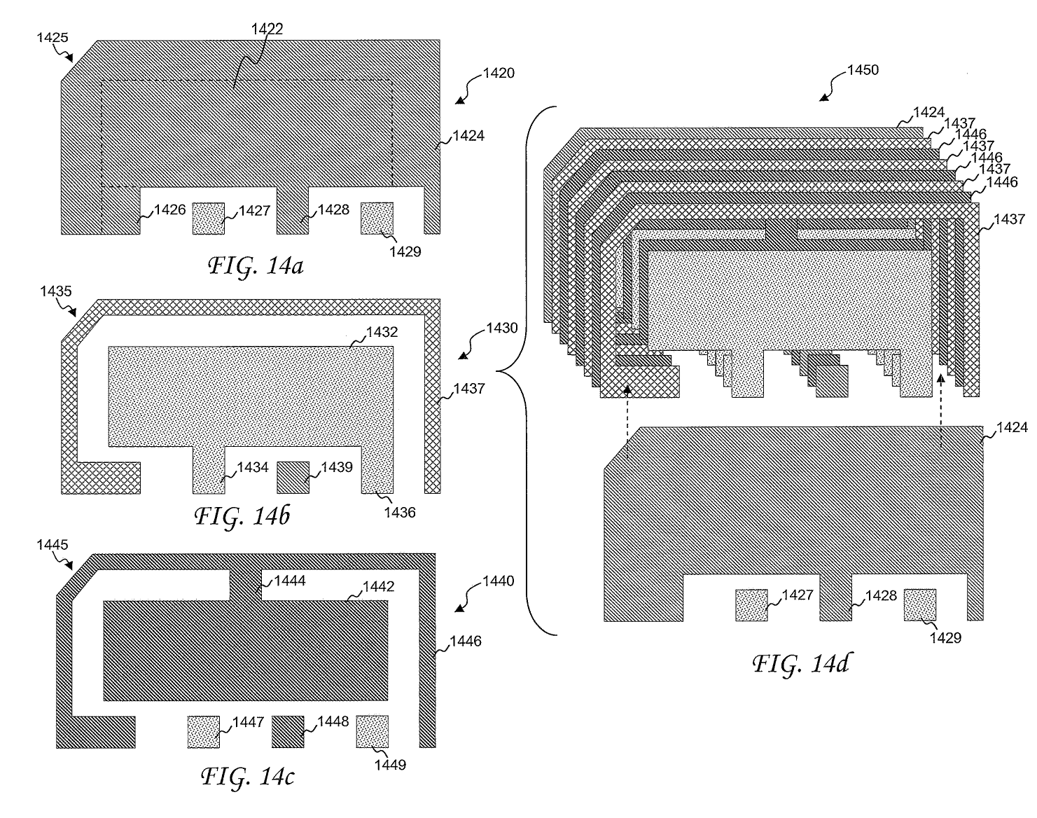

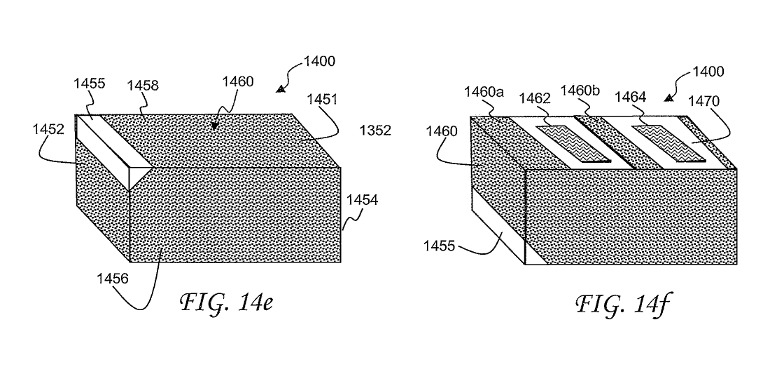

Additional embodiments of the disclosed technology combine the advantages of controlled ESR with termination structures that provide shielding by substantially covering one or more peripheral surfaces of an MLC. Such termination structures can generally facilitate heat transfer and dissipation by carrying heat away from internal areas where the ceramic dielectric acts to insulate generated heat. Some such structures may also serve as an isolation shield for the MLCs to protect against electromagnetic interference (EMI) that may be generated in various circuit applications. More specific aspects of such embodiments are depicted in FIGS. 13a-14f, respectively.

Referring now to FIGS. 13a-13c, three different electrode patterns 1320, 1330 and 1340 for use in a shielded capacitor embodiment with controlled ESR are illustrated. Electrodes 1320 and 1340 correspond to different electrodes patterns of a first polarity, while electrode pattern 1330 is a second polarity electrode pattern. In general, electrode patterns are layered in a stacked arrangement of first and second polarity electrode patterns alternately interleaved with layers of dielectric material. The electrodes 1320, 1330 and 1340 as discussed with reference to FIGS. 13a-13f are shown and described as vertical electrodes, with respect to the planned mounting to the circuit board, although other relative positioning within a multilayer capacitor may be possible.

FIG. 13a discloses a first polarity mother electrode 1320 that includes a substantially rectangular main portion 1322 with three tabs extending therefrom on longer top and bottom sides of the main portion 1322. A single internal-connection electrode tab 1324 extends from a given location along a top longer side of the main electrode portion 1322 of electrode 1320. Although shown as extending from a generally central location, it should be appreciated that tab 1324 can extend from any location along main portion 1322 since the entire top of the device provides a conductive surface for connecting to tab 1324. First and second circuit-connection electrode tabs 1326 and 1328 extend from the bottom side opposite that from which tab 1324 extends.

FIG. 13b discloses a second polarity electrode 1330 that includes a substantially rectangular main portion 1332 with two tabs extending therefrom on the longer bottom side of the electrode 1330. Two circuit-connection electrode tabs 1334 and 1336 extend to the bottom longer side of main portion 1332 in locations that are offset from the bottom tabs 1326 and 1328 of electrode 1320 such that stacked pluralities of the four tabs 1326, 1328, 1334 and 1336 will be in alternating but adjacent columns as visually depicted in the perspective view of FIG. 13d. Since a single pattern for second polarity electrode 1330 will be used to couple with both mother and daughter electrodes 1320 and 1340 of a first polarity, electrode 1330 may be referred to as a hybrid electrode pattern since it functions in both mother and daughter capacities.

FIG. 13c discloses a first polarity daughter electrode 1340 that includes a substantially rectangular main portion 1342 and a single internal-connection electrode tab 1344 that extends from a longer top side of main portion 1342 of electrode 1340. The internal-connection tab 1344 extends from the same given location along the top longer side of electrode 1340 similar to the same surface to which tab 1324 extends from electrode 1320. This alignment of internal-connection tabs facilitates the internal electrical connection of mother and daughter electrodes 1320 and 1340 of a given first polarity. It will be appreciated that current flow into and out of the first polarity daughter electrodes substantially occurs only through respective internal-connection electrode tabs 1344.

As shown in FIG. 13d, one embodiment of the disclosed technology provides a multilayer capacitor (MLC) 1350 (represented by the dotted line outline) formed by selectively stacking electrodes 1320, 1330 and 1340 with interleaved dielectric layers (not shown in the figure for ease and clarity of illustration). From front to back, the stacked configuration includes the following sequence of electrodes, with one or more dielectric layers provided between each adjacent pair of electrodes: a first polarity mother electrode 1320, a second polarity hybrid electrode 1330, a first polarity mother electrode 1320, a second polarity hybrid electrode 1330, a first polarity daughter electrode 1340, a second polarity hybrid electrode 1330, a first polarity daughter electrode 1340, a second polarity hybrid electrode 1330, a first polarity daughter electrode 1340, a second polarity hybrid electrode 1330, a first polarity mother electrode 1320, a second polarity hybrid electrode 1330 and a first polarity mother electrode 1320.

It should be appreciated with regard to FIG. 13d that many more pairs of first polarity daughter electrode 1340 and second polarity hybrid electrode 1330 may be provided in between the front and back sets of first polarity mother electrode 1320 and second polarity hybrid electrode 1330, as respective groups of three pairs are shown merely for ease and clarity of illustration. In an alternative example, first polarity mother electrodes 1320 are not provided on both ends of the stacked configuration, but only in a single location such as on a single end or in the middle of the stacked configuration. Any number of daughter electrodes may be provided in between or surrounding the mother pairs. In some embodiments, mother electrodes may be provided in groups other than pairs, such as, for example, groups of one to five mother electrodes. However, to facilitate a shielded structure, it is generally preferred that a first polarity electrode (either a mother electrode 1320 or a daughter electrode 1340) be provided on the very front and back of a stacked assembly 1350 as shown in FIG. 13d so that device shielding can be implemented.

Exemplary peripheral terminations for a device formed from the stacked electrode assembly of FIG. 13d are shown in FIGS. 13e and 13f. FIG. 13e shows a perspective view of a terminated device 1300 in the same relative orientation as the assembly 1350 of FIG. 13d. Each of five surfaces of the device 1300, including top surface 1351, end surfaces 1352 and 1354, and side surfaces 1356 and 1358 are substantially covered with a conductive material. Such encompassing larger portion 1360 of conductive material forms a first circuit-connection terminal that also functions as a device shield and heat dissipation feature. Heat dissipation for the resultant MLC 1300 is facilitated because a larger conductive surface for transferring heat away from the relatively insulative ceramic dielectric material is provided. An additional benefit is that such peripheral termination 1360 serves as an isolation shield for protecting MLC 1300 from electromagnetic interference (EMI) levels that may exist in a circuit application.

Additional termination elements for device 1300 are shown in FIG. 13f, which provides a bottom (surface mount) perspective view of device 1300. On the bottom (mounting) surface 1370 of MLC 1300, two second polarity terminations 1362 and 1364 that respectively cover exposed portions of electrode tabs 1334 and 1336 of second polarity electrodes 1330 are provided. Termination stripes 1360a and 1360b are electrically connected as part of continuous peripheral termination 1360, but serve to cover the portions of first polarity electrode tabs 1326 and 1328 that are initially exposed along mounting surface 1370. Circuit connection to MLC 1300 can thus occur by mounting the bottom surface 1370 in a circuit environment and electrically connecting to the first polarity circuit-connection terminal portions 1360a and 1360b and to the second polarity circuit-connection terminals 1362 and 1364.

The application of conductive material forming peripheral terminations 1360-1364 of FIGS. 13e and 13f may be applied by any number of suitable methods known to one of ordinary skill in the art, including but not limited to printing, sputtering, vacuum deposition or the like. In one example, a stacked assembly 1350 is laid on a flat plate to protect bottom surface 1370 prior to a process of sputtering conductive material over each of the surfaces 1351, 1352, 1354, 1356 and 1358. Selective portions of conductive material corresponding to strips 1360a, 1360b, 1362 and 1364 may be formed by using a shadow mask and then sputtering or otherwise depositing conductive material on the bottom surface 1370 of MLC 1300. Alternatively, it may be possible to plate the bottom conductive stripes 1360a, 1360b, 1362 and 1364 after the other device surfaces have been covered with conductive material. A masking feature (such as a strip or corner cover) may also be used to prevent application of conductive material on a select portion of one or more of surfaces 1351-1358 so that an orientation feature is provided to help position and package the resultant MLC 1300.

Referring now to FIG. 13g, an equivalent circuit schematic representation of device 1300 of FIGS. 13e/13f is presented. It should be appreciated that a similar schematic will apply to corresponding components of MLC device 1400, shown and discussed with reference to FIGS. 14a-14f, respectively. The schematic of FIG. 13g depicts an approximation of an equivalent circuit as seen between the first polarity surface mount terminals 1360a and 1360b and the second polarity surface mount terminals 1362 and 1364. As illustrated, combined pairs of opposing first and second polarity electrode plates form multiple parallel-plate capacitances. Four parallel-plate capacitances 1380 are formed from an opposing first polarity mother electrode 1320 and second polarity hybrid electrode 1330, while three parallel-plate capacitances 1380 are formed from an opposing first polarity daughter electrode 1340 and second polarity hybrid electrode 1330. Resistances 1382 are effectively formed from each second polarity hybrid electrode 1330 (including the main electrode portion 1332 and electrode tabs 1334 and 1336). Resistances 1384 are effectively formed from each first polarity daughter electrode 1340 (including the main electrode portion 1342 and electrode tab 1344). Resistances 1386 are effectively formed from each first polarity mother electrode 1320 (including the main electrode portion 1322 and electrode tab portions 1324, 1326 and 1328). The resultant configuration yields increased ESR compared to a traditional vertical electrode MLC, such as that shown in FIGS. 4a-4d, respectively, because current flowing through first polarity terminals 1460a, 1460b has to pass through the resistances 1386 from mother electrodes 1320 before seeing the daughter electrodes 1320 and corresponding resistances 1384. For the sake of simplifying this equivalent circuit, the resistance of the overall shielding conductor, as well as the conductive stripes 1360a, 1362, 1360b, and 1364 are assumed to be zero. However it should be appreciated that as in the above embodiment represented in FIG. 7h, additional ESR can be provided by making those coating materials more electrically resistive.

Aspects of another shielded MLC with controlled ESR are illustrated in FIGS. 14a-14f, which illustrate three different electrode patterns 1420, 1430 and 1440 for use in a shielded capacitor embodiment with controlled ESR. Such electrode patterns each generally include at least one main electrode portion and at least one anchor tab portion. Electrodes 1420 and 1440 correspond to different electrode patterns of a first polarity, while electrode pattern 1430 is a second polarity electrode pattern. In general, electrode patterns are layered in a stacked arrangement of first and second polarity electrode patterns alternately interleaved with layers of dielectric material. The electrodes 1420, 1430 and 1440 as discussed with reference to FIGS. 14a-14f are shown and described as vertical electrodes, although other relative positioning with a multilayer capacitor may be possible.

FIG. 14a discloses a first polarity mother electrode pattern 1420 that includes a substantially rectangular main portion 1422 with additional contiguous portions 1424 that are configured to extend to and be initially exposed along three adjacent surfaces of an MLC (e.g., a top surface and adjacent end surfaces). Tab portions 1426 and 1428 extend from a bottom side of the main portion 1422, and tab 1426 is contiguous with part of extended portion 1424, as shown. Anchor tabs 1427 and 1429 are also part of electrode pattern 1420 and are positioned in the same plane but not in direct electrical contact with the main electrode portion. Instead, anchor tabs 1427, 1429 will be positioned to align with electrode tabs associated with second polarity electrode 1430. In one exemplary embodiment, a portion of contiguous portion 1424 is notched (e.g., corner notch 1425) to provide an orientation feature as illustrated in FIGS. 14e and 14f. In some cases where higher EMI shielding effect is required, this notched portion would be eliminated and made into a right angle, so that the entirety of the top surface is covered.

FIG. 14b discloses a second polarity electrode pattern 1430 that includes a substantially rectangular main portion 1432. Two circuit-connection electrode tabs 1434 and 1436 extend from the bottom longer side of main portion 1432 in locations that are offset from the bottom tabs 1426 and 1428 of electrode 1420 such that stacked pluralities of the four tabs 1426, 1428, 1434 and 1436 will be in alternating but adjacent columns as visually depicted in the perspective view of FIG. 14d. In addition, the location of electrode tabs 1434 and 1436 generally corresponds to that of anchor tabs 1427 and 1429 of electrode pattern 1420 of FIG. 14a. Electrode pattern 1430 also includes two anchor tab elements 1437 and 1439. Anchor tab 1437 is a relatively narrow and elongated portion that wraps around the edges of, parallel to, but electrically isolated from, at least three sides of the main electrode portion 1432 in electrode pattern 1430. Similar to electrode portion 1424 of FIG. 14a, anchor tab 1437 has a wrap-around configuration that extends to and is initially exposed along three adjacent surfaces (e.g., a top surface and adjacent end surfaces). Anchor tab 1437 may also extend to portions of a bottom surface mountable location, immediately adjacent to the end surfaces. Anchor tab 1439 also extends to and is exposed along a bottom mounting surface, and is positioned in between although not in direct contact with the electrode tabs 1434 and 1436. Anchor tab 1439 and an additional portion of anchor tab 1437 extending along a bottom surface of the electrode pattern 1430 are intended to generally align with the location of electrode tabs 1426 and 1428 of electrode pattern 1420 in FIG. 14a. In one exemplary embodiment, a portion of anchor tab 1437 may be notched (e.g., corner notch 1435) to provide an orientation feature as illustrated in FIGS. 14e and 14f.

FIG. 14c discloses a first polarity daughter electrode pattern 1440 that includes a substantially rectangular main portion 1442 and a narrow electrode tab 1444 that extends from a longer top side of main portion 1442 of electrode 1440. The internal-connection tab 1444 extends from a generally central location along the top longer side of electrode 1440 to form a narrow pathway by which current enters and exits the main electrode portion 1442. Another wrap-around electrode portion 1446 is connected to the pathway tab 1444. Wrap-around electrode portion 1446 extends to and is initially exposed along three adjacent surfaces (e.g., a top surface and adjacent end surfaces) and optionally to portions of a bottom surface mountable location, immediately adjacent to the end surfaces. Anchor tabs 1447, 1448 and 1449 are also provided along the bottom surface of electrode pattern 1440, adjacent to but not in direct electrical contact with the main electrode portion 1442. Anchor tab 1447 is generally in the same relative orientation as anchor tab 1427 in electrode pattern 1420 and electrode tab 1434 in electrode pattern 1430. Anchor tab 1448 is generally in the same relative orientation as electrode tab 1428 of electrode pattern 1420 and anchor tab 1439 in electrode pattern 1430. Anchor tab 1449 is generally in the same relative orientation as electrode 1429 of electrode pattern 1420 and electrode tab 1436 of electrode pattern 1430. In one exemplary embodiment, a portion of wrap-around electrode portion 1446 may be notched (e.g., corner notch 1445) to provide an orientation feature as illustrated in FIGS. 14e and 14f.

As shown in the exploded view of FIG. 14d, one embodiment of the disclosed technology provides a multilayer capacitor (MLC) 1450 formed by selectively stacking electrode patterns 1420, 1430 and 1440 with interleaved dielectric layers (not shown in the figure for ease and clarity of illustration). From front to back, such a stacked configuration includes the following sequence of electrode patterns (including main electrode portions and corresponding anchor tabs), with one or more dielectric layers provided between each adjacent pair of electrodes: a first polarity mother electrode pattern 1420, a second polarity electrode pattern 1430, a first polarity daughter electrode pattern 1440, a second polarity electrode pattern 1430, a first polarity daughter electrode pattern 1440, a second polarity electrode pattern 1430, a first polarity daughter electrode pattern 1440, a second polarity electrode pattern 1430, and a first polarity mother electrode pattern 1420.

It should be appreciated with regard to FIG. 14d that many more pairs of first polarity daughter electrode 1440 and second polarity electrode 1430 may be provided in between the front and back sets of first polarity mother electrode 1420 and second polarity electrode 1430, as respective groups of three pairs are shown merely for ease and clarity of illustration. In an alternative example, first polarity mother electrodes 1420 are not provided on both ends of the stacked configuration, but only in a single location such as on a single end or in the middle of the stacked configuration. Any number of daughter electrodes may be provided in between or surrounding the mother pairs. In some embodiments, mother electrodes may be provided in groups other than pairs, such as, for example, groups of one to five mother electrodes. However, to facilitate a shielded structure, it is generally preferred that a first polarity electrode (either a mother electrode 1420 or a daughter electrode 1440) be provided on the very front and back of a stacked assembly 1450 as shown in FIG. 14d so that device shielding can be implemented.

Exemplary peripheral terminations for a device formed from the stacked electrode assembly of FIG. 14d are shown in FIGS. 14e and 14f. FIG. 14e shows a perspective view of a terminated device 1400 in the same relative orientation as the assembly 1450 of FIG. 14d. Each of five surfaces of the device 1400, including top surface 1451, end surfaces 1452 and 1454, and side surfaces 1456 and 1458 are substantially covered with a conductive material.

Such encompassing larger portion 1460 of conductive material forms a first circuit-connection terminal that also functions as a device shield and heat dissipation feature, as previously described with reference to FIGS. 14e and 14f. If notched portions are provided in each electrode pattern (such as notched portions 1425, 1435 and 1445 in FIGS. 14a-14c, respectively), then an exposed corner 1455 may remain unterminated to provide a feature for orienting the completed device for mounting or packaging purposes.

Additional termination elements for device 1400 are shown in the bottom (surface mount) perspective view of FIG. 14f. On the bottom (mounting) surface 1470 of MLC 1400, two second polarity terminations 1462 and 1464 are provided. Termination 1462 covers exposed portions of anchor tabs 1427 and 1447 as well as exposed edges of electrode tabs 1434. Termination 1464 covers exposed portions of anchor tabs 1429 and 1449 as well as exposed edges of electrode tabs 1436. Termination stripes 1460a and 1460b are electrically connected as part of continuous peripheral termination 1460. Termination stripe 1460a serves to cover the portions of electrode portions 1424/1426, anchor tab 1437, and wrap-around electrode portion 1446 that are initially exposed along mounting surface 1470. Termination stripe 1460b serves to cover other portions of electrode portions 1424, anchor tab 1437, and wrap-around electrode portion 1446 that are initially exposed along mounting surface 1470 adjacent to the closest edge surface. Circuit connection to MLC 1400 can thus occur by mounting the bottom surface 1470 in a circuit environment and electrically connecting to the first polarity circuit-connection terminal portions 1460a and 1460b and to the second polarity circuit-connection terminals 1462 and 1464.

The application of conductive material forming peripheral terminations 1460-1464 of FIGS. 14e and 14f may be applied by any number of suitable methods known to one of ordinary skill in the art, including but not limited to a process of direct thin-film plating such as electroless copper plating as previously described herein. The formation of such direct plating is aided by the provision of various anchor tab features in the electrode patterns and controlled spacing of the exposed locations of electrode and anchor tab portions along a device periphery. It should be further appreciated in accordance with such direct plating termination method(s), that any type of orientation feature (e.g., exposed corner 1455) may be formed. Since thin-film plating is only deposited where internal electrode patterns are exposed along device surfaces, any size or shape of orientation feature can be formed by leaving a strip, square, circle, or other portion of surface area free from exposed conductive elements.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A unitary capacitor having low inductance and controlled Equivalent Series Resistance (ESR) features, comprising:
a plurality of first conductive layers comprising at least one pair of mother electrodes adapted for connection externally to said unitary capacitor;
a plurality of second conductive layers comprising at least one pair of daughter electrodes adapted for connection internally to said unitary capacitor; and
a plurality of dielectric layers interleaved with said plurality of first and second conductive layers;
wherein said mother and daughter electrodes are in parallel connection and interdigitated with electrode tabs such that said daughter electrodes are only connected to other daughter electrodes and to selected mother electrodes without direct connection external to said unitary capacitor, while selected of said mother electrodes are connected externally to said unitary capacitor.

2. A unitary capacitor as in claim 1, further including end terminations provided for internal connection among said selected mother electrodes and said daughter electrodes, and side terminations for connecting said unitary capacitor to a circuit or other mounting environment.

3. A unitary capacitor as in claim 1, further including a plurality of said pairs of mother electrodes and a plurality of said pairs of daughter electrodes, for forming a desired amount of capacitance with said unitary capacitor formed thereby.

4. A unitary capacitor as in claim 1, wherein said mother electrodes are interdigitated with respective end tabs on opposite ends thereof for providing internal connection to other electrodes, and with side tabs on opposite longer sides thereof for providing circuit connection to an external location.

5. A unitary capacitor as in claim 4, wherein said daughter electrodes include end tabs on opposite ends thereof for internal connection to other daughter electrodes and to selected of said mother electrodes.

6. A unitary capacitor as in claim 5, further including anchor tabs placed alongside portions of said mother and daughter electrodes but not in electrical contact therewith, for acting as dummy tabs to provide additional nucleation and guide points for subsequently applied peripheral terminations.

7. A unitary capacitor as in claim 1, wherein each mother electrode includes a substantially rectangular main portion with two external-connection tabs attached to and extending from a first longer side edge thereof and two external-connection tabs attached to and extending from a second longer side edge thereof, and with an internal-connection tab attached to and extending from an end edge thereof.

8. A unitary capacitor as in claim 7, wherein each of said mother electrodes is associated with a plurality of dummy tabs.

9. A unitary capacitor as in claim 8, wherein said plurality of dummy tabs associated with said mother electrodes each include two dummy tabs each provided adjacent to each longer side edge of each of said mother electrodes and in between respective side tabs thereof and one dummy tab provided at an end edge thereof opposite said internal-connection tab thereof.

10. A unitary capacitor as in claim 9, wherein said plurality of dummy tabs associated with said mother electrodes respectively provide support and nucleation points for electroless copper termination.

11. A unitary capacitor as in claim 1, wherein each of said daughter electrodes includes a substantially rectangular main electrode portion with respective internal-connection tabs provided on alternate ones of the shorter end sides thereof.

12. A unitary capacitor as in claim 11, wherein each of said daughter electrodes is associated with a plurality of dummy tabs.

13. A unitary capacitor as in claim 12, wherein said plurality of dummy tabs associated with said electrodes are located in a spaced co-planar relationship to the main portion of said daughter electrodes, with four dummy tabs provided adjacent to a first longer side edge of each respective daughter electrode, four additional dummy tabs provided adjacent to a second longer side edge thereof, and one additional dummy tab provided adjacent to a third shorter end edge thereof.

14. A unitary capacitor as in claim 1, wherein:
each of said mother electrodes includes a substantially rectangular main portion with two external-connection tabs attached to and extending from a first longer side edge thereof and two external-connection tabs attached to and extending from a second longer side edge thereof, and with an internal-connection tab attached to and extending from an end edge thereof;
each of said mother electrodes are associated with a plurality of dummy tabs respectively associated with side and end edges of said mother electrodes, said plurality of dummy tabs associated with said mother electrodes respectively providing support and nucleation points for electroless copper termination;
each of said daughter electrodes includes a substantially rectangular main electrode portion with respective internal-connection tabs provided on alternate ones of the shorter end sides thereof;
each of said daughter electrodes are associated with a plurality of dummy tabs; and said capacitor further includes end terminations provided for internal connection among said selected mother electrodes and said daughter electrodes, and side terminations for connecting said unitary capacitor to a circuit or other mounting environment.

15. A multilayer ceramic capacitor incorporating both low inductance (ESL) and controlled Equivalent Series Resistance (ESR) features into a unitary device, having a low inductance section connected in parallel with a high ESR section, comprising:
a first type of electrode pairs comprising mother electrodes adapted for external connection;
a second type of electrode pairs comprising daughter electrodes adapted only for internal connection to other electrodes within said capacitor without direct connection to an external circuit;
alternating dielectric layers among said electrode pairs; and
outer lamination.

16. A multilayer ceramic capacitor as in claim 15, wherein said mother electrodes and said daughter electrodes comprise respective pairs of a first polarity and a second polarity electrode, for yielding a plurality of different electrode patterns in said capacitor.

17. A multilayer ceramic capacitor as in claim 15, wherein the number of daughter electrodes is greater than the number of mother electrodes.

18. A multilayer ceramic capacitor as in claim 15, wherein:
said mother electrodes are interdigitated with respective end tabs on opposite ends thereof for providing selected internal connection to other electrodes, and with side tabs on opposite longer sides thereof for providing circuit connection external at said outer lamination; and
said daughter electrodes are not connected to an external circuit location, but include end tabs on opposite ends thereof for internal connection to other daughter electrodes and to selected of said mother electrodes.

19. A multilayer ceramic capacitor as in claim 18, further including circuit-connection terminals connected to said side tabs, and internal-connection terminals selectively connected with said end tabs.

20. A multilayer ceramic capacitor as in claim 18, further including anchor tabs situated adjacent but electrically separated from portions of said mother and daughter electrodes.

21. A multilayer ceramic capacitor as in claim 15, wherein:
said mother electrodes and said daughter electrodes comprise respective pairs of a first polarity and a second polarity electrode, for yielding a plurality of different electrode patterns in interdigitated arrangement in said capacitor; and
said capacitor further includes four respective corner tabs, one each associated with each corner of said capacitor and exposed along two adjacent side edges of each respective one of said electrodes; and four respective terminations, associated with said four respective corner tabs.

22. A multilayer ceramic capacitor as in claim 21, further including diagonally mounted resistive stripes, selectively associated with said respective terminations.

23. A low inductance controlled ESR multilayer capacitor, including interdigitated vertical electrodes, oriented in a substantially perpendicular direction relative to a mounting surface, said vertical electrodes including at least one respective pair of mother and daughter electrode patterns, with circuit-connection tabs extending to a mounting surface and contacting selected of said mother electrode patterns, and with internal tabs extending to a surface opposite the mounting surface and connected to daughter electrode patterns and selected mother electrode patterns by internal-connection terminations.

24. A capacitor as in claim 23, wherein said circuit-connection tabs are provided in multiple stripes on the mounting surface of said capacitor.

25. A capacitor as in claim 24, wherein said circuit-connection tabs comprise four stripes, two of which are associated with each said mother electrode pattern.

26. A capacitor as in claim 23, further including anchor tabs with thin-film plated terminations thereon.

27. A capacitor as in claim 26, further including exposed electrode tabs associated with said anchor tabs with said mother and daughter electrode patterns configured relative to a columnar centerline, resulting in a staggered array of exposure locations, for selective formation of thin-film plated terminations thereon for the formation of serpentine termination structures, for increasing the resistive path length traveled by current flowing through said capacitor.

28. A capacitor as in claim 23, wherein said internal tabs include resistive material, for providing increased resistance in a current path traveled between mother and daughter electrode patterns in a stacked assembly thereof in said capacitor.

29. A capacitor as in claim 23, wherein said internal-connection terminations comprise peripheral internal-connection terminals in a wrap-around arrangement, respectively extending across an entire end dimension and onto two adjacent surfaces thereof.

30. A capacitor as in claim 29, further including a generally rectangular main portion with a single tab, coupled with such wrap-around arrangement terminations, for providing a narrow and highly resistive pathway from such terminations to a main electrode surface area.

31. A capacitor as in claim 29, wherein a rectangular main portion of each electrode pattern is configured for substantially parallel portions in which current flows in opposing directions to improve current cancellation, for lowering overall device inductance while simultaneously increasing current path lengths for increasing amounts of controlled ESR.

32. A capacitor as in claim 23, wherein selected of said mother and electrode patterns are provided on front and back surfaces of a vertical electrode stack so as to form a device shield formed on multiple surfaces of said capacitor, for improved heat dissipation and protection from electromagnetic interference (EMI) or emission.

33. A method of providing a unitary capacitor having low inductance and controlled Equivalent Series Resistance (ESR) features, comprising:
providing a plurality of first conductive layers comprising at least one pair of mother electrodes adapted for connection externally to the unitary capacitor;
providing a plurality of second conductive layers comprising at least one pair of daughter electrodes adapted for connection internally to the unitary capacitor;
forming a plurality of dielectric layers interleaved with the plurality of first and second conductive layers; and
forming electrode tabs such that the mother and daughter electrodes are in parallel connection and interdigitated with the electrode tabs, with the daughter electrodes only connected to other daughter electrodes and to selected mother electrodes without direct connection external to the unitary capacitor, and with selected of the mother electrodes connected externally to the unitary capacitor.

34. A method as in claim 33, further including providing end terminations for internal connection among the selected mother electrodes and the daughter electrodes, and providing side terminations for connecting the unitary capacitor to a circuit or other mounting environment.

35. A method as in claim 33, wherein said mother and daughter electrodes comprise a plurality of pairs of mother electrodes and a plurality of pairs of daughter electrodes, the numbers of which are selected for forming a desired amount of capacitance with the unitary capacitor resulting therefrom.

36. A method as in claim 33, further including interdigitating the mother electrodes with respective end tabs on opposite ends thereof for providing internal connection to other electrodes, and with side tabs on opposite longer sides thereof for providing circuit connection to an external location.

37. A method as in claim 36, further including providing the daughter electrodes with end tabs on opposite ends thereof, connected to other daughter electrodes and to selected of the mother electrodes internally to the unitary capacitor.

38. A method as in claim 37, further including:
placing anchor tabs alongside portions of the mother and daughter electrodes but not in electrical contact therewith; and
subsequently applying peripheral terminations using the dummy tabs as nucleation and guide points for such terminations.

39. A method as in claim 33, wherein:
each mother electrode includes a substantially rectangular main portion with two external-connection tabs attached to and extending from a first longer side edge thereof and two external-connection tabs attached to and extending from a second longer side edge thereof, and with an internal-connection tab attached to and extending from an end edge thereof;
each of the mother electrodes are associated with a plurality of dummy tabs, which plurality of dummy tabs for each mother electrode includes two dummy tabs each provided adjacent to each longer side edge of each of the mother electrodes and in between respective side tabs thereof and one dummy tab provided at an end edge thereof opposite the internal-connection tab thereof; and
such plurality of dummy tabs associated with the mother electrodes respectively provide support and nucleation points for electroless copper termination.

40. A method as in claim 33, wherein:
each of the daughter electrodes includes a substantially rectangular main electrode portion with respective internal-connection tabs provided on alternate ones of the shorter end sides thereof;
each of the daughter electrodes are associated with a plurality of dummy tabs; and
the plurality of dummy tabs associated with the electrodes are located in a spaced co-planar relationship to the main portion of the daughter electrodes, with four dummy tabs provided adjacent to a first longer side edge of each respective daughter electrode, four additional dummy tabs provided adjacent to a second longer side edge thereof, and one additional dummy tab provided adjacent to a third shorter end edge thereof.

41. A method as in claim 33, wherein:
each of the mother electrodes includes a substantially rectangular main portion with two external-connection tabs attached to and extending from a first longer side edge thereof and two external-connection tabs attached to and extending from a second longer side edge thereof, and with an internal-connection tab attached to and extending from an end edge thereof;
each of the mother electrodes are associated with a plurality of dummy tabs respectively associated with side and end edges of the mother electrodes, the plurality of dummy tabs associated with the mother electrodes respectively providing support and nucleation points for electroless copper termination;
each of the daughter electrodes includes a substantially rectangular main electrode portion with respective internal-connection tabs provided on alternate ones of the shorter end sides thereof;
each of the daughter electrodes are associated with a plurality of dummy tabs; and the capacitor further includes end terminations provided for internal connection among the selected mother electrodes and the daughter electrodes, and side terminations for connecting the unitary capacitor to a circuit or other mounting environment.

42. A method as in claim 33, further including selecting the thickness of the dielectric layers interleaved with conductive layers so as to provide a predetermined capacitance value formed between the electrode pairs.

43. A method as in claim 33, wherein the electrodes comprise conductive materials including one or a combination of platinum, silver, nickel, copper, a palladium-silver alloy, and the dielectric layers comprise one of ceramic, semiconductive, or insulating material.

44. A method as in claim 33, wherein the electrodes respectively comprise a thickness in a range of about 1-2 μm, and the dielectric layers respectively comprise a thickness in a range of about 3-15 μm.

45. A method of providing a multilayer ceramic capacitor incorporating both low inductance (ESL) and controlled Equivalent Series Resistance (ESR) features into a unitary device, having a low inductance section connected in parallel with a high ESR section, comprising:
providing a first type of electrode pairs comprising mother electrodes adapted for external connection;
providing a second type of electrode pairs comprising daughter electrodes adapted only for internal connection to other electrodes within the capacitor without direct connection to an external circuit;
forming alternating dielectric layers among the electrode pairs; and
forming an outer lamination.

46. A method as in claim 45, wherein the mother electrodes and the daughter electrodes comprise respective pairs of a first polarity and a second polarity electrode, for yielding a plurality of different electrode patterns in the capacitor.

47. A method as in claim 45, including providing a greater number of daughter electrodes than the number of mother electrodes.

48. A method as in claim 45, further including:
interdigitating the mother electrodes with respective end tabs on opposite ends thereof and providing selected internal connection to other electrodes, and providing side tabs on opposite longer sides thereof and forming circuit connection external at the outer lamination; and
forming end tabs on opposite ends of the daughter electrodes not connected to an external circuit location, but to internal connection to other daughter electrodes and to selected of the mother electrodes.

49. A method as in claim 48, further including forming circuit-connection terminals connected to the side tabs, and internal-connection terminals selectively connected with the end tabs.

50. A method as in claim 48, further including providing anchor tabs situated adjacent but electrically separated from portions of the mother and daughter electrodes.

51. A method as in claim 45, further including:
providing the mother electrodes and the daughter electrodes as respective pairs of a first polarity and a second polarity electrode, for yielding a plurality of different electrode patterns in interdigitated arrangement in the capacitor;
forming four respective corner tabs, one each associated with each corner of the capacitor and exposed along two adjacent side edges of each respective one of the electrodes; and
forming four respective terminations, associated with the four respective corner tabs.

52. A method as in claim 51, further including providing diagonally mounted resistive stripes, selectively associated with the respective terminations.

53. A method as in claim 45, wherein:
the electrodes comprise conductive materials including one or a combination of platinum, silver, nickel, copper, a palladium-silver alloy, and respectively having a thickness in a range of about 1-2 μm; and
the dielectric layers comprise one of ceramic, semiconductive, or insulating material, and respectively having a thickness in a range of about 3-15 μm.

54. A method for providing a low inductance controlled ESR multilayer capacitor, including providing interdigitated vertical electrodes, oriented in a substantially perpendicular direction relative to a mounting surface, the vertical electrodes including at least one respective pair of mother and daughter electrode patterns, with circuit-connection tabs extending to a mounting surface and contacting selected of the mother electrode patterns, and with internal tabs extending to a surface opposite the mounting surface and connected to daughter electrode patterns and selected mother electrode patterns by internal-connection terminations.

55. A method as in claim 54, wherein the circuit-connection tabs are provided in multiple stripes on the mounting surface of the capacitor.

56. A method as in claim 55, wherein the circuit-connection tabs comprise four stripes, two of which are associated with each the mother electrode pattern.

57. A method as in claim 54, further including providing anchor tabs with thin-film plated terminations formed thereon.

58. A method as in claim 57, further including:
providing exposed electrode tabs associated with the anchor tabs with the mother and daughter electrode patterns configured relative to a columnar centerline, resulting in a staggered array of exposure locations; and
selectively forming thin-film plated terminations on such exposure locations for the formation of serpentine termination structures, for increasing the resistive path length traveled by current flowing through the capacitor.

59. A method as in claim 54, wherein the internal tabs include resistive material, for providing increased resistance in a current path traveled between mother and daughter electrode patterns in a stacked assembly thereof in the capacitor.

60. A method as in claim 54, wherein the internal-connection terminations comprise peripheral internal-connection terminals in a wrap-around arrangement, respectively extending across an entire end dimension and onto two adjacent surfaces thereof.

61. A method as in claim 60, further including a generally rectangular main portion with a single tab, coupled with such wrap-around arrangement terminations, for providing a narrow and highly resistive pathway from such terminations to a main electrode surface area.

62. A method as in claim 60, wherein a rectangular main portion of each electrode pattern is configured for substantially parallel portions in which current flows in opposing directions to improve current cancellation, for lowering overall device inductance while simultaneously increasing current path lengths for increasing amounts of controlled ESR.

63. A method as in claim 54, wherein selected of the mother and electrode patterns are provided on front and back surfaces of a vertical electrode stack so as to form a device shield formed on multiple surfaces of the capacitor, for improved heat dissipation and protection from electromagnetic interference (EMI) or emission.

64. A method as in claim 54, further including dielectric layers interleaved with the electrode patterns and having a selected thickness, so as to provide a predetermined capacitance value formed between the electrode pattern pairs.

65. A method as in claim 64, wherein:
the electrodes comprise conductive materials including one or a combination of platinum, silver, nickel, copper, a palladium-silver alloy, and respectively having a thickness in a range of about 1-2 μm; and
the dielectric layers comprise one of ceramic, semiconductive, or insulating material, and respectively having a thickness in a range of about 3-15 μm.
